(19) United States
(12) Patent Application Publication
(10) Pub. No.: US 2024/0250357 A1
(43) Pub. Date: Jul. 25, 2024

(54) BATTERY PACK AND ELECTRICAL COMPONENTS

(71) Applicant: Rivian IP Holdings, LLC, Irvine, CA (US)

(72) Inventors: Bing FENG, Hefei (CN); Hanbin HOU, Hefei (CN); Jonathan VERGHESE, Costa Mesa, CA (US)

(21) Appl. No.: 18/342,608

(22) Filed: Jun. 27, 2023

(30) Foreign Application Priority Data
Jan. 20, 2023 (WO) PCT/CN2023/073395

(51) Int. Cl. H01M 50/204; H01M 10/48; H01M 10/655; H01M 10/658

(52) U.S. Cl. CPC H01M 50/204; H01M 10/48; H01M 10/655; H01M 10/658; H01M 2220/20

(57) ABSTRACT

A system can include a first battery module. The system can include a second battery module. The second battery module can have more lithium iron phosphate (LFP) battery cells than the first battery module.

### CROSS-REFERENCES TO RELATED APPLICATIONS

This application claims the benefit of priority to PCT Application No. PCT/CN2023/073395, filed Jan. 20, 2023, which is hereby incorporated by reference in its entirety.

### INTRODUCTION

Electric vehicles can include various electrical components that provide power to the vehicle. The electrical components can be electrically coupled with vehicle components to power the vehicle.

### SUMMARY

This disclosure is generally directed to a solution for a battery pack (e.g., a Lithium Iron Phosphate (LFP) battery pack or another suitable battery pack) that can be used in an electric vehicle (e.g., to power the electric vehicle). The battery pack can include two sets of battery modules (or two groups of battery cells), the battery modules of one set of battery modules can be bigger than the battery modules of the other set of battery modules. The battery pack can include a battery voltage temperature monitor (BVT) that measures voltage and temperature sensor readings for one or more of the battery modules. The battery pack can include high/low voltage or thermal interfaces at a first end of the battery pack (e.g., in the front of the pack). The high/low voltage or thermal interfaces can be configured to route connections to external devices. The battery modules can include prismatic cells, cylindrical cells, or another suitable type of cells. The prismatic cells can include internal fuses for disconnecting electrical connections. A pack cover (e.g., an aluminum pack cover) can overlay the battery modules with thermal insulation between the pack cover and the battery modules. Thermal components can laterally span underneath the battery modules and the thermal insulation. The battery pack can include a voltage distribution box (VDB), such as a high voltage distribution box, that is positioned towards an end (e.g., a front end) of the battery pack. The battery pack can include a pack housing that includes four members (e.g., lateral cross members). The battery pack can include a current collector assembly that overlays and connects the battery cell terminals. The battery pack can include a disconnect in the middle of the battery pack.

At least one aspect is directed to a system. The system can include a first battery module. The system can include a second battery module. The second battery module can have more lithium iron phosphate (LFP) battery cells than the first battery module.

At least one aspect is directed to a system. The system can include a battery pack. The battery pack can include a first plurality of lithium iron phosphate (LFP) battery cells. The battery pack can include a second plurality of LFP battery cells. The battery pack can include a third plurality of LFP battery cells. Each of the first plurality of LFP battery cells or the second plurality of LFP battery cells can comprise more LFP battery cells than the third plurality of LFP battery cells. The first plurality of LFP battery cells, the second plurality of LFP battery cells, and the third plurality of LFP battery cells can each comprise a double-wide cell arrangement.

At least one aspect is directed to a method. The method can include providing a first battery module for a battery pack (e.g., a battery pack of an electric vehicle). The method can include providing a second battery module for the battery pack (e.g., a battery pack of the electric vehicle). The second battery module can have more lithium iron phosphate (LFP) battery cells than the first battery module.

At least one aspect is directed to a method. The method can include providing a first battery module and a second battery module. The second battery module can have more battery cells than the first battery module.

At least one aspect is directed to a method. The method can include providing a first plurality of battery cells, a second plurality of battery cells, and a third plurality of battery cells. Each of the first plurality of battery cells or the second plurality of battery cells can include more battery cells than the third plurality of battery cells. Each of the first plurality of battery cells or the second plurality of battery cells can be provided in the second battery module. The third plurality of battery cells can be provided in the first battery module. The first plurality of battery cells, the second plurality of battery cells, and the third plurality of battery cells each comprise a double-wide cell arrangement.

At least one aspect is directed to a system. The system can include a first thermal component to couple with a first battery module. The system can include a second thermal component to couple with a second battery module. The first thermal component can have a surface (e.g., a top surface containing a serpentine structure) with a smaller area than a surface (e.g., a top surface containing a serpentine structure) of the second thermal component.

At least one aspect is directed to a system. The system can include a first thermal component to couple with a first battery module. The system can include a second thermal component to couple with a second battery module. The first thermal component can be smaller than the second thermal component.

At least one aspect is directed to a system. The system can include a first thermal component coupled with a first plurality of battery cells. The system can include a second thermal component coupled with a second plurality of battery cells. The system can include a third thermal component coupled with a third plurality of battery cells. The third thermal component can be smaller than each of the first thermal component or the second thermal component. For example, a surface (e.g., a top surface containing a serpentine structure) of the third thermal component can have a smaller area than a surface (e.g., a top surface containing a serpentine structure) of each of the first thermal component or the second thermal component.

At least one aspect is directed to a system. The system can include a first thermal component coupled with a first plurality of battery cells. The system can include a second thermal component coupled with a second plurality of battery cells. The system can include a third thermal component coupled with a third plurality of battery cells. The third thermal component can have a surface with a smaller area than a surface of the first thermal component or the second thermal component.

At least one aspect is directed to a method. The method can include coupling a first thermal component with a first battery module and coupling a second thermal component with a second battery module. The first thermal component can be smaller than the second thermal component.

At least one aspect is directed to a method. The method can include coupling a first thermal component to a first plurality of battery cells, coupling a second thermal component to a second plurality of battery cells, and coupling a third thermal component to a third plurality of battery cells. The third thermal component can be smaller than each of the first thermal component or the second thermal component.

At least one aspect is directed to a system. The system can include a voltage distribution box (VDB) to dispose in a first portion of a battery pack. The system can include a first battery module and a second battery module to dispose in a second portion of the battery pack. The VDB can be electrically coupled with the first battery module and with the second battery module. A first harness can extend in a direction from the first portion of the battery pack to the second portion of the battery pack across a middle portion of the first battery module and a middle portion of the second battery module. A busbar can comprise a first portion that extends across the second portion of the battery pack, a second portion that extends across first end portions of the first battery module and the second battery module, and a third portion that extends across second end portions of the first battery module and the second battery module. A second harness can extend across the first portion of the battery pack

At least one aspect is directed to a system. The system can include a voltage distribution box (VDB) to dispose in a first portion of a battery pack. The system can include a first plurality of battery cells and a second plurality of battery cells to dispose in a second portion of the battery pack. The VDB can be electrically coupled with the first plurality of battery cells and with the second plurality of battery cells. A first harness can extend in a first direction from the first portion to the second portion. A busbar can include a first portion that extends in the first direction, a second portion that extends in the first direction, and a third portion that extends in a direction between the first portion and the second portion. A second harness can extend across the first portion.

At least one aspect is directed to a method. The method can include disposing a voltage distribution box (VDB) in a first portion of a battery pack and disposing a first battery module and a second battery module in a second portion of the battery pack. The VDB can be electrically coupled with the first battery module and with the second battery module. The method can include extending a first harness in a direction from the first portion of the battery pack to the second portion of the battery pack across a middle portion of the first battery module and a middle portion of the second battery module. The method can include extending a first portion of a busbar across the second portion of the battery pack, a second portion of the busbar across first end portions of the first battery module and the second battery module, and a third portion of the busbar across second end portions of the first battery module and the second battery module. The method can include extending a second harness across the first portion of the battery pack.

At least one aspect is directed to a method. The method can include disposing a voltage distribution box (VDB) in a first portion of a battery pack and disposing a first plurality of battery cells and a second plurality of battery cells in a second portion of the battery pack. The VDB can be electrically coupled with the first plurality of battery cells and with the second plurality of battery cells.

At least one aspect is directed to a battery pack housing. The battery pack housing can include a first bay and a second bay. The first bay can house a first plurality of battery cells. The second bay can house a second plurality of battery cells. The second plurality of battery cells can include more battery cells than the first plurality of battery cells.

At least one aspect is directed to a system. The system can include a first member. The system can include a second member. A distance between a wall of a battery pack and the first member can be less than a distance between the first member and the second member.

At least one aspect is directed to a method. The method can include providing a first bay and a second bay, the first bay to house a first plurality of battery cells, the second bay to house a second plurality of battery cells. The second plurality of battery cells can include more battery cells than the first plurality of battery cells.

At least one aspect is directed to a method. The method can include providing a first member and a second member. A distance between a wall of a battery pack and the first member can be less than a distance between the first member and the second member.

At least one aspect is directed to a system. The system can include a busbar. The system can include a tray. The system can include a pedestal to couple the busbar with the tray. The busbar can be coupled with a terminal of a battery cell.

At least one aspect is directed to a method. The method can include providing a busbar and a tray. The method can include coupling the busbar with the tray with a pedestal. The method can include coupling the busbar with a terminal of a battery cell.

At least one aspect is directed to a method. The method can include providing a busbar having a front end and a back end. The method can include coupling a circuit with the front end of the busbar. The method can include providing a tray to support the busbar. The method can include coupling the busbar with the tray with a pedestal. The method can include coupling the busbar with a terminal of a battery cell. The method can include connecting the terminal of the battery cell with the circuit.

At least one aspect is directed to a method. The method can include providing a current collector assembly comprising a tray and a busbar, the busbar having a current collector element exposed by a cavity in the tray. The method can include placing the current collector assembly over a battery pack comprising a battery cell. The method can include welding the current collector element to a terminal of the battery cell through a surface of the current collector element exposed by the cavity.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example cross-sectional view of an electric vehicle, in accordance with implementations.

FIG. 2 depicts an example perspective view of a battery pack coupled with a frame, in accordance with implementations.

FIG. 3 depicts an example perspective view of battery pack components, in accordance with implementations.

FIG. 4 depicts an example top view of a battery pack, in accordance with implementations.

FIG. 5 depicts an example cross-sectional view of a battery pack, in accordance with implementations.

FIG. 6 depicts an example top view of a battery module of a battery pack, in accordance with implementations.

FIG. 7 depicts an example side view of a battery module of a battery pack, in accordance with implementations.

FIG. 8 depicts an example front view of a battery module of a battery pack, in accordance with implementations.

FIG. 9 depicts an example top view of a battery module of a battery pack, in accordance with implementations.

FIG. 10 depicts an example side view of a battery module of a battery pack, in accordance with implementations.

FIG. 11 depicts an example front view of a battery module of a battery pack, in accordance with implementations.

FIG. 12 depicts an example exploded view of a battery module of a battery pack, in accordance with implementations.

FIG. 13 depicts an example exploded view of a battery module of a battery pack, in accordance with implementations.

FIG. 14 depicts an example front view of a battery pack, in accordance with implementations.

FIG. 15 depicts an example top view of a battery pack, in accordance with implementations.

FIG. 16 depicts an example side view of a battery pack, in accordance with implementations.

FIG. 17 depicts an example side view of a battery pack, in accordance with implementations.

FIG. 18 depicts an example perspective view of a battery pack, in accordance with implementations.

FIG. 19 depicts an example bottom view of a base plate of a battery pack, in accordance with implementations.

FIG. 20 depicts an example partial perspective view of a battery pack, in accordance with implementations.

FIG. 21 depicts an example perspective view of a battery cell, in accordance with implementations.

FIG. 22 depicts an example exploded view of a battery pack, in accordance with implementations.

FIG. 23 depicts an example perspective view of a thermal component, in accordance with implementations.

FIG. 24 depicts an example front view of a thermal component, in accordance with implementations.

FIG. 25 depicts an example back view of a thermal component, in accordance with implementations.

FIG. 26 depicts an example side view of a thermal component, in accordance with implementations.

FIG. 27 depicts an example side view of a thermal component, in accordance with implementations.

FIG. 28 depicts an example top or bottom view of a thermal component, in accordance with implementations.

FIG. 29 depicts an example top or bottom view of a thermal component, in accordance with implementations.

FIG. 30 depicts an example exploded view of a thermal component, in accordance with implementations.

FIG. 31 depicts an example top view of a serpentine structure, in accordance with implementations.

FIG. 32 depicts an example top view of a serpentine structure, in accordance with implementations.

FIG. 33 depicts a perspective view of serpentine structures connected to a pipe, in accordance with implementations.

FIG. 34 depicts an exploded view of a voltage distribution box, in accordance with implementations.

FIG. 35A depicts a top view of a base of a battery pack housing, in accordance with implementations.

FIG. 35B depicts a top view of a base of a battery pack housing, in accordance with implementations.

FIG. 36 depicts a bottom view of a base of a battery pack housing, in accordance with implementations.

FIG. 37 depicts a front view of a base of a battery pack housing, in accordance with implementations.

FIG. 38 depicts a back view of a base of a battery pack housing, in accordance with implementations.

FIG. 39 depicts a side view of a base of a battery pack housing, in accordance with implementations.

FIG. 40 depicts a side view of a base of a battery pack housing, in accordance with implementations.

FIG. 41 depicts a perspective view of a base of a battery pack housing, in accordance with implementations.

FIG. 42 depicts an exploded view of a base of a battery pack housing, in accordance with implementations.

FIG. 43 depicts a cross-sectional view of a base of a battery pack housing, in accordance with implementations.

FIG. 44 depicts a cross-sectional view of a base of a battery pack housing, in accordance with implementations.

FIG. 45 depicts a front view of a base plate, in accordance with implementations.

FIG. 46 depicts a top view of a current collector assembly, in accordance with implementations.

FIG. 47 depicts a bottom view of a current collector assembly, in accordance with implementations.

FIG. 48 depicts a partial perspective view of a current collector assembly, in accordance with implementations.

FIG. 49 depicts a front view of a current collector assembly, in accordance with implementations.

FIG. 50 depicts a back view of a current collector assembly, in accordance with implementations.

FIG. 51 depicts a side view of a current collector assembly, in accordance with implementations.

FIG. 52 depicts a side view of a current collector assembly, in accordance with implementations.

FIG. 53 depicts an exploded view of a current collector assembly, in accordance with implementations.

FIG. 54 depicts an exploded view of a current collector assembly, in accordance with implementations.

FIG. 55 depicts a welding area of a portion of a busbar, in accordance with implementations.

FIG. 56 depicts an operation of placing a current collector assembly on a battery module, in accordance with implementations.

FIG. 57 depicts an operation of welding a current collector assembly onto a battery module, in accordance with implementations.

FIG. 58 depicts a perspective view of a thermistor coupled with an interconnection structure, in accordance with implementations.

FIG. 59 depicts a perspective view of a thermistor measuring the temperature for different battery cells of a battery pack, in accordance with implementations.

FIG. 60 depicts a cross-sectional view of a thermistor coupled with a terminal of a battery cell through an interconnection structure, in accordance with implementations.

FIG. 61 depicts a perspective view of a flexible printed circuit coupled with an interconnection structure, in accordance with implementations.

FIG. 62 depicts a top view of a thermistor coupled with a battery cell, in accordance with implementations.

FIG. 63 depicts a top view of a thermistor coupled with a battery cell, in accordance with implementations.

FIG. 64 depicts a perspective view of a flexible printed circuit coupled with an interconnection structure, in accordance with implementations.

FIG. 65 depicts a perspective view of a battery module of a battery pack, in accordance with implementations.

FIG. 66 depicts a partial top view of a battery module, in accordance with implementations.

FIG. 67 depicts a partial perspective view of a battery module, in accordance with implementations.

FIG. 68 depicts a method of providing a battery pack for an electric vehicle, in accordance with present implementations.

FIG. 69 depicts a method of providing a battery pack for an electric vehicle, in accordance with present implementations.

FIG. 70 depicts a method of coupling thermal components with a battery pack for an electric vehicle, in accordance with present implementations.

FIG. 71 depicts a method of coupling thermal components with a battery pack for an electric vehicle, in accordance with present implementations.

FIG. 72 depicts a method of configuring a battery pack for an electric vehicle, in accordance with present implementations.

FIG. 73 depicts a method of configuring a battery pack for an electric vehicle, in accordance with present implementations.

FIG. 74 depicts a method of providing a battery pack for an electric vehicle, in accordance with present implementations.

FIG. 75 depicts a method of providing a battery pack for an electric vehicle, in accordance with present implementations.

FIG. 76 depicts a method of coupling a current collector assembly with one or more battery cells, in accordance with present implementations.

FIG. 77 depicts a method of coupling a current collector assembly with a battery module for an electric vehicle, in accordance with present implementations.

FIG. 78 depicts an example perspective view of a battery pack, in accordance with implementations.

FIG. 79 depicts an example perspective view of a battery module, in accordance with implementations.

FIG. 80 depicts an example perspective view of a battery cell, in accordance with implementations.

FIG. 81 depicts an example perspective view of a battery cell, in accordance with implementations.

FIG. 82 depicts an example perspective view of a battery cell, in accordance with implementations.

### DETAILED DESCRIPTION

Following below are more detailed descriptions of various concepts related to, and implementations of a battery pack that can be used in an electric vehicle. The various concepts introduced above and discussed in greater detail below may be implemented in any of numerous ways.

This disclosure is generally directed to solution for a battery pack (e.g., a Lithium Iron Phosphate (LFP) battery pack) that can be used in an electric vehicle. The battery pack can include a first set of battery modules and a second set of battery modules. The battery modules of the first set of battery modules can be larger than the battery modules of the second set of battery modules. In one example, the first set of battery modules can include three large battery modules of the same or a similar size and the second set of battery modules can include a single battery module that is smaller than the three large battery modules. The first and second sets of battery modules can each include any number or ratio of battery modules. For example, the first set of battery modules can include two battery modules and the second set of battery modules can include one battery module; the second set of battery modules can include four battery modules and the second set of battery modules can include one battery module; the first set of battery modules can include five battery modules and the second set of battery modules can include one battery module; the first set of battery modules can include five battery modules and the second set of battery modules can include two battery modules; among other possibilities. This configuration can provide improved energy density, capacity, and mass of the battery pack in view of the limited space that can be available within the electric vehicle to house the battery pack. The configuration can also provide high integration efficiency and a shorter busbar (e.g., a high voltage busbar).

The battery pack can include a battery voltage temperature monitor. The battery voltage temperature monitor can measure voltage and temperature sensor readings for one or more of the battery modules. The battery voltage temperature monitor can be centralized within the battery pack. This positioning can conserve space because, via the positioning, a single battery voltage temperature monitor can monitor each of multiple battery modules within the battery pack instead of having a separate battery voltage temperature monitor for each battery module.

The battery pack can include high voltage and low voltage interfaces. The high voltage and low voltage interfaces can be located in the front of the battery pack. This location of the high voltage and low voltage interfaces can improve accessibility and servicing compared to conventional battery packets. Additionally, the location of the high and low voltage interfaces in the front of the battery can facilitate routing the connections of the battery pack to the front face of the battery pack without any external pouches.

The battery modules can include one or more prismatic cells. The prismatic cells may or may not include internal fuses for disconnecting electrical connections. Disconnecting the electrical connections can prevent thermal runaways.

The battery pack can include a pack cover (e.g., an aluminum pack cover). The pack cover can include service windows. The service windows can facilitate servicing of the high voltage and low voltage interfaces. The battery pack can include structural insulation underneath the pack cover to protect cell interconnections in case there is weight on top of the battery pack (e.g., on top of a pack lid of the battery pack).

The battery pack can include one or more thermal components. The thermal components can each be or include a cold plate. The thermal components can laterally span underneath multiple battery modules. Each thermal component can include a thermal system architectures with cooling pipes and water or glycol. A different thermal component can span each of the battery modules. The thermal components can interface with the battery cells within the battery modules to facilitate temperature control of the battery pack.

The battery pack can include a voltage distribution box (e.g., a high voltage distribution box). The voltage distribution box can be positioned towards the front of the battery pack adjacent to thermal components or cooling pipes of the battery pack. The voltage distribution box can include cooling mechanisms, such as fans, heatsinks, coolant manifolds, fuses, or thermal runaway detection units. The cooling mechanisms can be used to monitor or modify thermal characteristics of the voltage distribution box or the battery pack.

The battery pack can include a pack housing. The pack housing can include one or more members. The members can extend across the pack housing in parallel with each other. The members can improve structural stability of the battery pack.

The battery pack can include a current collector assembly. The current collector assembly can connect terminals of the battery cells of the individual battery modules of the battery pack. The current collector assembly can connect the battery cells in series with each other.

The battery pack can include a disconnect. The disconnect can be located in the middle of the battery pack as a “mid pack disconnect.” For example, disconnects can be in the middle of battery modules of the battery pack. The mid pack disconnects can provide technicians with the ability to disconnect circuits or remove busbars in the middle of the battery pack prior to servicing of the battery pack.

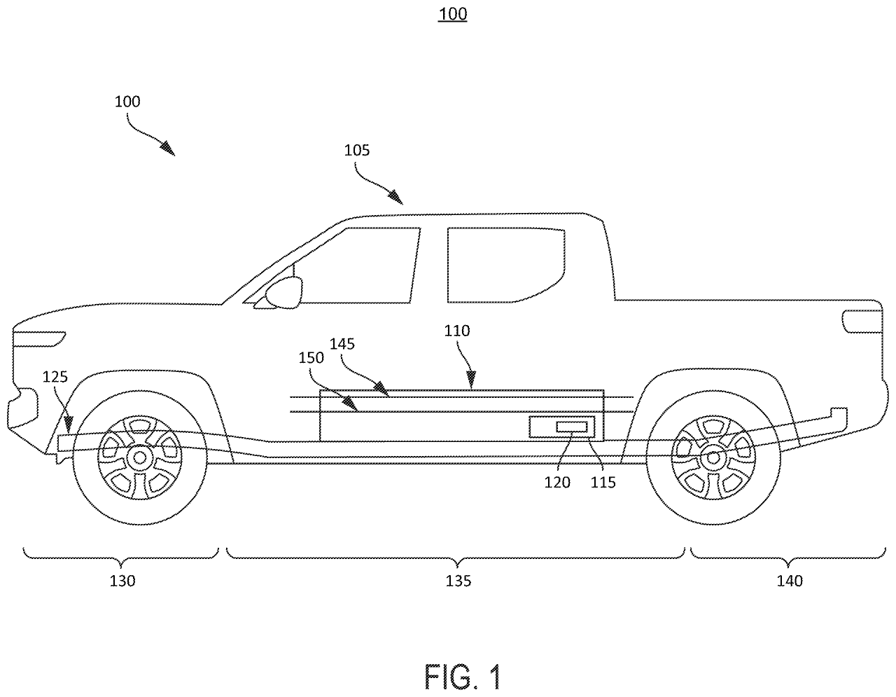

FIG. 1 depicts an example cross-sectional view 100 of a vehicle 105 installed with at least one battery pack 110. The vehicle 105 can be an electric vehicle. Vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Vehicles 105 can be fully electric or partially electric (e.g., plug-in hybrid) and further, vehicles 105 can be fully autonomous, partially autonomous, or unmanned. Vehicles 105 can also be human operated or non-autonomous. Vehicles 105 such as electric trucks or automobiles can include on-board battery packs 110, batteries 115 or battery modules 115, or battery cells 120 to power the electric vehicles. The vehicle 105 can include a chassis 125 (e.g., a frame, internal frame, or support structure). The chassis 125 can support various components of the vehicle 105. The chassis 125 can span a front portion 130 (e.g., a hood or bonnet portion), a body portion 135, and a rear portion 140 (e.g., a trunk, payload, or boot portion) of the vehicle 105. The battery pack 110 can be installed or placed within the vehicle 105. For example, the battery pack 110 can be installed on the chassis 125 of the vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery 115, the battery modules 115, or the battery cells 120 with other electrical components of the vehicle 105 to provide electrical power to various systems or components of the vehicle 105.

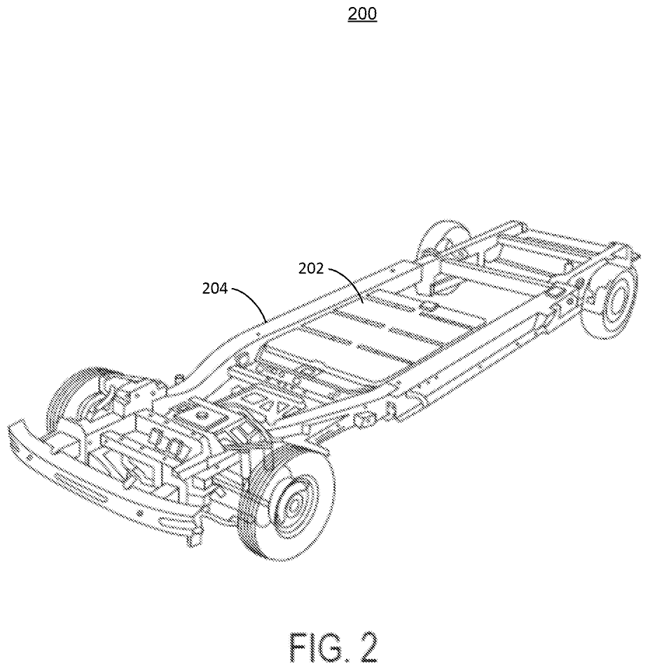

FIG. 2 depicts an example perspective view 200 of a battery pack 202 coupled with a frame 204. The frame 204 can be a frame for a vehicle (e.g., the vehicle 105). For example, the frame 204 can be a frame of a chassis (e.g., the chassis 125) of a vehicle that can support different portions of the vehicle (e.g., the front portion 130, the body portion 135, and the rear portion 140 of the vehicle 105). The battery pack 202 or the components of the battery pack 202 can be the same or similar to the battery pack 110 or the components of the battery pack 110 of FIG. 1.

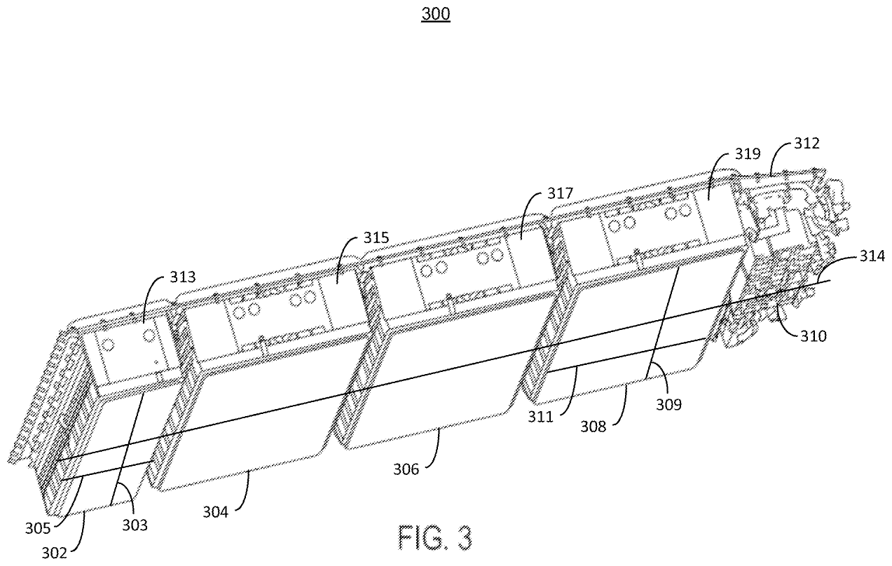

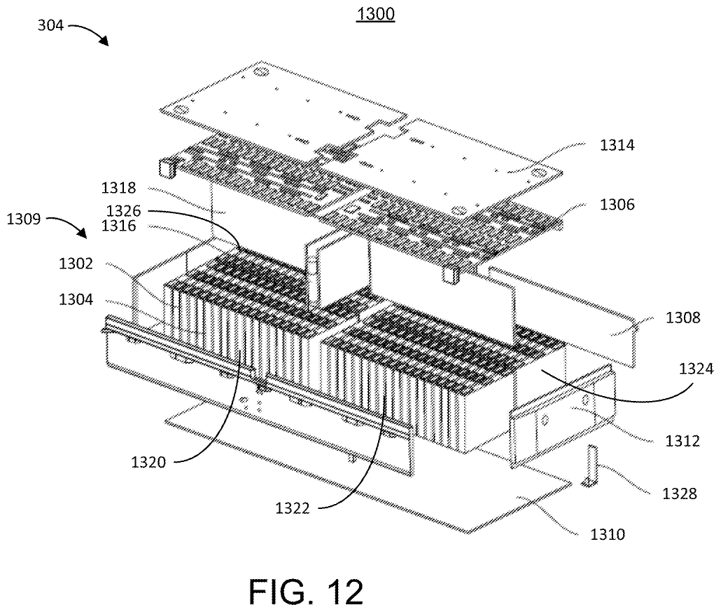

FIG. 3 depicts an example perspective view 300 of components inside a housing (e.g., a housing 2315) of the battery pack 202. As depicted in FIG. 3, the battery pack 202 can include batteries 302, 304, 306, and 308, and circuitry 310. It should be noted that batteries 302, 304, 306, and 308 may each include a number battery cells, such as those described herein in relation to FIGS. 12, 13, 80, 81, and 82, among possibly others. The batteries 302, 304, 306, and 308, possibly also referred to as battery modules, can each include one or a plurality of battery cells (e.g., LiFePO₄ (LFP) battery cells). The battery cells can be prismatic battery cells or cylindrical battery cells. For example, the battery module 302 can contain a first plurality of battery cells, the battery module 304 can contain a second plurality of battery cells, the battery module 306 can contain a third plurality of battery cells, or the battery module 308 can contain a fourth plurality of battery cells. In one example, the battery modules 304 and 306 can respectively include, have, or contain a first plurality (e.g., multiple) of battery cells and a second plurality of battery cells. The battery module 302 can contain a third plurality of battery cells. Each of the first plurality of battery cells or the second plurality of battery cells can include more battery cells than the third plurality of battery cells. The battery module 308 can include a fourth plurality battery cells. The fourth plurality of battery cells can include more battery cells than the third plurality of battery cells or an equal number of battery cells to the first plurality of battery cells or the second plurality of battery cells. The battery modules 304, 306, and 308 or the plurality of battery cells of (e.g., stored in) the battery modules 304, 306, and 308 can have or include the same number of battery cells. The battery module 302 can be a first battery module and the battery modules 304, 306, and 308 can be a plurality of second battery modules. The battery module 302 or the plurality of battery cells of (e.g., stored in) the battery module 302 can have a smaller number of battery cells than each of the battery modules 304, 306, and 308. In one example, one, multiple, or each of the battery modules 304, 306, and 308 can each have twice the number of battery cells of the battery module 302. The difference in size or number of battery cells between the battery modules 302, 304, 306, and 308 can provide improved energy density, capacity, and mass of the battery pack 202, which can be beneficial when electric vehicles have limited space to house the battery pack 202.

The battery modules 302, 304, 306, and 308 can each have a battery housing (e.g., battery housings 313, 315, 317, and 319). The battery housing 313 can be a first battery housing; the battery housing 315 can be a second battery housing; the battery housing 317 can be a third battery housing; the battery housing 319 can be a fourth battery housing. The battery housings 313, 315, 317, and 319 of the respective battery modules 302, 304, 306, and 308 can enclose all or portions of one or a plurality of battery cells respectively within the battery modules 302, 304, 306, or 308. The lengths of the battery modules 304, 306, or 308 (e.g., the battery housings 315, 317, or 319) can be greater than the length of the battery module 302 (e.g., the battery housing 313). The widths of the battery modules 302, 304, 306, or 308 (e.g., the battery housings 313, 315, 317, or 319) can be the same. For example, the battery module 302 and battery module 308 can each have a width 303 and 309. The widths 303 and 309 of the battery module 302 and the battery module 308 can be the same or equal. A length 311 of the battery module 308 can be greater than a length 305 of the battery module 302.

The battery pack 202 can operate to power an electric vehicle. In doing so, the cells of the battery pack 202 can provide about 117 amp hours (Ah) of current. The battery cells can be LFP battery cells. The battery pack 202 can have or provide a voltage of about 403.2 volts. The battery pack 202 can have or provide a voltage range of about 315 volts to about 459.9 volts. The battery pack 202 can have a capacity of about 238 Ah. The battery pack 202 can provide about 95.96 kWh of energy. The battery pack 202 can have a mass of about 716.7 kg. The battery pack 202 can have an energy density of about 133.9 Wh/kg. The battery pack 202 can have a water or glycol cooling system.

The battery pack 202 can include the circuitry 310. The circuitry 310 can include contactors or interfaces that connect the power output of the battery modules 302, 304, 306, and 308 with external loads. The circuitry 310 can include a voltage distribution box (e.g., a high voltage distribution box) that connects (e.g., via contactors or ports) high voltage current from the battery modules 302, 304, 306, and 308 with high voltage loads. The circuitry 310 can include contactors that connect low voltage current from the battery modules 302, 304, 306, and 308 with low voltage loads. The circuitry 310 can connect currents of any voltage with any types of loads. The circuitry 310 can include a battery voltage temperature monitor that monitors the current state (e.g., temperature or voltage) of the battery modules 302, 304, 306, and 308.

The battery pack 202 can include a railing 312. The battery modules 302, 304, 306, or 308 or the circuitry 310 can be coupled (e.g., with hooks or loops) with the railing 312. The railing 312 can facilitate the battery modules 302, 304, 306, or 308 and the circuitry 310 remaining in place relative to each other outside of a housing (e.g., the housing 2315) of the battery pack 202. The railing 312 can surround each of 302, 304, 306, or 308 or the circuitry 310 and maintain a fixed position relative to the battery modules 302, 304, 306, or 308 and the circuitry 310.

The battery modules 302, 304, 306, and 308 and the circuitry 310 can be arranged within the battery pack 202 along a first axis 314 (e.g., a lengthwise axis). The first axis 314 can extend through a back end (e.g., a wall at the back of the battery pack 202) and a front end (e.g., a wall at the front of the battery pack 202) opposite the back end of the battery pack 202. Each axis that is described herein is provided as an example. The axes can have any orientation or be directed across any portion of the battery pack 202 or a vehicle in which the battery pack 202 is located. The first axis 314 can extend through the rear portion 140 to the front portion 130, through the body portion 135 of the vehicle 105 when the battery pack 202 is installed in the vehicle 105. The battery module 302 can be disposed or located at the back end of the battery pack 202 and the circuitry 310 can be disposed at the front end of the battery pack 202 along the first axis 314.

A second axis (e.g., a widthwise axis) can be perpendicular to the first axis 314. Each of the battery modules 302, 304, 306, and 308 can have a first dimension along the first axis 314 and a second dimension along the second axis. The second dimensions of each of the battery modules 302, 304, 306, and 308 can be the same. The first dimension of the battery module 302 can be smaller or different than the first dimensions of the battery modules 304, 306, and 308.

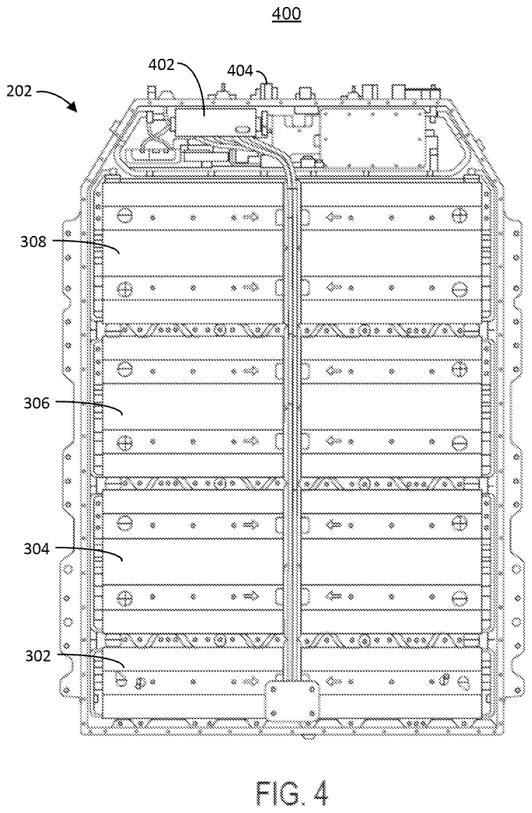

FIG. 4 depicts an example top view 400 of the battery pack 202. As depicted in FIG. 4, the battery pack 202 can include a battery voltage temperature monitor (BVT) 402 and interfaces 404. The BVT monitor 402 can include a processor and memory. The BVT monitor 402 can monitor the voltage and temperature of the battery modules 302, 304, 306, or 308 using sensors (e.g., a volt meter or a thermometer (e.g., a thermistor)). For example, the BVT monitor 402 can be coupled with at least one of a voltage sensor or a temperature sensor disposed or placed adjacent or next to one or more of the battery modules 302, 304, 306, or 308. For example, the voltage sensor or temperature sensor can be contacting or within 10 centimeters, 20 centimeters, 50 centimeters, or a meter of one or more of the battery modules 302, 304, 306, or 308. In another example, the voltage or temperature sensor can be one or more thermistors electrically coupled with one or more of the battery modules 302, 304, 306, or 308. The BVT monitor 402 can receive readings (e.g., signals) from the voltage sensor or temperature sensor indicating the voltage or temperature of one of the battery modules 302, 304, 306, or 308. The BVT monitor 402 can connect with any number of voltage or temperature sensors to receive readings for any number of the battery modules 302, 304, 306, or 308. In another example, the BVT monitor 402 can be communicatively coupled with the battery modules 302, 304, 306, or 308. The BVT monitor 402 can query the battery modules 302, 304, 306, or 308 for the current state (e.g., the battery voltage or temperature) of the respective battery modules 302, 304, 306, or 308. Accordingly, the BVT monitor 402 can be communicatively coupled with the plurality of cells within each of the battery modules 302, 304, 306, or 308. The BVT monitor 402 can display the readings from the sensors on a display or store the readings in memory as the BVT monitor 402 measures the temperature or voltage of the battery modules 302, 304, 306, and 308. An operator can connect a computing device to the BVT monitor 402 to retrieve the stored readings from the memory of the BVT monitor 402. A battery management system of a vehicle (e.g., the vehicle 105) can retrieve the stored readings from the memory of the BVT monitor 402 to use to manage or control the battery output of the battery pack 202 or components of the vehicle. The battery pack 202 can only include one BVT to read the voltage and temperature readings of the battery modules 302, 304, 306, and 308. Accordingly, the BVT can save space within the battery pack 202 compared to battery packs that have separate BVTs for individual battery modules.

The interfaces 404 can be or include high voltage or low voltage interfaces (e.g., contactors or ports) or thermal interfaces (e.g., a port for connecting an output of the BVT monitor 402 to an external computer, such as a battery management system of a vehicle). The interfaces 404 can be located in the front (e.g., the front end) of the battery pack 202 to increase accessibility and improve servicing capabilities of the battery pack 202. Connections (e.g., all the connections of the battery pack 202) can be routed to the interfaces 404 at the front of the battery pack 202. Accordingly, the connections of the battery pack 202 can be made without any external pouches being added to the battery pack 202. A rear drive unit interface or port can be placed on a top surface of the battery pack 202.

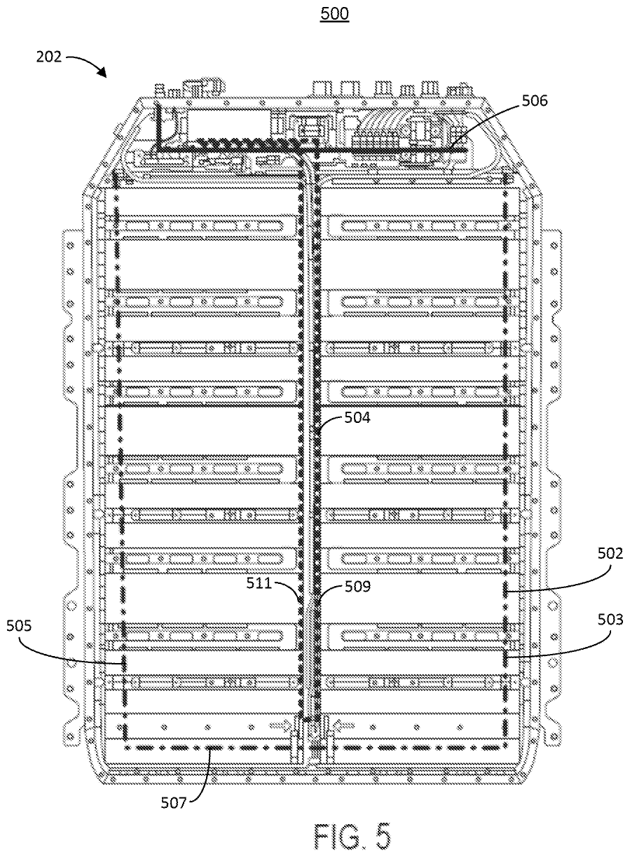

FIG. 5 depicts an example cross-sectional view 500 of the battery pack 202. As depicted in FIG. 5, the battery pack 202 can include a busbar 502, a harness 504, and a harness 506. The busbar 502 can be a high voltage busbar. For example, the busbar 502 can be configured to carry high voltage current between the battery modules 302, 304, 306, and 308 and to loads of the battery pack 202. High voltage can include voltage in the range of, for example, 315-489.9 volts. The busbar 502 can be connected to the battery modules 302, 304, 306, and 308 at the middle of the battery modules 302, 304, 306, and 308. The harness 504 can be a low voltage harness or a first harness. The harness 504 can be configured to carry low voltage current between the battery modules 302, 304, 306, and 308 and to loads of the battery pack 202. Low voltage can include a voltage of, for example, 12V. Low voltage and high voltage can each be or have any voltage range or value. The low voltage current can have a lower voltage than the high voltage current. The harness 506 can be or include a battery management system (BMS) harness or a second harness. The harness 506 can connect a controller (e.g., the BVT monitor 402 or a controller of a BMS of the vehicle in which the battery pack 202 is located) to the battery modules 302, 304, 306, and 308 or to the interfaces 404. Through the harness 506, the controller can operate to control the output of the battery modules 302, 304, 306, and 308. The controller can do so based on readings or measurements by the BVT monitor 402.

The busbar 502 can include a first portion 503, a second portion 505, and a third portion 507. The first portion 503 of the busbar 502 can extend across an edge of the battery pack 202 and contact high voltage ports of the battery modules 302, 304, 306, and 308. The second portion 505 of the busbar 502 can extend across an opposite edge of the battery pack 202 and contact high voltage ports of the battery modules 302, 304, 306, and 308. The portion 507 of the busbar 502 can extend between (e.g., connect) the portions 503 and 505 of the busbar 502. The busbar 502 can distribute or conduct high voltage current to high voltage ports of the battery pack 202 (e.g., high voltage ports of the VDB 2310).

The harness 504 can include a first portion 509 and a second portion 509. The harness 504 can contact or plug into circuitry (e.g., the circuits 4710 or 4722) of the battery modules 302, 304, 306, and 308. The circuitry can reduce the voltage of the current provided by the battery modules 302, 304, 306, and 308 such that the harness 504 can distribute or conduct low voltage current to low voltage ports of the battery pack 202 (e.g., low voltage ports of the VDB 2310).

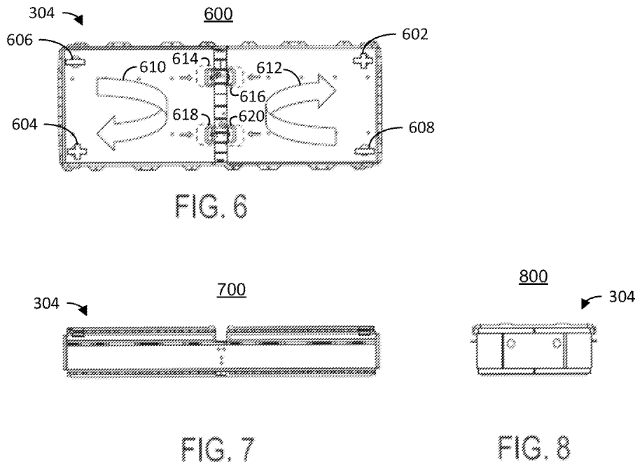

FIGS. 6, 7, and 8 depict a top view 600, a side view 700, and a front view 800 of the battery module 304 of the battery pack 202. The battery modules 306 and 308 can have similar or the same components as the battery module 304. As illustrated in FIG. 6, the battery module 304 can include positive terminals 602 and 604, negative terminals 606 and 608, current flow directions 610 and 612, and low voltage connectors 614, 616, 618, and 620. The terminals 602, 604, 606, and 608 can each be or include high voltage terminals. Current can flow from the negative terminals 606 and 608 to the positive terminals 602 and 604 in the current flow directions 610 and 612.

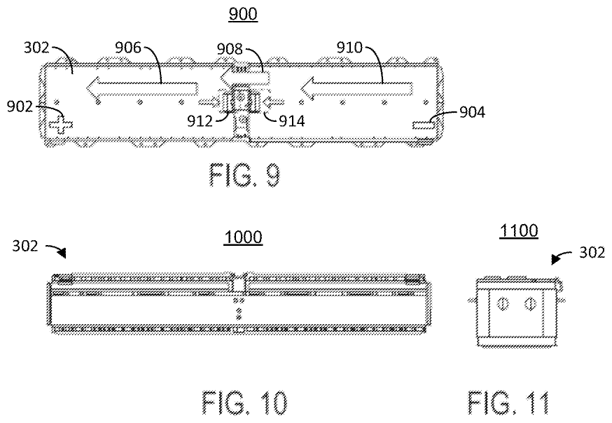

FIGS. 9, 10, and 11 depict a top view 900, a side view 1000, and a front view 1100 of the battery module 302 of the battery pack 202. As illustrated in FIG. 9, the battery module 302 can include a positive terminal 902, a negative terminal 904, current flow directions 906, 908, and 910, and low voltage terminals 912 and 914. The terminals 902 and 904 can each be or include high voltage terminals. Current can flow from the negative terminal 904 to the positive terminal 902 in the current flow directions 906, 908, and 910.

FIG. 12 depicts an exploded view 1300 of the battery module 304 of the battery pack 202. As illustrated in the exploded view 1300, the battery module 304 can include one or a plurality of battery cells 1302, one or more divider plates 1304, a current collector assembly 1306, side walls 1308, a thermal component 1310, end plates 1312, a cover 1314, a fixation board 1316, an insulation board 1318, and a fastener 1328. Although the battery cells 1302 can be LFP prismatic battery cells, battery cells 1302 can include another suitable type of cells such as cylindrical cells. The battery cells 1302 can be connected in series with each other within the battery module 304. The battery cells 1302 can be divided between each other by divider plates 1304. For example, the battery cells 1302 can be arranged in rows or columns within the battery module 304 with divider plates 1304 separating the individual rows or columns. The current collector assembly 1306 can overlay the battery cells 1302. The current collector assembly 1306 can operate to connect (e.g., electrically connect in series) pairs or any number of the battery cells 1302 via terminals of the battery cells 1302.

The battery cells 1302 can be enclosed by the battery housing 315 of the battery module 304. The battery housing 315 can include the side walls 1308, the thermal component 1310, the end plates 1312, and the cover 1314. The side walls 1308, the thermal component 1310, the end plates 1312, and the cover 1314 can connect with each other to maintain the shape (e.g., a square, a rectangle, a triangle, a trapezoid, or a circle) and functioning of the battery module 304. The end plate can have a width of 30 mm. The thermal component 1310 can be or include a cold plate. The thermal component 1310 can facilitate temperature control of the battery cells 1302 for improved functioning (e.g., improve efficiency or minimize power losses during storage or charge/discharge). Although the battery cells 1302 are shown to be part of the battery module 304, a battery module or the battery cells can include any suitable group of battery cells.

The fixation board 1316 and the insulation board 1318 can facilitate operation of the battery module 304. The fixation board 1316 and the insulation board 1318 can be members (e.g., lateral cross-members). The fixation board 1316 can be coupled or attached to the thermal component 1310 dividing the battery cells 1302 into portions such as halves, quarters, or different sized portions (e.g., divided into varying sized sets of battery cells). The fixation board 1316 can extend across the battery module 304 in a first direction (e.g., within the battery housing 315). The insulation board 1318 can be separated into two parts on opposite sides of the fixation board 1316. The insulation board 1318 can extend across the battery module 304 in a second direction (e.g., within the battery housing 315). The fixation board 1316 can operate as support to ensure the components of the battery module 304 can maintain their shape, position, or connection within the battery module 304. The insulation board 1318 can be or include an electrical insulation board to physically or electrically separate the battery cells 1302 from each other.

Each of the fixation board 1316 and the insulation board 1318 can protect the battery cells 1302 respectively separated by the fixation board 1316 and the insulation board 1318. The fixation board 1316 and the insulation board 1318 in combination with members (e.g., lateral cross members) of the housing of the battery pack 202 can protect the battery module 304 in case of a crash. For example, the fixation board 1316 and the insulation board 1318 in combination with members of the housing of the battery pack 202 can transfer loads from side to side of the a vehicle during crash impacts. The fixation board 1316 and the insulation board 1318 in combination with members of the housing of the battery pack 202 can absorb energy during the impact of the crash to minimize the energy that the battery housing 315 would absorb during impact.

The fixation board 1316 and the insulation board 1318 can divide the battery cells 1302 in separate sets or pluralities of battery cells 1320, 1322, 1324, and 1326 within the battery module 304. For example, the battery cells 1302 can be positioned within the battery housing 315 in a double-wide cell arrangement. In the double-wide cell arrangement, the battery cells 1302 can be divided into two rows of battery cells. The two rows of battery cells can be next to each other (e.g., next to each other within the battery housing 315). For example, the two rows can each have the same number of battery cells. The battery cells of one row can be directly adjacent to (e.g., have parallel or continuous edges with) the battery cells of the other row. Any number of rows of battery cells can be arranged in this manner within the battery pack 202. The battery housing 315 can be larger or smaller to house any number of rows of battery cells. In one example, the fixation board 1316 and the insulation board 1318 can be coupled within the battery housing 315 of the battery module 304 to create quadrants (e.g., equally sized quadrants). A different set of battery cells 1320, 1322, 1324, or 1326 can be placed or be disposed in each of the quadrants. The portions can be quadrants of the battery module 304. For example, the battery module 304 can include a first portion, a second portion, a third portion, and a fourth portion. The portions can have the same or a different number of battery cells.

The fastener 1328 can fasten or couple the thermal component 1310 with the end plate 1312. The fastener 1328 can be or include a screw, a nail, a bolt, or any other type of fastener. The fastener 1328 can include a first flat plate that couples (e.g., screws) to the thermal component 1310 and a second flat plate transverse to the first flat plate that couples (e.g., screws) to the end plate 1312. By doing so, the fastener 1328 can maintain the shape of the battery housing 315 of the battery module 304.

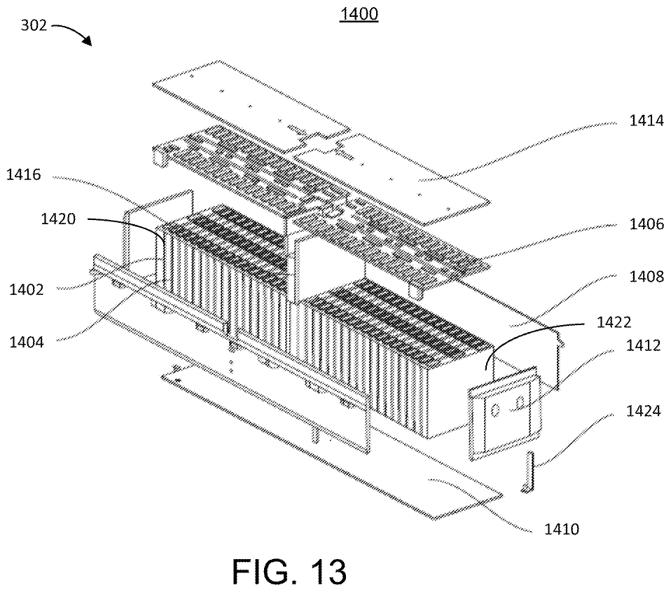

FIG. 13 depicts an exploded view 1400 of the battery module 302 of the battery pack 202. As illustrated in the exploded view 1400, the battery module 302 can include one or a plurality of battery cells 1402, one or more divider plates 1404, a current collector assembly 1406, side walls 1408, a thermal component 1410, end plates 1412, a cover 1414, a fixation board 1416, and a fastener 1424. The components 1402-1418 can be similar to the similarly named or corresponding components 1302-1320, shown and described with reference to FIG. 12. For example, the battery cells 1402 can be LFP prismatic battery cells. The number of battery cells in the battery cells 1402 can be smaller (e.g., by half) than the number of battery cells in the battery cells 1302. The battery cells 1402 can be connected in series with each other within the battery module 302. The battery cells 1402 can be divided between each other by divider plates 1404. For example, the battery cells 1402 can be arranged in rows or columns within the battery module 302 with divider plates 1404 separating the individual rows or columns. The battery module 302 can include fewer battery cells than one or more of the battery modules 304, 306, or 308. The current collector assembly 1406 can overlay the battery cells 1402. The current collector assembly 1406 can operate to connect (e.g., electrically connect in series) pairs or any number of the battery cells 1402 via terminals of the battery cells 1402.

The battery cells 1402 can be enclosed by the battery housing 313 of the battery module 302. The battery housing 313 can include the side walls 1408, the thermal component 1410, the end plates 1412, and the cover 1414. The side walls 1408, the thermal component 1410, the end plates 1412, and the cover 1414 can connect with each other to maintain the shape (e.g., a square, a rectangle, a triangle, a trapezoid, or a circle) and functioning of the battery module 302. The thermal component 1410 can be or include a cold plate. The thermal component 1410 can facilitate temperature control of the battery cells 1402 for improved functioning (e.g., improved efficiency or to minimize power losses during storage or charge/discharge). The side walls 1408 can be the same size (e.g., length or width) as the side walls 1308. The end plates 1412 can be or have a smaller size (e.g., length or width) than the end plates 1312 when the battery module 302 is configured to store fewer battery cells than the battery module 304.

The fixation board 1416 can be configured to maintain the shape of the battery module 302. The fixation board 1416 can be coupled or attached to the thermal component 1410 dividing the battery cells 1402 into halves or different sized portions (e.g., divided into varying sized sets of battery cells). The fixation board 1416 can extend across the battery module 302 (e.g., within the battery housing 313) in a first direction. The fixation board 1416 can operate as support to ensure the components of the battery module 302 can maintain the components' shape, position, or connection within the battery module 302.

The fixation board 1416 can protect the battery cells 1402 respectively separated by the fixation board 1416. The fixation board 1416 in combination with members (e.g., lateral cross members) of the housing of the battery pack 202 can protect the battery module 302 in case of a crash. For example, the fixation board 1416 in combination with lateral cross members of the housing of the battery pack 202 can transfer loads from side to side of the a vehicle during crash impacts. The fixation board 1416 in combination with lateral cross members of the housing of the battery pack 202 can absorb energy during the impact of the crash to minimize the energy that the battery housing 313 would absorb during impact.

The fixation board 1416 can divide the battery cells 1402 in separate sets or pluralities of battery cells 1420 and 1422 within the battery module 302. For example, the fixation board 1416 can be coupled within the battery housing 313 of the battery module 302 to create halves (e.g., equally sized halves). A different set of battery cells 1420 or 1422 can be placed or be disposed in each of the halves. The sets of battery cells 1420 or 1422 can each be the same size as the individual sets of battery cells 1320, 1322, 1324, and 1326.

The fastener 1424 can fasten or couple the thermal component 1410 with the end plate 1412. The fastener 1424 can be or include a screw, a nail, a bolt, or any other type of fastener. The fastener 1424 can include a first flat plate that couples (e.g., screws) to the thermal component 1410 and a second flat plate transverse to the first flat plate that couples (e.g., screws) to the end plate 1412. By doing so, the fastener 1424 can maintain the shape of the battery housing 313 of the battery module 302.

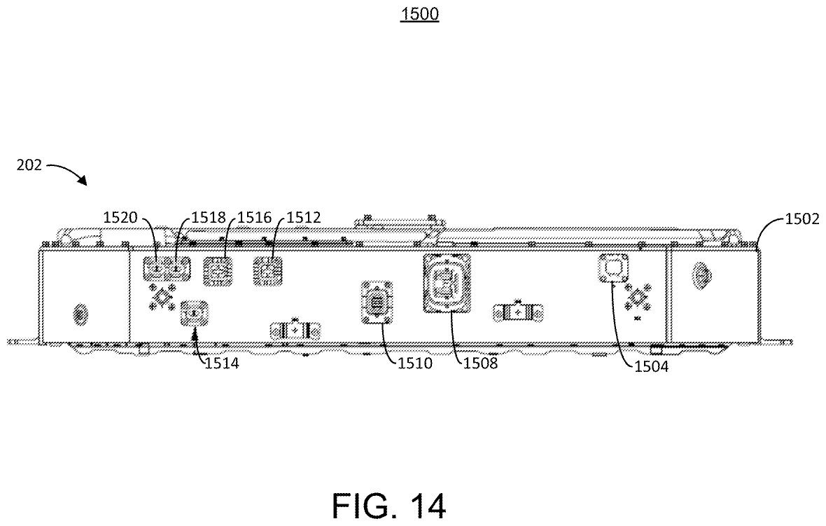

FIG. 14 depicts a front view 1500 of the battery pack 202. As depicted in the front view 1500, a surface 1502 (e.g., a front surface) of the battery pack 202 can include a low voltage port 1504, a direct current fast charging (DCFC) port 1508, a front driving unit (FDU) port 1510, a direct current (DC)/alternating current (AC) & heating, ventilation, and air conditioning (HVAC) port 1512, a spare port 1514, an electrical A/C compressor (EAC) & DC/DC left hand (LH) port 1516, an on-board charger (OBC) port 1518, and a DC/DC right hand (RH) port 1520. The surface 1502 can be an outer surface of the battery pack 202. Each of the ports 1504-1520 can be connection ports or contacts connecting battery cells of the battery pack 202 with different loads internal or external (e.g., inside or outside) to an electric vehicle.

The low voltage port 1504 can be configured to provide low voltage power to loads (e.g., loads within an electrical vehicle). The low voltage port 1504 can be configured to handle 24 Watts of power. The DCFC port 1508 can be configured to provide fast charging of the battery cells within the battery pack 202. The DCFC port 1508 can do so because the DC power can be directly applied to the battery cells within the battery pack 202. The DCFC port 1508 can have a cross-sectional area of 3 millimeters (mm) squared. The FDU port 1510 can connect the battery cells of the battery pack 202 to the front drive unit of an electric vehicle the battery pack 202 is powering. The FDU port 1510 can have a cross-sectional area of 70 mm squared. The FDU port 1510 can be, include, or be of an interface (e.g., a first interface or a front drive unit interface). The DC/AC and HVAC port 1512 can be configured to connect battery cells of the battery pack 202 to HVAC equipment within an electric vehicle. The DC/AC and HVAC port 1512 can have a cross-sectional area of 3 mm squared. The spare (idle) port 1514 can be a non-dedicated port configured to connect battery cells of the battery pack 202 to an external load. The spare (idle) port 1514 can be 3 mm squared. The EAC and DC/DC LH port 1516 can be configured to connect battery cells of the battery pack 202 to an electrical air conditioning compressor of an electric vehicle. The EAC and DC/DC LH port 1516 can have a cross-sectional area of 3 mm squared. The OBC port 1518 can be configured to connect an external AC power source to an on-board charger of the battery pack. The on-board charger can convert AC power supplied by the AC power source to DC power to charge the battery cells of the battery pack 202. The OBC port 1518 can have a cross-sectional area of 4 mm squared. The DC/DC RH port 1520 can be configured to connect the battery pack 202 to a DC power source. The DC/DC RH port 1520 can have a cross-sectional area of 3 mm squared.

Placing each of the ports 1504-1520 at the surface 1502 (e.g., the same surface) can enable cables connecting the ports 1504-1520 to the battery modules 302-308 (e.g., the cells of the battery modules 302-308) to be routed to a common of the battery pack 202 within the housing of the battery pack 202 without requiring any external pouches to hold the cables. The placement can reduce the amount of space the battery pack 202 requires when placed in an electric vehicle.

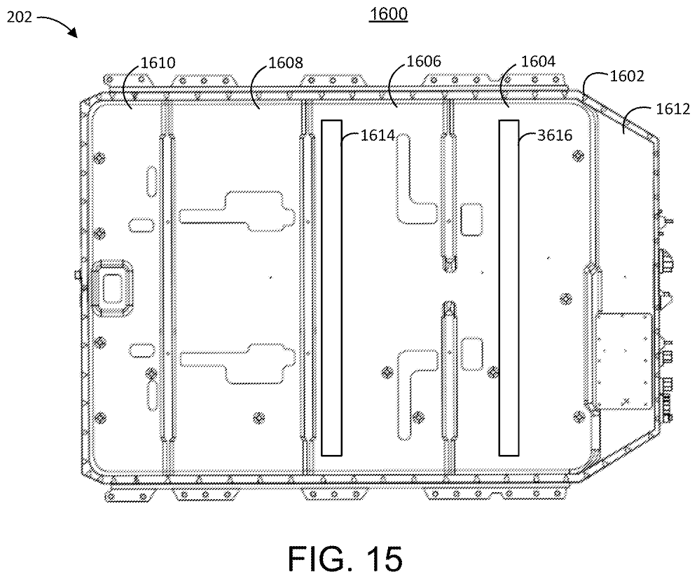

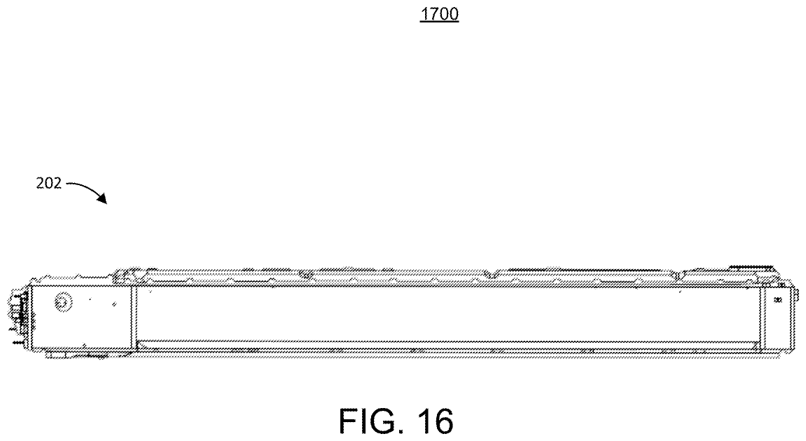

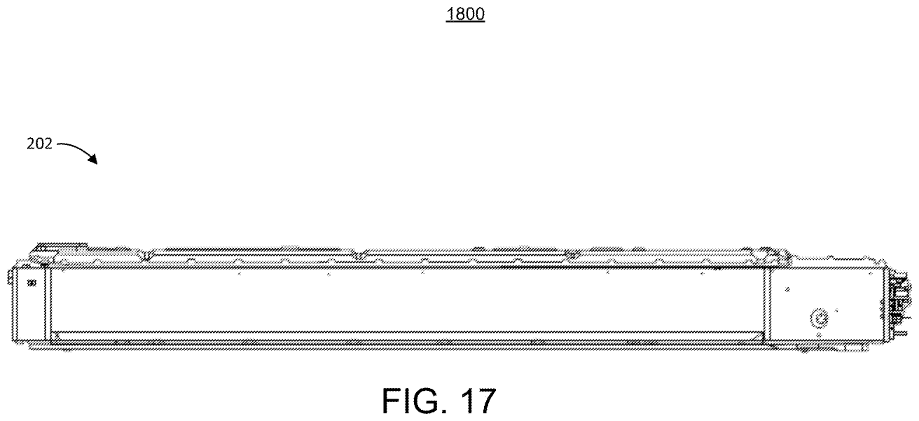

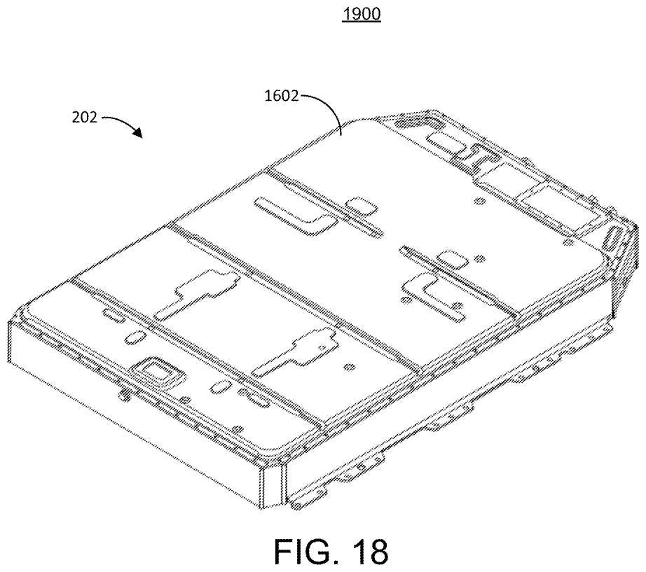

FIGS. 15, 16, 17, and 18 respectively depict a top view 1600 of the battery pack 202, a side view 1700 of the battery pack 202, a side view 1800 of the battery pack 202, and a perspective view 1900 of the battery pack 202. As illustrated in each of the views 1600, 1700, 1800, and 1900, a housing (e.g., the housing 2315) of the battery pack 202 can enclose battery modules and/or battery cells within the battery pack 202. The housing can include a cover 1602 that covers the components within the battery pack 202. The cover 1602 can be or include aluminum or another metal (e.g., a light flexible metal). Aluminum can provide advantages as a material of the cover 1602 because aluminum is relatively strong has a high electromagnetic compatibility, and can be shaped or configured to hold a service window (e.g., a fuse service window). The cover 1602 can be shaped or configured to hold the battery modules 302, 304, 306, and 308 within the battery pack 202 in place. For example, the cover 1602 can include bay (e.g., compartment) covers 1604, 1606, 1608, and 1610 that are sized to the battery modules 302, 304, 306, and 308 (e.g., the cover 1602 can include three bay covers 1604, 1606, and 1608 of equal size (e.g., area) and a fourth bay cover 1610 smaller than the three bay covers 1604, 1606, and 1608 to account for the size and shapes of the battery modules 302, 304, 306, and 308).

The bay covers 1604, 1606, 1608, and 1610 can cover openings of individual bays (e.g., the bays 3616, 3618, 3620, 3622, and 3624) in the battery pack 202. The openings can be on top of the bays. The battery modules 302, 304, 306, and 308 can be placed in the individual bays through the openings. The cover 1602 can be placed over the openings to be adjacent to the bays. The cover 1602 can include bay covers in any configuration or shape to account for different sizes, shapes, or configurations of battery modules within the battery pack 202. The bay covers 1604, 1606, 1608, and 1610 can each have a raised region 1614 in which the bay covers 1604, 1606, 1608, and 1610 rise with respect to (e.g., transverse to) a floor of the battery pack 202. The raised region 1614 can facilitate the battery modules 302, 304, 306, and 308 fitting into (e.g., each having a shape that conforms to a shape of a bay) a different bay (e.g., the area below a respective bay cover) within the battery pack 202. The raised region 1614 can have any size or shape at any location within the battery pack or within the individual bay covers 1604, 1606, 1608, and 1610.

The bay covers 1604, 1606, 1608, and 1610 can have a depressed region 1616. In the depressed region 1616 of the bay covers 1604, 1606, 1608, and 1610, the bay covers can depress towards the floor of the battery pack 202. The depressed region 1616 of bay covers 1604, 1606, 1608, and 1610 can facilitate the battery modules 302, 304, 306, and 308 remaining in place within the battery pack 202 (e.g., the individual battery modules 302, 304, 306, and 308 will each be blocked from shifting within the battery pack 202 by the depressed regions 1616 of the bay covers 1604, 1606, 1608, and 1610). The bay covers 1604, 1606, 1608, and 1610 can be sized or shaped to hold any number of components (e.g., busbars, cables, harness, or connectors) of the battery pack 202. The depressed region 1616 can have any size or shaped within the battery pack or within the individual bay covers 1604, 1606, 1608, and 1610. In one example, the depressed region 1616 can be a line on opposite edges of one of the bay covers 1604, 1606, 1608, or 1610 that extends from edge to edge of the battery pack 202 or that covers a portion of any size or shape at any location of the bay cover.

The battery pack 202 can include a circuitry bay 1612. The circuitry bay 1612 can be a front end portion of the battery pack 202 while the bay underneath the bay cover 1610 can be a back end portion of the battery pack 202. The circuitry bay 1612 can include the ports 1504-1520. The ports 1504-1520 can be configured to connect the battery cells within the battery pack 202 to external loads as well as a processor and memory for the battery pack that is configured to monitor the health or state of charge of the battery modules 302, 304, 306, and 308 within the battery pack 202. The circuitry bay 1612 can include a BVT monitor (e.g., the BVT monitor 402) or a VDB (e.g., the VDB 2310).

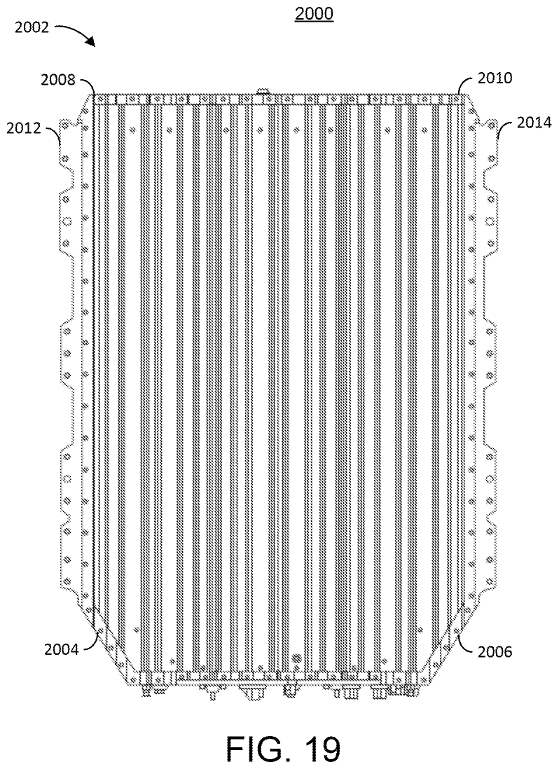

FIG. 19 depicts a bottom view 2000 of a plate 2002 of the battery pack 202. The plate 2002 can be a floor plate of the battery pack 202. As illustrated in the bottom view 2000, the plate 2002 can have a shape that matches the shape of the cover 1602. The plate 2002 can have two chamfered corners 2004 and 2006 adjacent (e.g., at opposite ends of the same edge or end of the plate 2002) to each other at one end of the plate 2002 and two right angle (e.g., substantially right angle) corners 2008 and 2010 at an opposite end of the plate 2002 from the chamfered corners 2004 and 2006. Extensions 2012 and 2014 (e.g., metallic extensions) can extend from the plate 2002. Fasteners (e.g., screws, nails, or clips) can fasten the battery pack 202 to a frame (e.g., the frame 204) of an electric vehicle through the extensions 2012 and 2014. The extensions 2012 and 2014 can be a part of or separate from the plate 2002.

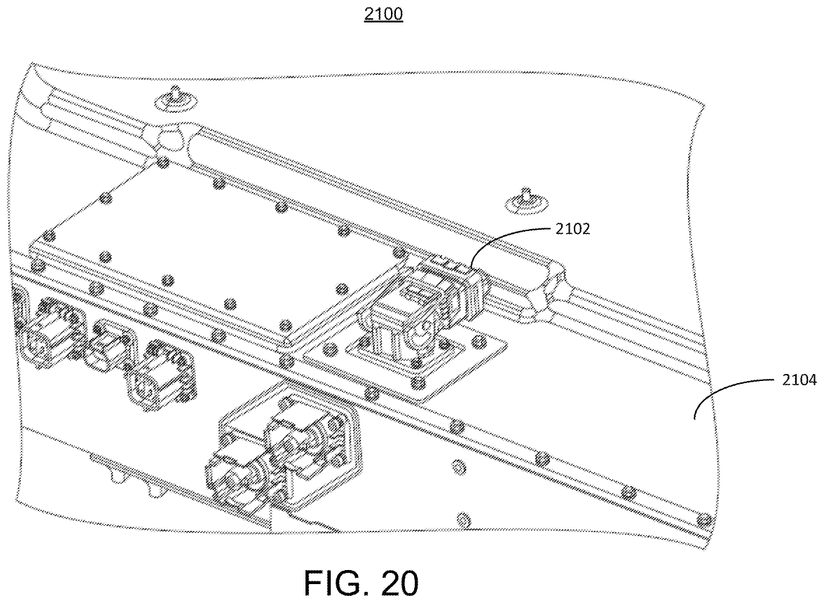

FIG. 20 depicts a partial perspective view 2100 of the battery pack 202. As illustrated in the partial perspective view 2100, a rear drive unit (RDU) port 2102 can be coupled or attached to a surface 2104 (e.g., a top surface or a second surface) of the battery pack 202. The RDU port 2102 can be, include, or be of an interface (e.g., second interface) configured to connect battery cells of the battery pack 202 with an RDU of an electric vehicle. The RDU port 2102 can be coupled to the surface 2104 of the battery pack 202 by being coupled to the top surface of the circuitry bay 1612. The RDU port 2102 can be located above the ports 1504-1520 at a front end of the battery pack 202. For example, the RDU port 2102 can be located next to a bay (e.g., the bay under the bay cover 1604) of the battery pack 202 at the front end of the battery pack 202. Placing the RDU port 2102 on the surface 2104 at the front end of the battery pack 202 can reduce the number of cables or wires that are internally (e.g., within the battery pack 202) fed into the ports at the surface 1502 of the battery pack 202 while facilitating the connections (e.g., each connection) between the battery cells within the battery pack 202 and external loads at the front end of the battery pack 202.

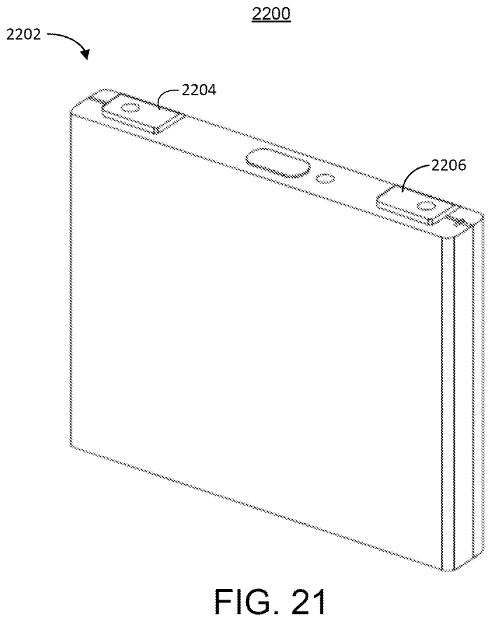

FIG. 21 depicts a perspective view 2200 of a battery cell 2202. The battery cell 2202 can be one or more or each of the battery cells in the battery modules 302, 304, 306, and 308 within the battery pack 202. The battery cell 2202 can include a negative terminal 2204 and a positive terminal 2206. Current within the battery cell 2202 can flow from the negative terminal 2204 to the positive terminal 2206. The battery cell 2202 can be shaped as a rectangular prism or any other shape (e.g., a cube, a trapezoid prism, a pyramid, or a cylinder). The battery cell 2202 can be or include an LFP prismatic battery cell. The battery cell 2202 may or may not include an internal fuse. The internal fuse can electrically disconnect the battery cell 2202 from a load to avoid or prevent thermal runaways. The battery cell 2202 can have dimensions of 28 mm to 31 mm by 205 mm to 210 mm by 170 mm to 180 mm. The battery cell 2202 can have any dimensions.

The battery cell 2202 can be thinner, thicker, longer, or shorter than the battery cell 2202 as illustrated in FIG. 21. In one example, the battery cell 2202 can be thinner for embodiments of a cell-to-pack architecture in which battery cells are not enclosed battery modules, but are rather placed directly into a battery pack. Such embodiments can reduce the weight of the battery packs because the housings of battery modules can be heavy. Having thinner battery cells for a cell-to-pack architecture can increase the energy efficiencies because the vehicles can be lighter.

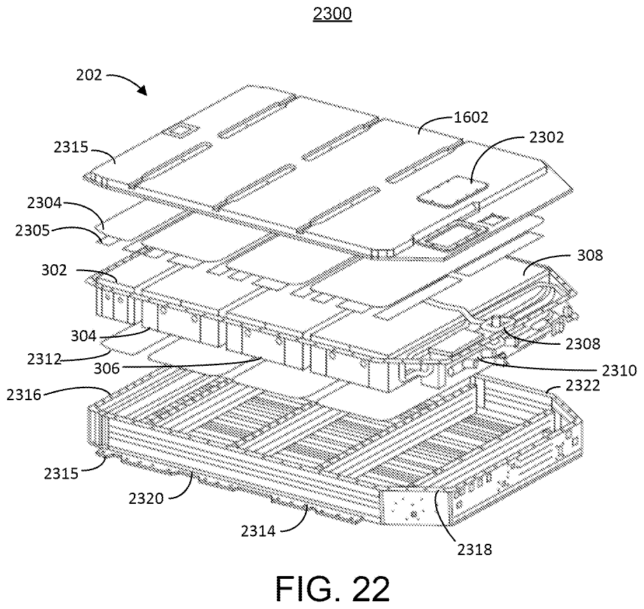

FIG. 22 depicts an exploded view 2300 of the battery pack 202. As illustrated in the exploded view 2300, the battery pack 202 can include the cover 1602, thermal insulation 2304, structure insulation 2305, a current collector assembly 2306, the battery modules 302, 304, 306, and 308, the cooling pipe 2308, a voltage distribution box (VDB) 2310, thermal insulation 2312, and a base 2314. The cover 1602 in combination with the base 2314 can form the housing 2315 of the battery pack 202. The cover 1602 can include a service window 2302. The portions of the base 2314 can be continuous with each other (e.g., each portion of the base can overlay a floor of the base 2314). The service window 2302 can be located and configured to open or be removed such that a technician can replace or take off a busbar through the service window 2302. A fuse of the VDB 2310 can be visible or exposed through the service window 2302. A technician can remove or replace the fuse of the VDB 2310 through the service window 2302. The service window 2302 can be located at a bay cover (e.g., in the middle or substantially the middle of the bay cover) of the cover 1602 (e.g., the bay cover 1604) nearest the circuitry bay (e.g., the circuitry bay 1612) of the battery pack 202.

The battery pack 202 can include the thermal insulation 2304. The thermal insulation 2304 can be sandwiched between the cover 1602 and the current collector assembly 2306. The thermal insulation 2304 can be or include thermal insulation material, such as fiberglass, mineral wool, cellulose, polyurethane foam, or polystyrene. The thermal insulation 2304 can be configured to reduce the impact of changes in environment temperature around the battery pack 202 on the temperature of the battery cells within the battery modules 302, 304, 306, and 308.

The battery pack 202 can include the structure insulation 2305. The structure insulation can be a strong material (e.g., metal, plastic, or foam) located between the thermal insulation 2304 and the battery modules 302, 304, 306, and 308. The structure insulation can operate to protect battery cell interconnections of the battery modules 302, 304, 306, and 308 in case weight is placed on top of the battery pack 202.

The battery pack 202 can include the cooling pipe 2308. The cooling pipe 2308 can be or include a pipe configured to carry liquid (e.g., water or glycol) through thermal components of the battery modules 302, 304, 306, and 308. The cooling pipe 2308 can be connected to a thermal component for each battery module 302, 304, 306, and 308 and carry the liquid through each of the thermal components. Accordingly, the cooling pipe 2308 can operate to control (e.g., reduce or increase) the temperature of the battery cells of the battery modules 302, 304, 306, and 308.

The battery pack 202 can include the VDB 2310. The VDB 2310 can be or include a high voltage distribution box (HVDB). The VDB 2310 can be or include a device configured to connect external loads to high or low voltage terminals of the battery modules 302, 304, 306, and 308. The VDB 2310 can include high voltage ports (e.g., the ports 1514-1520) and connections with one or more busbars (e.g., the busbar 502) of the battery pack 202. The VDB 2310 can facilitate energy transfer between the busbars and loads connected to the high voltage ports. The VDB 2310 can include temperature control equipment and components to avoid overheating during the energy transfer. The VDB 2310 can be communicably or electrically coupled with the battery modules 302, 304, 306, or 308 (e.g., the plurality of battery cells of each of the battery modules 302, 304, 306, or 308 (e.g., a first plurality of battery of the battery module 302 and a second plurality of battery cells of the battery module 304)) by monitoring the voltage or temperature of the battery modules 302, 304, 306, or 308 via temperature or voltage sensors or by receiving or distributing power from the battery modules 302, 304, 306, or 308.

The battery pack 202 can include the thermal insulation 2312. The thermal insulation 2312 can be sandwiched between the battery modules 302, 304, 306, and 308 and the base 2314. The thermal insulation 2312 can be similar to the thermal insulation 2304.

The battery pack 202 can include the base 2314. The base 2314 can be or include a plate (e.g., a floor) of the battery pack 202. The base 2314 can include multiple bays, a bay for each of the battery modules 302, 304, 306, and 308, and a circuitry bay (e.g., the circuitry bay 1612). The circuitry bay can be configured to house the ports (e.g., the ports 1504-1520) and the VDB 2310 of the battery pack 202. The bays can be separated by members (e.g., lateral cross members). The members can span the length or width of the base 2314 or be spaced apart equal to the spacing between the bay cover edges of the cover 1602 such that the battery modules 302, 304, 306, and 308 can be disposed or fit between the members and the circuitry of the battery pack 202 can fit within the circuitry bay 1612.

In one example, the base 2314 can include a first end portion 2316 and a second end portion 2318. The base 2314 can be the housing 2315 of the battery pack 202 or be a part of the housing 2315 of the battery pack 202 in combination with the cover 1602. The first end portion 2316 and the second end portion 2318 can be on opposite ends of the base 2314. The first end portion 2316 can be a bay for the battery module 302 and the second end portion 2318 can be a bay (e.g., the circuitry bay 1612) to hold the circuitry of the battery pack 202. Sides 2320 and 2322 (e.g., side walls 2320 and 2322) can extend between the first end portion 2316 and the second end portion 2318. The battery module 302 (e.g., a first battery module) can be configured to dispose or fit into the first end portion 2316 and the battery module 308 (e.g., a second battery module) can be configured to fit into the base 2314 between the first end portion 2316 and the second end portion 2318. For example, the battery module 302 can have a length 305 that extends in a direction from the first end portion 2316 towards the second end portion 2318. The battery module 308 can have the length 311 that extends in a direction from the first end portion 2316 to the second end portion 2318. The battery module 302 and battery module 308 can each have the widths 303 and 309, respectively that extends from or between the side 2320 towards the side 2322 (e.g., in a direction transverse to the sides 2320 and 2322). The widths 303 and 309 of the battery module 302 and the battery module 308 can be the same or equal. The length 311 of the battery module 308 can be greater than the length 305 of the battery module 302. The battery module 308 can be disposed in a portion (e.g., a bay, such as the bay under the bay cover 1604) of the base 2314. The battery modules 304 and 306 can be disposed to areas between the first end portion 2316 and the second end portion 2318 within the base 2314 (e.g., in different bays or portions between the first end portion 2316 and the battery module 308). The battery modules 304 and 306 can be positioned and have similar or the same dimensions as the battery module 308 when disposed or fit into the base 2314.

The battery modules 302, 304, 306, and 308 and the circuitry of the battery pack 202 can be disposed or fit into their respective portions (e.g., bays) of the base 2314. While disposed within the portions, a harness (e.g., the harness 504 or a first harness) can extend from the first end portion 2316 to the second end portion 2318. The harness can do so over (e.g., contacting) low voltage connectors (e.g., the low voltage connectors 614-620) of the battery modules 302, 304, 306, and 308. A busbar (e.g., the busbar 502) can extend along the edge of the base 2314. For example, a first portion of the busbar can extend over the high voltage terminals of the battery modules 302, 304, 306, and 308 along the sides 2320 or 2322. A second portion of the busbar can extend across the first end portion 2316. A harness (e.g., the harness 506 or a second harness) can extend across the second portion connecting the components in the circuitry bay 1612.

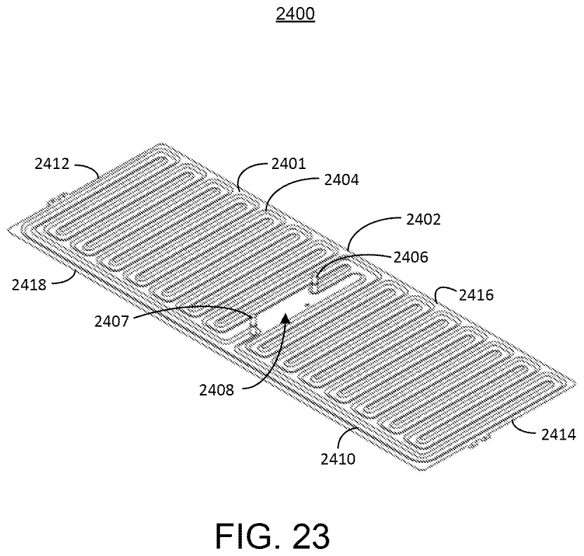

FIG. 23 depicts a perspective view 2400 of a thermal component 2402. The thermal component 2402 can be, include, or be a part of a cold plate of the battery pack 202. The thermal component can have a surface 2401. The thermal component 2402 can be sized to match or fit as a bottom of one of the battery modules 302, 304, 306, or 308. For example, a smaller thermal component (e.g., a thermal component having a smaller volume or a surface (e.g., a top surface) with a smaller area) can fit to the bottom of the battery module 302 than a thermal component attached or sized to fit to one or each of the battery modules 304, 306, or 308 to account for differences in size between the battery modules 302, 304, 306, or 308. The thermal component 2402 can be configured to cool or otherwise control the temperature of the battery cells of one of the battery modules 302, 304, 306, or 308. For example, the thermal component 2402 (e.g., a first thermal component) can transfer heat from the battery module 302, 304, 306, or 308 to which the thermal component 2402 is attached or configured to cool. A second thermal component similar to the thermal component 2402 can be sized to span the bottom of another of the battery modules 302, 304, 306, or 308 can transfer heat from (e.g., cool) the battery module 302, 304, 306, or 308.

The thermal component 2402 can include a serpentine structure 2404 on the surface 2401 (e.g., on the top surface of the thermal component 2402). The serpentine structure 2404 can be or include a pipe, a tube, a crevice, or a channel through which fluid can travel. The serpentine structure 2404 can have a flow path including a repeating “s” shape (e.g., a serpentine portion) on the thermal component 2402 with tight curves and a straight portion 2410 along at least one edge of the thermal component 2402. The shape can maximize the surface area of a plate (e.g., an upper plate) placed above and contacting the serpentine structure 2404 that the serpentine structure 2404 contacts. Doing so can increase the impact that the thermal component 2402 can have on the temperature of the battery cells above or contacting the plate or the serpentine structure 2404 itself.

The serpentine structure 2404 can have one or more faucets 2406 and 2407 that extend away (e.g., transverse) to the thermal component 2402. The one or more faucets 2406 and 2407 can be located in or extend from a middle portion 2408 (e.g., a first middle portion or a second middle portion that is substantially the middle of the thermal component 2402) of the serpentine structure 2404 or thermal component 2402. The one or more faucets 2406 and 2407 can be located at any location on the thermal component 2402 (e.g., the faucet 2406 and 2407 can be on opposite sides 2412 and 2414 or edges 2416 and 2418 of the thermal component 2402, on the same side 2412 or 2414 or edge 2416 or 2418 of the thermal component 2402, among other configurations. A liquid, such as water, glycol, or coolant, can flow through the one or more faucets 2406 (e.g., the faucets 2406 can receive liquid) and through the serpentine structure 2404. The liquid can be cold (e.g., have a temperature around or below 32 degrees). The faucet 2406 can be an inlet faucet that receives or is configured to receive a liquid into the serpentine structure 2404. The faucet 2407 can be an outlet faucet that distributes or that is configured to distribute liquid away from the serpentine structure 2404. Accordingly, a plate contacting or above the serpentine structure 2404 can cool down too, reducing the temperature of battery cells located above or in contact with the plate.

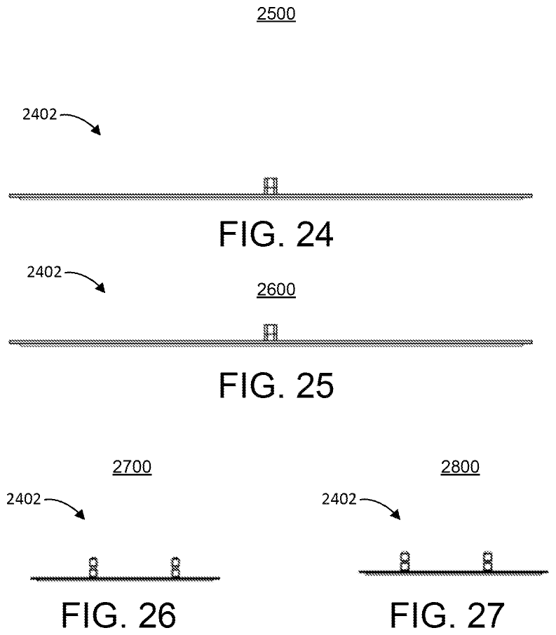

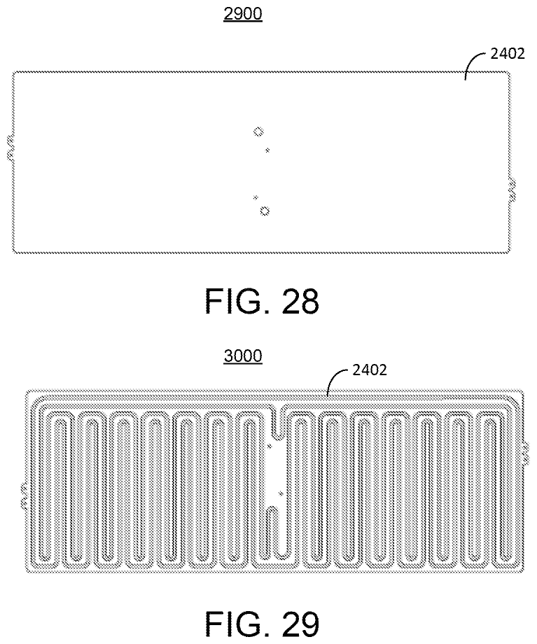

FIG. 24 depicts a front view 2500 of the thermal component 2402. FIG. 25 depicts a back view 2600 of the thermal component 2402. FIG. 26 depicts a side view 2700 of the thermal component 2402. FIG. 27 depicts a side view 2800 of the thermal component 2402. FIG. 28 depicts a top or bottom view 2900 of the thermal component 2402. FIG. 29 depicts a bottom or top view 3000 of the thermal component 2402.

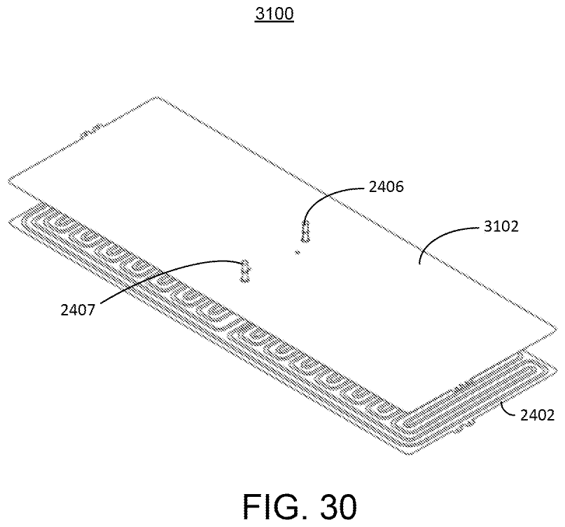

FIG. 30 depicts an exploded view 3100 of the thermal component 2402. As depicted in the exploded view, an upper plate 3102 can be placed over the thermal component 2402. The upper plate 3102 can include holes that are sized to receive the one or more faucets 2406 or 2407. The holes can be positioned anywhere on the upper plate 3102 depending on the location of the faucets 2406 or 2407. The upper plate 3102 can lie on top of the thermal component 2402. In doing so, a bottom surface of the upper plate 3102 can contact the serpentine structure 2404 of the thermal component 2402. Battery cells of a battery module 302, 304, 306, or 308 can contact the upper plate 3102 (e.g., a top surface of the upper plate 3102). When liquid (e.g., cool liquid) flows through the serpentine structure 2404, the liquid can cool the upper plate 3102, which can cool the battery cells of the battery module 302, 304, 306, or 308. The shape of the serpentine structure 2404 can maximize the area of the upper plate 3102 the serpentine structure 2404 contacts. Insulating powder (e.g., 200 micrometer insulating powder) can be sprayed onto a top surface of the upper plate 3102. An insulating material (e.g., mineral wool, cellulose, or polystyrene) can be placed below the thermal component 2402. Accordingly, the serpentine structure 2404 can control or cool the temperature of battery cells contacting or near the upper plate 3102.

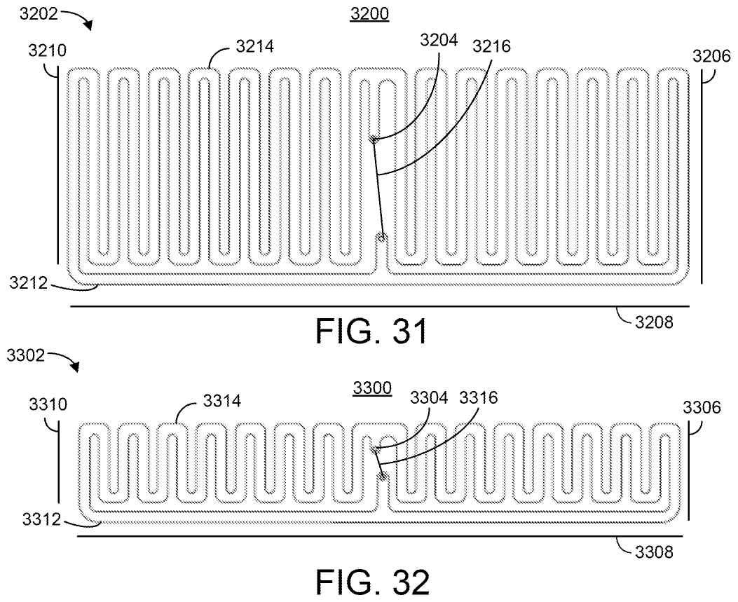

FIG. 31 depicts a top view 3200 of a serpentine structure 3202 and FIG. 32 depicts a top view 3300 of a serpentine structure 3302. The serpentine structure 3202 can be a serpentine structure of a thermal component for a large battery module (e.g., the battery modules 304, 306, and 308) and the serpentine structure 3302 can be smaller than the serpentine structure 3202 and be a serpentine structure of a thermal component for a smaller battery module (e.g., a battery module with fewer battery cells than the large battery module, such as the battery module 302). As illustrated in the views 3200 and 3300, the serpentine structures 3202 and 3302 can have a similar shape (e.g., a first flow path and a second flow path). The serpentine structure 3202 can have a straight portion 3212 (e.g., a second straight portion) and a serpentine portion 3214 (e.g., a second serpentine portion). The straight portion 3212 can span a side of a thermal component on which the serpentine structure 3202 is defined. The serpentine structure 3302 can have a straight portion 3312 (e.g., a first straight portion) and a serpentine portion 3314 (e.g., a first serpentine portion). The straight portion 3312 can span a side of a thermal component on which the serpentine structure 3302 is defined. A length 3210 of the serpentine portion 3214 in the serpentine structure 3202 of the thermal component for the large battery modules can be larger than a length 3310 of the serpentine portion 3314 in the serpentine structure 3302 for the thermal component for the small battery module. Additionally, the distance between faucets 3204 or 3304 of, or attached to, the serpentine structures 3202 and 3302 can vary. For example, a distance 3216 between the faucets 3204 of the serpentine structure 3202 can be larger than a distance 3316 between the faucets 3304 of the serpentine structure 3302. The serpentine structure 3202 can have a length 3206 that is greater than a length 3306 of the serpentine structure 3302. The serpentine structure 3202 can have a width 3208 that is the same or equal to a width 3308 of the serpentine structure 3302. When coupled with (e.g., affixed to a bottom of or be the bottom surface of) one of the battery modules 304, 306, or 308, the length 3206 of the serpentine structure 3202 can extend from one end portion (e.g., the first end portion 2316) towards another end portion (e.g., the second end portion 2318) of the battery pack 202 and the width 3208 can extend between sides (e.g., sides 2320 and 2322) of the battery pack 202. When coupled with (e.g., affixed to a bottom of or be the bottom surface of) the battery module 302, the length 3306 of the serpentine structure 3302 can extend from one end portion (e.g., the first end portion 2316) towards another end portion (e.g., the second end portion 2318) of the battery pack 202 and the width 3308 can extend between sides (e.g., sides 2320 and 2322) of the battery pack 202. Accordingly, the serpentine structures 3202 and 3302 can be sized to cool battery cells in different sized battery modules. The illustrations of the serpentine structures 3202 and 3302 are provided for example purposes only. Other structures for cooling batteries, battery modules, or battery cells of a battery pack can be implemented, such as structures with parallel designs, a combination of serpentine and parallel designs, among other possibilities.

In one example, the serpentine structure 3302 can be a component of a first thermal component (e.g., a first cold plate) and the serpentine structure 3202 can be a component of a second thermal component (e.g., a second cold plate). The first thermal component can span (e.g., be coupled with) the battery module 302 and the second thermal component can span one of the battery modules 304, 306, or 308. The first thermal component can be disposed in a first end portion (e.g., the first end portion 2316) of the battery pack 202 and the second thermal component can be disposed between the first thermal component and a second end portion (e.g., the second end portion 2318) of the battery pack 202. A first plurality of cells of the battery module 302 can be between the first thermal component and a cover (e.g., the cover 1602) of the battery pack 202 and a second plurality of cells of the battery module 304, 306, or 308 can be between the second thermal component and the cover of the battery pack 202.

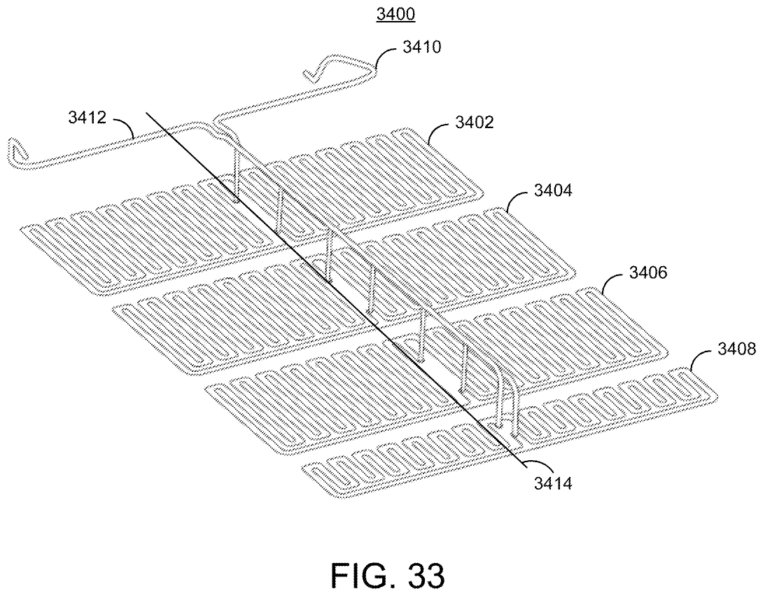

FIG. 33 depicts a perspective view 3400 of serpentine structures 3402, 3404, 3406, and 3408 connected to pipes 3410 and 3412. The serpentine structure 3408 can be a first serpentine structure; the serpentine structure 3402 can be a second serpentine structure; the serpentine structure 3404 can be a third serpentine structure; the serpentine structure 3406 can be a fourth serpentine structure. The serpentine structures 3402, 3404, 3406, and 3408 can be numbered in any way herein. The pipes 3410 and 3412 can each be a cooling pipe. The pipe 3410 can be an inlet pipe that flows or facilitates the flow of liquid from an external source and through the serpentine structures 3402, 3404, 3406, and 3408. The pipe 3412 can be an outlet pipe in which liquid flows out of the serpentine structures 3402, 3404, 3406, and 3408 to the same or a different external source. The serpentine structures 3402, 3404, and 3406 can be sized or configured to cool large battery modules (e.g., the battery modules 304, 306, and 308) and the serpentine structure 3408 can be sized or configured to cool a small battery module (e.g., the battery module 302). The serpentine structures 3402, 3404, and 3406 can be serpentine structures of thermal components (e.g., thermal components such as or similar to the thermal component 2402). When the thermal components that include the serpentine structures 3402, 3404, and 3406 are coupled with the battery modules 302, 304, 306, or 308 within the battery pack 202, and the pipes 3410 and 3412 is coupled with the serpentine structures 3402, 3404, 3406, or 3408, the pipes 3410 and 3412 can extend in a direction from a first end portion (e.g., the first end portion 2316) towards a second end portion (e.g., the second end portion 2318) of the battery pack 202. While illustrated as being positioned in a middle portion of the serpentine structures 3402, 3404, 3406, and 3408, the pipes 3410 and 3412 can be positioned various other areas relative to the serpentine structures 3402, 3404, 3406, and 3408, such as on the edges of the serpentine structures 3402, 3404, 3406, and 3408 (which can also be on the edges of the thermal structures of the serpentine structures 3402, 3404, 3406, and 3408), a combination of such edges and middle portions, among other possibilities.

The serpentine structures 3402, 3404, 3406, and 3408 can be connected with (e.g., to) the pipes 3410 and 3412 to receive liquid from the pipes 3410 and 3412. The serpentine structures 3402, 3404, 3406, and 3408 can be connected with the pipes 3410 and 3412 in a configuration or orientation that matches the configuration or orientation of battery modules (e.g., the battery modules 302, 304, 306, and 308) of the battery pack 202. Each serpentine structure 3402, 3404, and 3406 can be connected to the pipes 3410 and 3412 in two locations. The two locations can be on opposing sides of the serpentine structure 3402, 3404, or 3406. Liquid can flow from the pipes 3410 and 3412 at each location through the serpentine structure 3402, 3404, or 3406 until the liquid received at the respective locations contacts each other. In one example, the pipes 3410 and 3412 can distribute coolant from the serpentine structure 3402, then to the serpentine structure 3404, then to the serpentine structure 3406, and then to the serpentine structure 3408.

The serpentine structures 3402, 3404, 3406, and 3408 can be disposed in a housing (e.g., the housing 2315) of the battery pack 202. The serpentine structures 3402, 3404, 3406, and 3408 can be disposed to have the same orientations or locations as the battery modules 302, 304, 306, and 308. For example, the serpentine structure 3408 can have a first length that extends in a direction from the first end portion of the housing to the second end portion of the housing and a width that extends between the sides of the housing. The serpentine structures 3402, 3404, and 3406 can have a second length that extends in a direction from the first end portion of the housing to the second end portion of the housing and a width that extends between the sides of the housing. The widths of the serpentine structures 3402, 3404, 3406, and 3408 can be the same or substantially the same. However, the second length of each of the serpentine structures 3404, 3406, and 3408 can be larger than the first length of the serpentine structure 3408. The thermal components of which the serpentine structures 3402, 3404, 3406, and 3408 are a part can have similarly proportional widths or lengths between each other. The serpentine structures 3402, 3404, 3406, and 3408 and the thermal components of the serpentine structures 3402, 3404, 3406, and 3408 can be coupled, connected, affixed, or a part of battery module housing of the battery modules 302, 304, 306, and 308. Accordingly, the serpentine structures 3402, 3404, 3406, and 3408 and the thermal components of the serpentine structures 3402, 3404, 3406, and 3408 can be sized to match the lengths, widths, and shapes of the battery module housings of the battery modules 302, 304, 306, and 308 and positioned within the battery pack at the same locations as the battery modules 302, 304, 306, and 308.

When connected with the serpentine structures 3402, 3404, 3406, and 3408, the pipes 3410 and 3412 can extend from the first end portion 2316 of the housing 2315 of the battery pack 202 to the second end portion 2318 of the housing 2315 of the battery pack 202.

The serpentine structures 3402, 3404, 3406, and 3408 or the thermal components of the serpentine structures 3402, 3404, 3406, and 3408 can be arranged within the battery pack 202 along a first axis 3414 (e.g., a lengthwise axis similar to or the same as the first axis 314). The first axis 3414 can extend through a back end (e.g., a wall at the back of the battery pack 202) and a front end (e.g., a wall at the front of the battery pack 202) opposite the back end of the battery pack 202. The first axis 3414 can extend through the rear portion 140 to the front portion 130 through the body portion 135 of the vehicle 105 when the battery pack 202 is installed in the vehicle 105. The serpentine structure 3408 can be disposed or located at the back end of the battery pack 202 and circuitry or the serpentine structure 3402 can be disposed at or towards the front end of the battery pack 202 along the first axis 3414.

A second axis can be perpendicular to the first axis 3414. Each of the serpentine structures 3402, 3404, 3406, and 3408 or the thermal components of the serpentine structures 3402, 3404, 3406, and 3408 can have a first dimension along the first axis 3414 and a second dimension along the second axis. The second dimensions of each of the serpentine structures 3402, 3404, 3406, and 3408 or the thermal components of the serpentine structures 3402, 3404, 3406, and 3408 can be the same. The first dimension of the serpentine structure 3402 or the thermal component of the serpentine structure 3402 can be smaller or different than the first dimensions of the serpentine structures 3402, 3404, and 3406 or the thermal components of the serpentine structures 3402, 3404, and 3406.

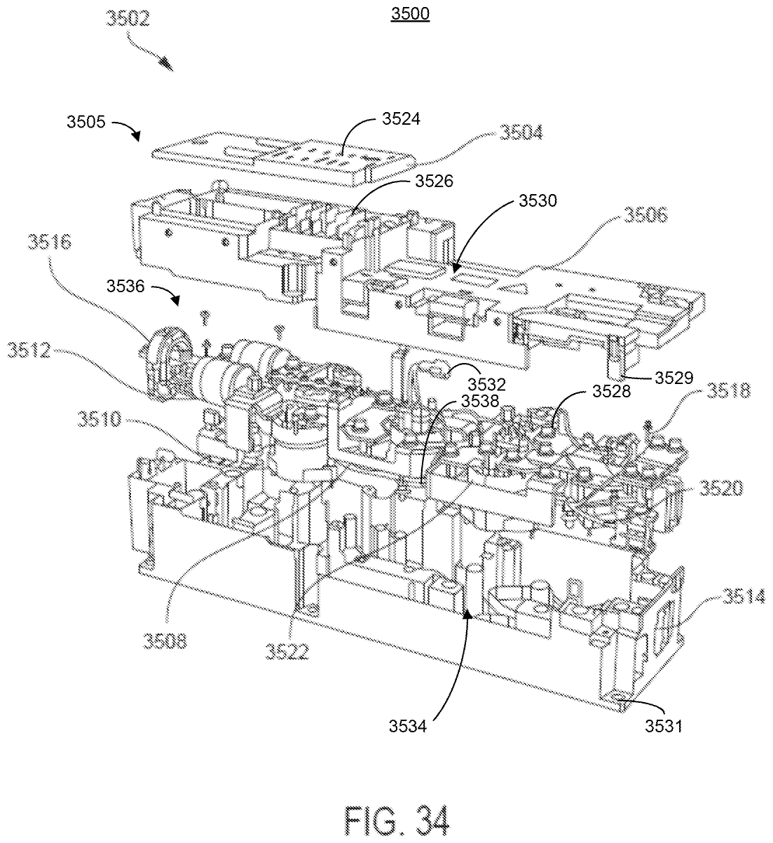

FIG. 34 depicts an exploded view 3500 of a VDB 3502. The VDB 3502 can be located in the battery pack 202. The VDB 3502 can be the same as or similar to the VDB 2310. The VDB 3502 can be configured to electrically connect (e.g., electrically couple) loads that operate at high voltages to the battery modules 302, 304, 306, or 308 of the battery pack 202. For example, the VDB 3502 can be configured to connect loads that operate at high voltages to a busbar (e.g., the busbar 502) of the battery pack 202. The VDB 3502 can be positioned at the front end portion (e.g., in the circuitry bay 1612) of the battery pack 202. The VDB 3502 can be positioned at the front of the battery pack 202 because the connectors or ports of the battery pack 202 are at the front of the battery pack 202. This location can shorten the length of the busbar and reduce the resistance of the circuit of the battery pack 202. A BMS of the battery pack 202 or the vehicle in which the battery pack is located can control the VDB 3502. The battery pack 202 can contain cooling components, such as fans, heatsinks, coolant manifolds, fuses, or thermal runaway detection units to cool the components (e.g., the ports or interfaces) of the VDB 3502 or other components of the battery pack 202.

The VDB 3502 can include a first lid 3504, a second lid 3506, and a bottom lid 3514. Together, the first lid 3504, the second lid 3506, and the bottom lid 3514 can be or include a VDB housing 3505. The first lid 3504 can connect or couple with the second lid 3506. For example, the first lid 3504 can contain slits 3524 and the second lid 3506 can contain extensions 3526. The slits 3524 can be holes in the first lid 3504. The extensions 3526 can be configured (e.g., shaped or sized) to slide into the slits 3524 when the first lid 3524 is placed on top of the second lid 3506. When the first lid 3504 is placed on top of the second lid 3506, the extensions 3526 can hold the first lid 3524 in place on top of the second lid 3506. The slits 3524 and the extensions 3526 can have any shape or form.

The first lid 3504 and the second lid 3506 can connect with the bottom lid 3514. For example, the first lid 3504 and the second lid 3506 can include connection extensions 3529. The bottom lid 3514 can include crevices 3531. The crevices 3531 can be configured to receive the extensions 3529 and snap or otherwise fasten the first lid 3504 and the second lid 3506 into place against the bottom lid 3514.

The VDB 3502 can include circuitry 3536, which can be or include one or more busbars 3508, a contactor 3510, a fuse 3512, a positive terminal 3516, a negative terminal 3518, a harness 3520, an FDU interface 3522, and a DCFC port 3538. The circuitry 3536 can include any components or ports of the ports 1504 1520. The circuitry 3536 can be held in place by bolts 3528 that bolt the different components of the circuitry 3536 together. The first lid 3504, the second lid 3506, and the bottom lid 3514 can cover and protect the circuitry 3536 (e.g., the one or more busbars 3508, the contactor 3510, the fuse 3512, the positive terminal 3516, the negative terminal 3518, the harness 3520, the FDU interface 3522, and the DCFC port 3538) of the VDB 3502 in combination with the bottom lid 3514. To do so, the first lid 3504 and the second lid 3506 can connect with the bottom lid 3514 to form a shell around the circuitry 3536 of the VDB 3502. The first lid and the second lid 3506 can include crevices and extensions 3530 to shape around the circuitry 3536. The bottom lid 3514 can include crevices or extensions 3534 to shape around the circuitry 3536.

The one or more busbars 3508 can connect high voltage external loads to the busbar of the battery pack 202. The contactor 3510 can operate as a port to connect an external load with the one or more busbars 3508. The fuse 3512 can operate to disconnect the VDB 3502 from the busbar of the battery pack 202 to avoid short circuits or thermal runaways. The fuse 3512 can be a fuse assembly. The fuse 3512 can be adjacent or next to a service window (e.g., the service window 2302) of the cover (e.g., the cover 1602) of the battery pack 202. For example, the fuse 3512 can be within 10 centimeters, 20 centimeters, 50 centimeters, or a meter of the service window. The fuse can be exposed (e.g., visible) through the service window, such as when the service window is open. The positive and negative terminals 3516 and 3518 can operate to power the VDB 3502. For example, the terminals 3516 and 3518 can connect to the busbar or busbars of the battery pack 202 that carry high voltage current. The harness 3520 can connect the low voltage components of the VDB 3502 to the terminals 3516 and 3518 or low voltage loads. For example, the harness 3520 can connect to the harness of the battery pack that carries low voltage current at a connector 3532. The FDU interface 3522 can be a connection port connecting the FDU of an electric vehicle in which the VDB 3502 is located with the one or more busbars 3508. The FDU interface 3522 can be exposed through a front surface (e.g., the surface 1502) of the battery pack 202.

The BMS of the battery pack 202 can monitor the VDB 3502. For example, the BMS or the VDB 3502 (e.g., a processor of the VDB 3502, such as in a BVT monitor (e.g., the 402) can monitor the contactor 3510 during operation (e.g., when the battery pack 202 is powering an electric vehicle). The BMS or the VDB 3502 can monitor the ambient temperature inside the battery disconnect unit (BDU) or the temperature of the contactor. The BMS or the VDB 3502 can do so by retrieving or polling temperature or voltage sensors measuring the temperature or voltage at the contactor 3510 or the BDU. The BMS or the VDB 3502 can detect anomalies or faults in the contactor 3510 or the BDU based on the measurements (e.g., the monitored temperature). The anomalies or faults can be or be indicative of contactor faults or electrical connection faults. Responsive to detecting anomalies or faults, the BMS can adjust the configuration of the contactor 3510 or BDU or generate an alert at a user interface that an operator can view to determine how to address the anomaly or fault.

The VDB 3502 can be disposed in an end portion (e.g., the first end portion 2316 or the second end portion 2318) of the battery pack 202. In one example, the battery module 302 can be disposed in the first end portion 2316 and the VDB 3502 can be disposed in the second end portion 2318. One or more of the battery modules 304, 306, or 308 can be disposed between the battery module 302 and the VDB 3502. Each of the battery modules 302, 304, 306, 308 can be disposed in different bays (e.g., bays 3616, 3618, 3620, and 3622) of the battery pack 202.

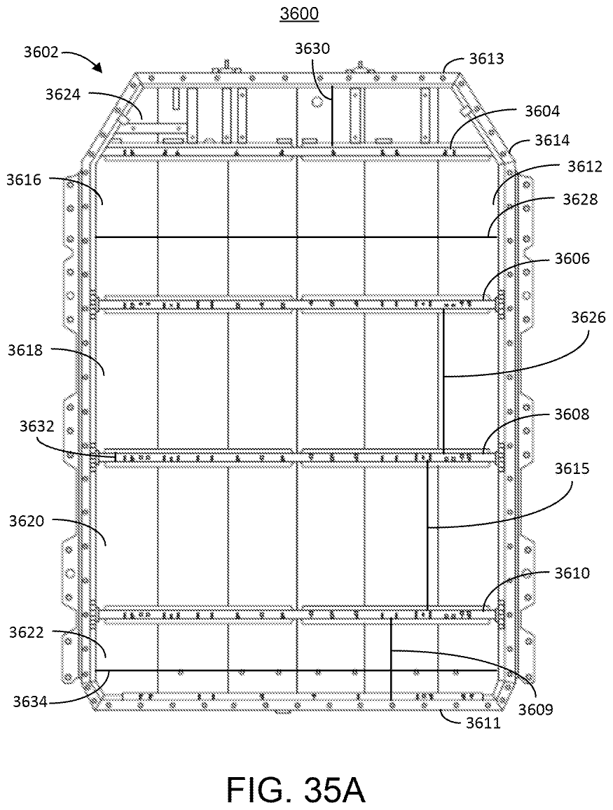

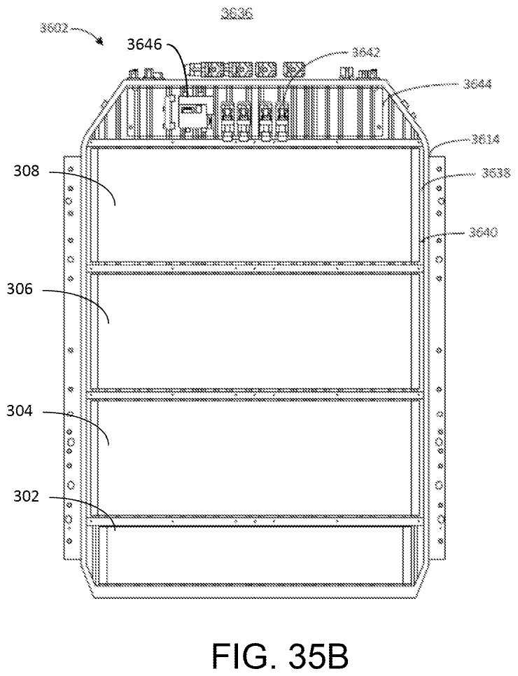

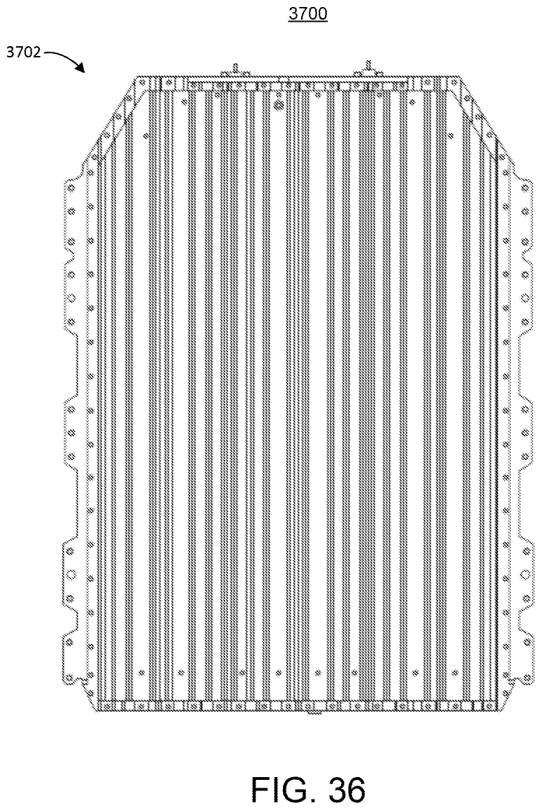

FIGS. 35A and 35B depict top views 3600 and 3636 of a base 3602 of a battery pack housing (e.g., the housing 2315). FIG. 36 depicts a bottom view 3700 of the base 3602. The base 3602 can be the same as or similar to the base 2314. The base 3602 can include members 3604, 3606, 3608, and 3610. The members 3604, 3606, 3608, and 3610 can be lateral cross members. The members 3604, 3606, 3608, and 3610 can have a width 3632 of 30 mm. The member 3604 can be a first member, the member 3606 can be a second member, the member 3608 can be a third member, and the member 3610 can be a fourth member. The members 3604, 3606, 3608, and 3610 can be referenced with any number. The members 3604, 3606, 3608, and 3610 can extend across the base 3602 (e.g., across the width of the base 3602) from a first end or edge of the base 3602 to a second end or edge of the base 3602. The members 3604, 3606, 3608, and 3610 can be spaced apart from each other to form the bays 3616, 3618, 3620, and 3622 in which battery modules (e.g., the battery modules 302, 304, 306, and 308) can be stored (e.g., placed between the members 3604, 3606, 3608, and 3610).

The bays 3616, 3618, 3620, and 3622 can house the battery modules 302, 304, 306, and 308 or pluralities of cells. For example, the bay 3622 can be a first bay (e.g., a first enclosure) to house (e.g., contain or store) the battery module 302 or a first plurality of battery cells, the bay 3616 can be a second bay (e.g., a second enclosure larger than the enclosure of the battery module 302) to house the battery module 304 or a second plurality of battery cells, the bay 3620 can be a fourth bay to house the battery module 306 or a third plurality of battery cells, and the bay 3622 can be a fifth bay or a fourth bay to house the battery module 308 or a fourth plurality of battery cells. The bays 3616, 3618, and 3620 can be substantially similar in size (e.g., have a substantially similar area or volume).

A distance 3609 between a wall 3611 (e.g., a first or second wall) at an end portion of the base 3602 and the member 3610 (e.g., a first member, such as the closest member 3610 to the wall 3611) can be smaller than a distance 3615 between the member 3610 and the member 3608 (e.g., a second member), such as to account for the different lengths of the battery modules 302 and 304 when disposed in the base 3602. A wall 3613 (e.g., a first wall or a second wall) can be at an end of the base 3602 opposite the wall 3611 to form a bay 3624 (e.g., a circuitry bay, such as the circuitry bay 1612) between the wall 3613 and the member 3604. The wall 3613 can be adjacent to the member 3604 (e.g., no members may be between the member 3604 and the wall 3613). The wall 3613 can be spaced apart from the member 3604 to form the bay 3624 in which circuitry (e.g., the BVT monitor 402 or the VDB 3502) can be stored, housed, or placed. The bay 3624 can be a third bay.

A VDB 3644 (e.g., the VDB 3502) and a BVT monitor 3646 can be in the bay 3624. The VDB 3644 can house the circuitry of the battery pack 202. Energy or current (e.g., energy or current from the harness 504) from battery modules can flow into the VDB 3644 through connection ports 3642. The connection ports 3642 can be an RDU interface (e.g., the RDU 2602) configured to power the RDU of a vehicle. The BVT monitor 3646 can be the same as or similar to the BVT monitor 402.

The members 3604, 3606, 3608, and 3610 can extend from a floor 3612 of the base 3602. The members 3604, 3606, 3608, and 3610 can have a height equal or substantially equal to side walls 3614 of the base 3602. The members 3604, 3606, 3608, and 3610 can have a height lower than the side walls 3614 of the base 3602. The members 3604, 3606, 3608, and 3610 can provide strength or mechanical protection for battery modules stored within the battery pack housing. The base 3602 and the members 3604, 3606, 3608, and 3610 can be or include an aluminum (or another metal) material.

The floor 3612 can include two plates (e.g., a plate 3702, which can be similar to or the same as the plate 2002, and a strike shield) on top of each other. Each plate can be or include an aluminum material. Additional reinforcing material can be between the two plates, such as additional plates or another material, such as plastic. This configuration of the floor 3612 can provide added protection for the battery modules 302, 304, 306, and 308.

The dimension of the bays 3616, 3618, 3620, and 3622 can be facilitate storage of the battery modules 302, 304, 306, and 308. For example, the bay 3618 can have a length 3626. The length 3626 can be 426 mm. The distance 3615 between the members 3608 and 3610 can be 416 mm. The bays 3616, 3618, and 3620 can have a width 3628 of 1126.6 mm. The bay 3622 can have a width 3634 of 1033.6 mm. The bay 3624 can have a length 3630 of 168 mm. Each of these dimension facilitate storage of the battery modules 302, 304, 306, and 308.

When stored in the bays 3616, 3618, 3620, and 3622, there can be a gap 3638 between the battery modules 302, 304, 306, and 308 and the side walls 3614 and the battery modules 302, 304, 306, and 308. The gap 3638 can have a width 3640 of 15 mm. The gap 3638 can also be between the members 3604, 3606, 3608, and 3610 and the side walls 3614. The gap can provide protection for the battery modules 302, 304, 306, and 308 during transport.

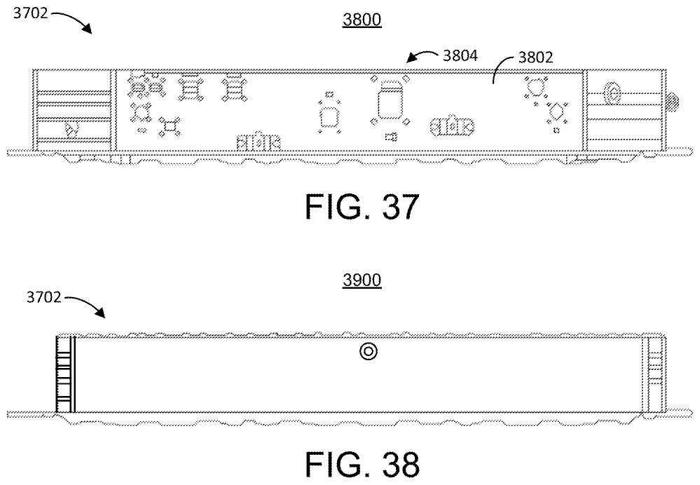

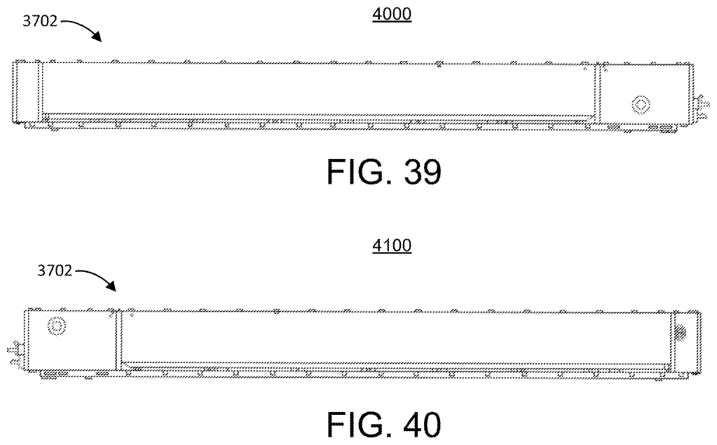

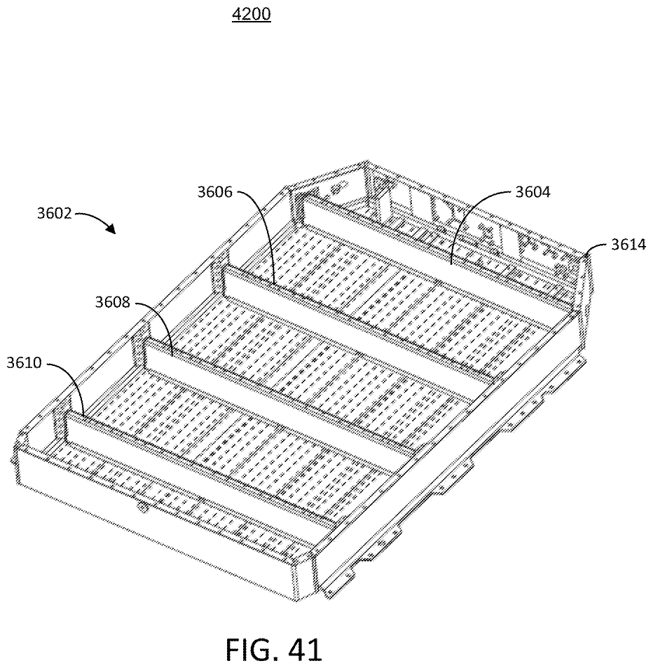

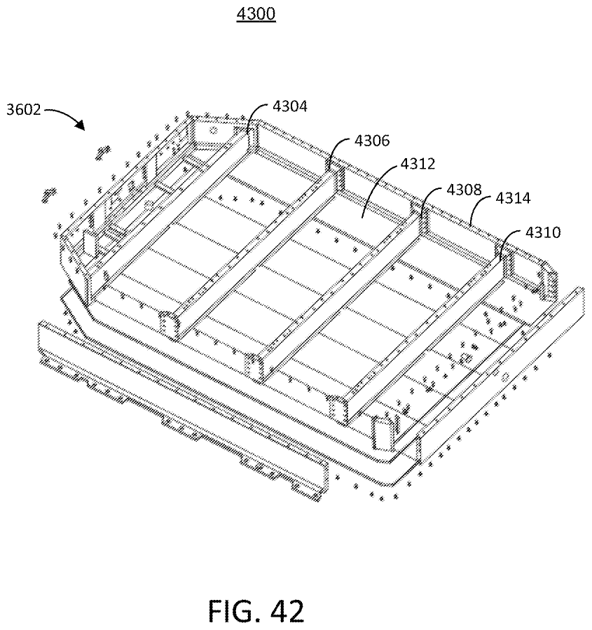

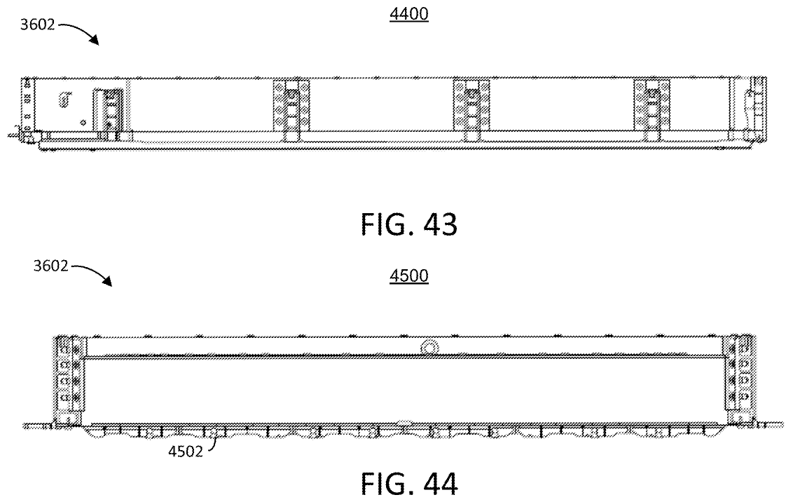

FIG. 37 depicts a front view 3800 of the base 3602. FIG. 38 depicts a back view 3900 of the base 3602. FIG. 39 depicts a side view 4000 of the base 3602. FIG. 40 depicts a side view 4100 of the base 3602. FIG. 41 depicts a perspective view 4200 of the base 3602. FIG. 42 depicts an exploded view 4300 of the base 3602. FIG. 43 depicts a cross-sectional view 4400 of the base 3602. FIG. 44 depicts a cross-sectional view 4500 of the base 3602.

As depicted in the front view 3800, the base 3602 can include a surface 3802. The surface 3082 can be a front surface. The surface 3802 can include holes or openings 3804 for different ports of the circuitry stored in the base 3602. The holes or openings 3804 can be sized such that cables can connect to the ports located behind or between the holes or openings 3804.

As depicted in the cross-sectional view 4500, a base plate 4502 can be coupled to the floor 3612 (e.g., coupled to or be a part of the plate 3702 of the floor 3612) of the base 3602. The base plate 4502 can fasten to the bottom of the floor 3612 with a fastener (e.g., a screw, bolt, or weld). The base plate 4502 can be separated into bays and have chamfered edges at the bottom of the base plate 4502 to provide protection for battery modules positioned on the floor 3612.

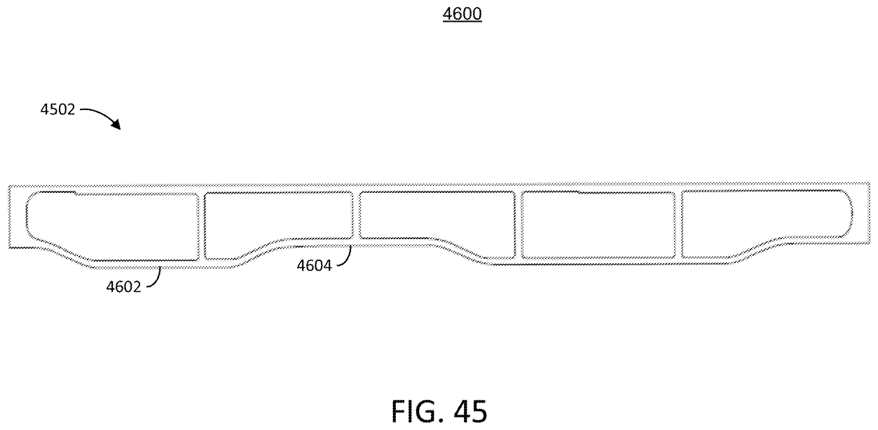

A front view 4600 of the base plate 4502 is depicted in FIG. 45. As illustrated in FIG. 45, the base plate 4502 can include convex portions 4602 and concave portions 4604. The convex portions 4602 and concave portions 4604 can provide structural stability to the base 3602.

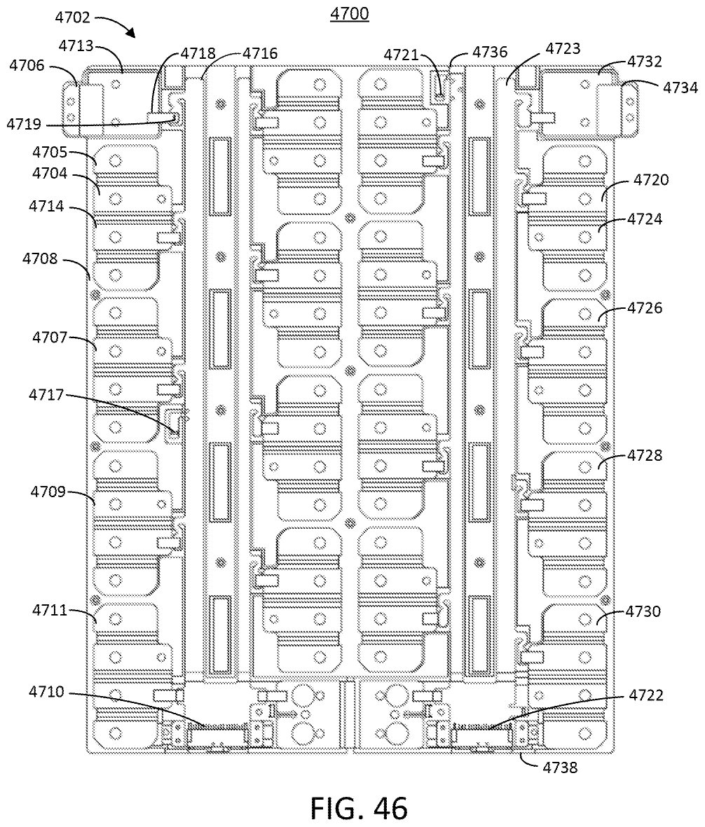

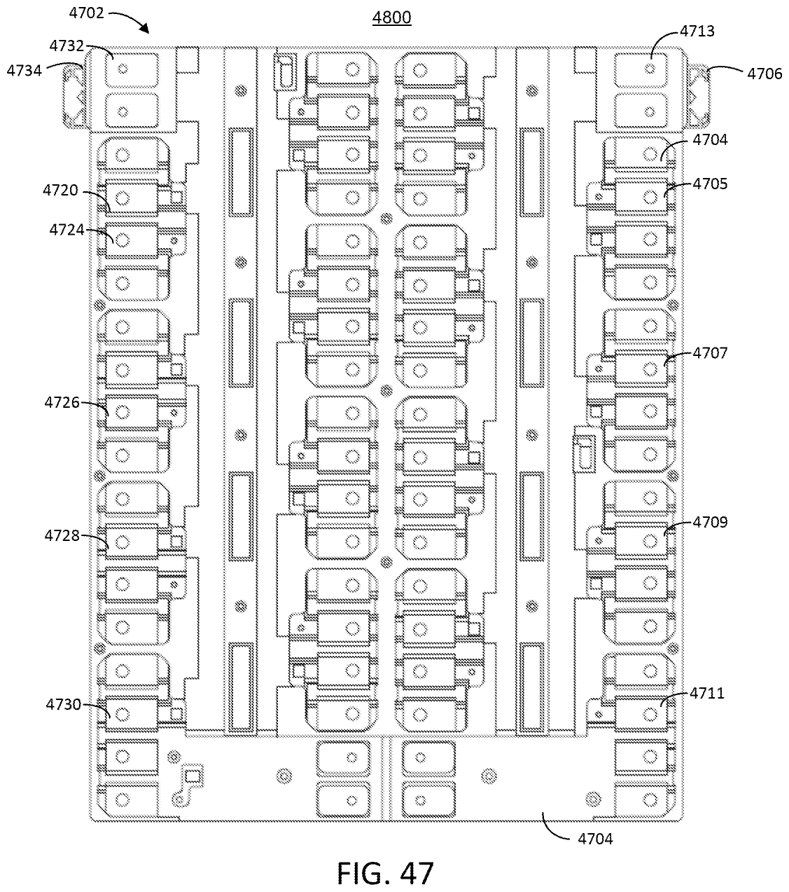

FIGS. 46 and 47 depict a top view 4700 and a bottom view 4800 of a current collector assembly 4702. The current collector assembly 4702 can be the same as or similar to the current collector assemblies 1306 or 1406. The current collector assembly 4702 can include a busbar 4704, a pedestal 4706, a tray 4708, a circuit 4710 (e.g., a first circuit), and thermistors 4717, 4721, and 4723. The current collector assembly 4702 (e.g., the tray 4708) can be sized to fit over terminals of battery cells of a battery module. For example, the current collector assembly 4702 can have the same or substantially the same size and shape as one or more of the battery modules 302, 304, 306, or 308. The tray 4708 can be configured to hold or support the busbar 4704, the pedestal 4706, the circuit 4710 and the thermistors 4717, 4721, and 4723. The tray 4708 can be or include a non-conductive material (e.g., rubber). The pedestal 4706 can be placeholder for components of the current collector assembly. The pedestal 4706 can couple (e.g., fasten, such as with screws or nails) the busbar 4704 with the tray 4708. While affixed to the tray 4708, the busbar 4704 can be coupled with or affixed to terminals on top of the battery cells within one of the battery modules 302, 304, 306, or 308. The pedestal 4706 can couple, to the tray 4708, a portion 4713 of the busbar 4704 that is configured as an out-pole busbar (e.g., a terminal for the battery module to which the current collector assembly 4702 is coupled).

The circuit 4710 can be a flexibly printed circuit (FPC). The circuit 4710 can be electrically coupled with the busbar 4704 such that the busbar 4704 provides power to the circuit 4710. The circuit 4710 can be electrically coupled with the busbar 4704 via a pedestal (e.g., an electrically conductive pedestal) underneath the circuit 4710 that contacts the busbar 4704 and the circuit 4710. The circuit 4710 can include power circuitry (e.g., amplifiers or transistors) or processing circuitry (e.g., memory or a processor) for controlling the voltage or current of the battery module to which the current collector assembly 4702 is coupled.

The busbar 4704 can connect the terminals of battery cells with the circuit 4710. The busbar 4704 can be welded (e.g., micro-welded) to terminals of battery cells. For example, the current collector assembly 4702 can be placed on top of battery cells of a battery module (e.g., the battery module 302, 304, 306, or 308). A welding device (e.g., a laser) can weld current collector elements (e.g., welding areas) of the busbar 4704 to different terminals of the battery cells. The welding device can weld the current collector elements of the busbar 4704 through one or more gaps 4714 (e.g., cavities or holes) in the tray 4708. The current collector elements of the busbar 4704 configured to be welded to the terminals of the battery cells can include a different material than other portions of the busbar 4704. For example, the current collector elements of the busbar 4704 to be welded can be or include copper, aluminum, or another conductive material. The current collector elements can have a lower melting point than the surrounding portions of the busbar 4704 to avoid disconfiguring or overheating the busbar 4704 during the welding process.

The busbar 4704 can include multiple portions 4705, 4707, 4709, 4711, and 4713 (e.g., a first busbar, a second busbar, a third busbar, a fourth busbar, and a fifth busbar). The multiple portions 4705, 4707, 4709, 4711, and 4713 of the busbar 4704 can be coupled with each other through an interconnection structure 4716. The interconnection structure 4716 can support the circuit 4710 (e.g., the circuit 4710 can contact or be affixed to a top surface of the interconnection structure 4716). The interconnection structure 4716 can be or include a conductive material (e.g., aluminum) to electrically couple the portions 4705, 4707, 4709, 4711, and 4713 of the busbar 4704 between each other and the circuit 4710. The interconnection structure 4716 can additionally couple the portions of the busbar 4704 and the circuit 4710 with portions of another busbar of the current collector assembly 4702 that is similarly fastened to the tray 4708 (e.g., fastened to the tray 4708 on an opposite side of the same surface of the tray 4708).

The interconnection structure 4716 can couple with the multiple portions 4705, 4707, 4709, 4711, and 4713 of the busbar 4704. At each portion 4705, 4707, 4709, 4711, and 4713, an adhesive 4718 or another electrically conductive material can be attached or otherwise adhere to the interconnection structure 4716 or a portion of the busbar 4704. In some cases, portions of the interconnection structure 4716 can extend and contact each of the portions 4705, 4707, 4709, 4711, and 4713 of the busbar 4704. The adhesive 4718 can adhere to a bottom surface or a top surface of the interconnection structure 4716. The adhesive 4718 can be tape. The tape can be double-sided tape. The tape can be a conductive adhesive (e.g., a thermally or electrically conductive adhesive) configured to transport electricity from the portion 4705, 4707, 4709, 4711, or 4713 of the busbar 4704 to which the adhesive 4718 adheres to the interconnection structure 4716. The interconnection structure 4716 can couple with portions of a busbar on each side of the interconnection structure 4716 in this manner.

The thermistors 4717, 4721, and 4723 can each be coupled with a top of a battery cell underneath the current collector assembly 4702. For example, the thermistor 4717 can be coupled with the top of the battery cell with an adhesive, such as an adhesive similar to the adhesive 4718. A BVT monitor (e.g., the BVT monitor 402) can measure the temperature of the battery cell to which the thermistor 4717 is coupled or the battery cells directly next to the battery cell to which the thermistor 4717 is coupled by measuring the temperature (e.g., measuring the resistance) of the thermistor 4717. Thermistors can be similarly located or coupled or measure the temperature for any number of battery cells of a battery module underneath the current collector assembly 4702.

The current collector assembly 4702 can include an interconnection structure 4719, a busbar 4720, a circuit 4722 (e.g., a second circuit), and a pedestal 4734. The busbar 4720 can include multiple portions 4724, 4726, 4728, 4730, and 4732. The busbar 4720, the portions 4724, 4726, 4728, 4730, and 4732, and the pedestal 4734 can be coupled with the interconnection structure 4719 and to each other similar to how the busbar 4704, the portions 4705, 4507, 4509, 4511, and 4713, and the pedestal 4706 are coupled with the interconnection structure 4716, but on an opposite side of the same surface of the current collector assembly 4702. The portions 4724, 4726, 4728, 4730, and 4732 can be busbars (e.g., a first busbar, a second busbar, a third busbar, a fourth busbar, and a fifth busbar) of the busbar 4720. The portions 4705, 4507, 4509, 4511, and 4713 can be busbars (e.g., a first busbar, a second busbar, a third busbar, a fourth busbar, and a fifth busbar) of the busbar 4704. Each of the portions 4724, 4726, 4728, 4730, and 4732 and the portions 4705, 4507, 4509, 4511, and 4713 can extend in a direction parallel to a direction from an end 4736 (e.g., a first end or edge) of the tray 4708 to an end 4738 (e.g., a second end or edge) of the tray 4708. The interconnection structure 4719 can couple with portions of a bus bar on each side of the interconnection structure 4719 in this manner. Each of the circuits 4710 and 4722 can be coupled at or adjacent to (e.g., within five centimeters, 10 centimeters, 15 centimeters, or 50 centimeters) the end 4738. The circuit 4710 can be powered via the busbar 4704 and the circuit 4722 can be powered via the busbar 4720.

The current collector assembly 4702 can be coupled with terminals on the top of battery cells of the battery module 302, 304, 306, or 308. The battery module 302, 304, 306, or 308 can be placed in the battery pack 202. When the battery module 302, 304, 306, or 308 is placed in the battery pack 202, the thermal insulation 2304 (e.g., thermal insulation material) can be placed over the battery cells (e.g., over the cover 1314 or 1414) of the battery module 302, 304, 306, or 308 as thermal protection for the battery cells. The cover 1602 can be placed over the thermal insulation 2304.

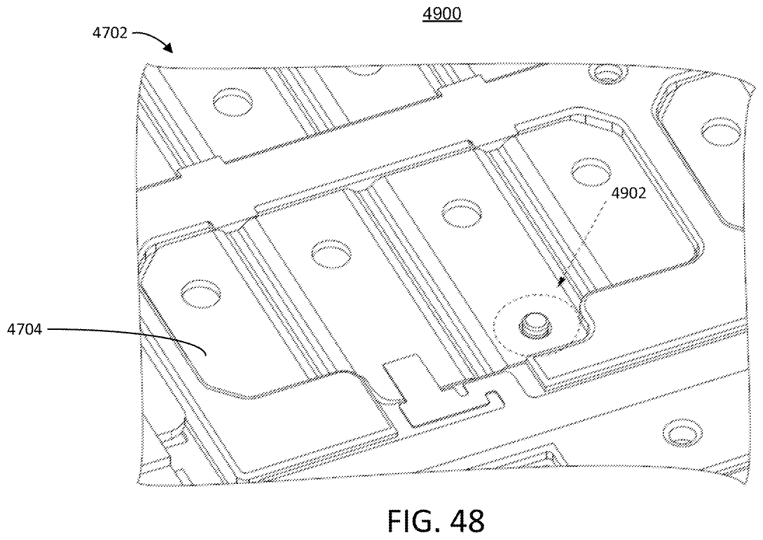

FIG. 48 depicts a partial perspective view 4900 of the current collector assembly 4702. As illustrated in the partial perspective view 4900, the current collector assembly 4702 can include a buckle 4902. The buckle 4902 can be a portion of or be coupled with the tray 4708. The buckle 4902 can extend from or abut the tray 4708. The buckle 4902 can be configured to fit or extend through a hole (e.g., a circular hole) in the busbar 4704. Accordingly, the buckle 4902 can be used to minimize shifting in the busbar 4704 with respect to the components of the current collector assembly 4702.

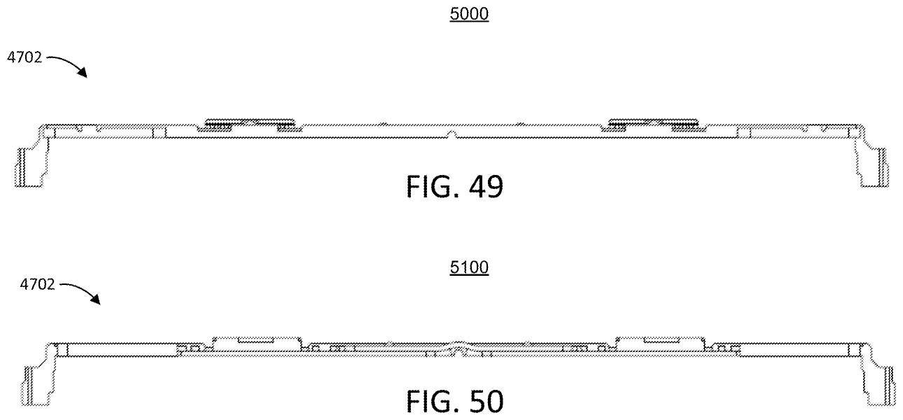

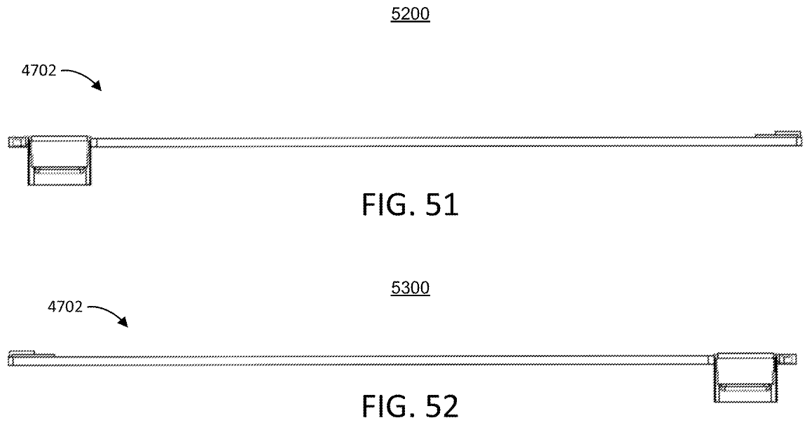

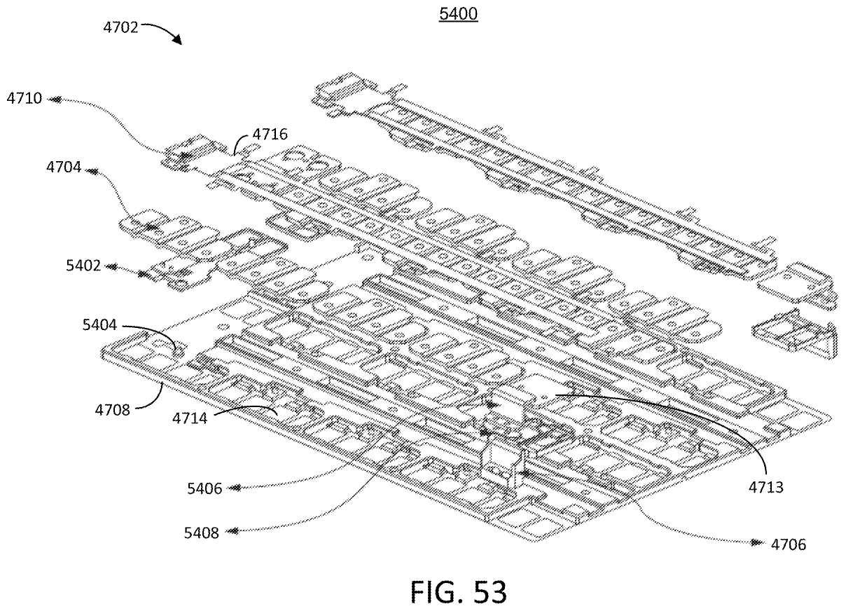

FIGS. 49-50 depict a front view 5000 and a back view 5100 of the current collector assembly 4702. FIGS. 51-52 depict a side view 5200 and a side view 5300 of the current collector assembly 4702.

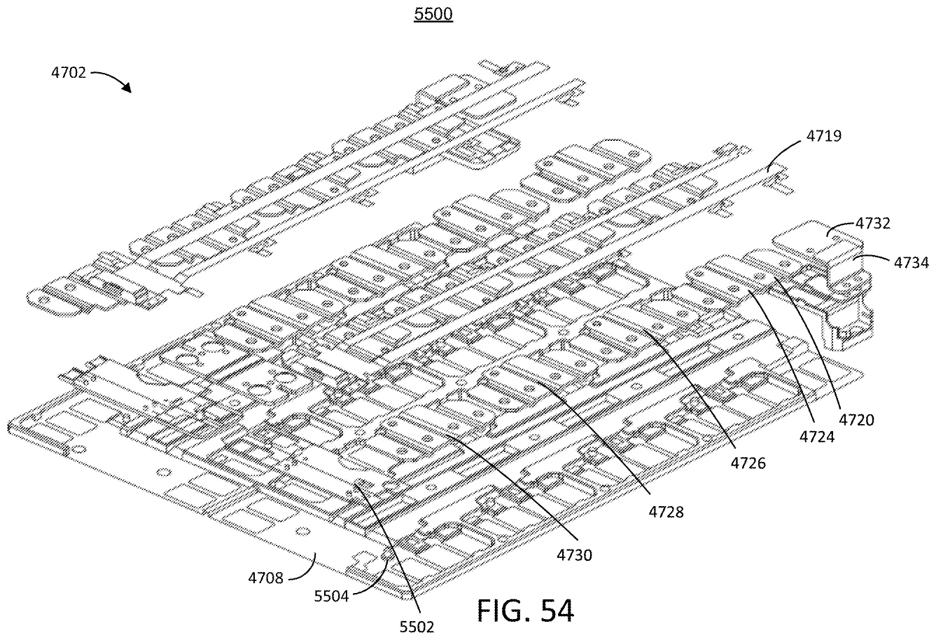

FIGS. 53 and 54 depict an exploded view 5400 and an exploded view 5500 of the current collector assembly 4702. As illustrated in the exploded view 5400, the current collector assembly 4702 can include the busbar 4704, the tray 4708, the pedestal 4706, the circuit 4710, a pedestal 5402, a buckle 5404, the portion 4713 of the busbar 4704, busbar fixation nuts 5408, and the interconnection structure 4716. The pedestal 5402 can be a first pedestal and couple the circuit 4710 to or with the busbar 4704. The pedestal 5402 can be or include a conductive material (e.g., a metal, such as aluminum). The pedestal 5402 can be a placeholder for components of the current collector assembly 4702. The pedestal 5402 can be fastened to the tray 4708 via the buckle 5404. For example, the buckle 5404 can lock the pedestal 5402 against the tray 4708 by sliding through a hole in the pedestal 5402. The buckle 5404 can have a portion that extends away from a center of the buckle 5404 (e.g., in a mushroom shape or configuration) and that rests against a top surface of the pedestal 5402. The buckle 4902 can similarly fasten the busbar 4704 (e.g., a portion of the busbar 4704) to the tray 4708. The buckle 5404 can fasten the busbar 4704 to the tray 4708 in a similar manner (e.g., the buckle 5404 can extend through both the pedestal 5402 and a portion of the busbar 4704). The buckle 5404 can fasten the pedestal 5402 and the busbar 4704 to the tray 4708 such that the busbar 4704 is on top of or contacting the pedestal 5402. The pedestal 5402 can contact the circuit 4710 through the interconnection structure 4716. Accordingly, the pedestal 5402, the circuit 4710, and the busbar 4704 can be electrically coupled with each other through the contact between the pedestal 5402 and the interconnection structure 4716, the contact between the interconnection structure 4716 and the circuit 4710, and the contact between the busbar 4704 and the pedestal 5402.

The exploded view 5500 illustrates the current collector assembly 4702 from a different angle. As illustrated in the exploded view 5500, the current collector assembly 4702 can include the interconnection structure 4719, the busbar 4720, the portions 4724-4730 of the busbar 4720, the portion 4732 of the busbar 4720, and the pedestal 4734. The current collector assembly 4702 can include a pedestal 5502 that is configured to be supported by the tray 4708 and coupled with the interconnection structure 4719 through a buckle 5504. The buckle 5504 can be an extension of the tray 4708 similar to the buckle 5404.

The pedestal 4706 can be coupled to the tray 4708 at an opposite end (e.g., at the portion 4713 of the busbar 4704, which can be a first end portion (e.g., a back end portion) of the busbar 4704) of the tray 4708 from the pedestal 5402. The pedestal 4706 can be or include a second pedestal. The pedestal 4706 can be coupled at the portion 4711 of the busbar 4704, which can be a second end portion of the busbar 4704. The pedestal 4706 can be an out-pole pedestal. The pedestal 4706 can be fastened to the portion 4713 of the busbar 4704 by the busbar fixation nuts 5408. The pedestal 4706 can be fastened to the portion 4713 of the busbar 4704 by any fastener. The busbar fixation nuts 5408 can be nuts or bolts that can slide between holes in the pedestal 4706 and the portion 4713 of the busbar 4704 to fasten the pedestal and the portion 4713 of the busbar 4704 together. The portion 4713 can be a portion of the busbar that is configured to couple to an external load (e.g., the portion 4713 can couple to or be a port or terminal of the current collector assembly 4702 to which an external load can be connected). The pedestal 4706 can be finger-safe with a cap (e.g., a rubber cap) covering the pedestal 4706. The pedestal 4706 can hold the busbar fixation nuts 5408 and the portion 4713 of the busbar 4704 in place.

The busbar 4704 can include multiple portions. One example of such a portion is the portion 4713 of the busbar 4704. Each portion can be placed within a different gap 5410 of the current collector assembly 4702. Each gap 5410 can include one or more openings at a bottom surface of the current collector assembly 4702. The different portions of the busbar 4704 can rest in the gaps 5410 and overlay battery cell terminals when the current collector assembly 4702 is placed over battery cells of a battery module. The different portions of the busbar 4704 can be coupled (e.g., welded) to the terminals of the battery cells through the openings in the gaps 5410.

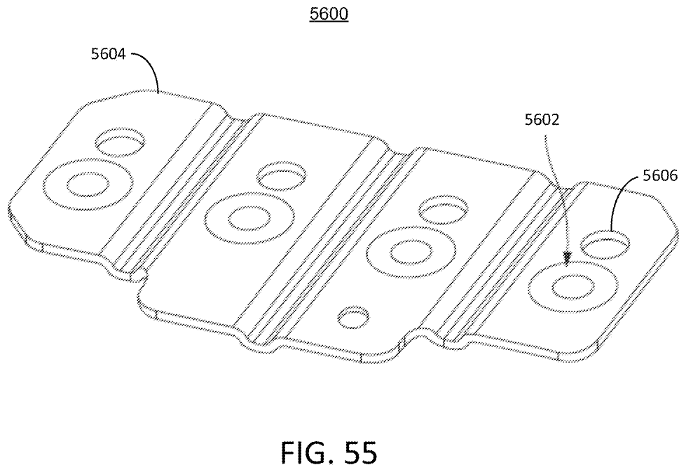

FIG. 55 depicts a current collector element 5602 of a portion 5604 of a busbar. The portion 5604 of the busbar can be a portion of the busbar 4704. The current collector element 5602 can be a welding area of the portion 5604 of the busbar that can be welded to a terminal of a battery cell. The current collector element 5602 can be or include a material, such as copper or aluminum, with a low melting point relative to the portions of the portion 5604 of the busbar outside of the current collector element 5602. The current collector element 5602 can be a designated area (e.g., marked area) of the busbar. The current collector element 5602 can be adjacent or next to a hole 5606. For example, the current collector element 5602 can be within 10 centimeters, 20 centimeters, 50 centimeters, or a meter of the hole 5606. The hole 5606 can be configured to receive a buckle of a tray (e.g., the tray 4708) to lock the portion 5604 of the busbar in place on the tray 4708.

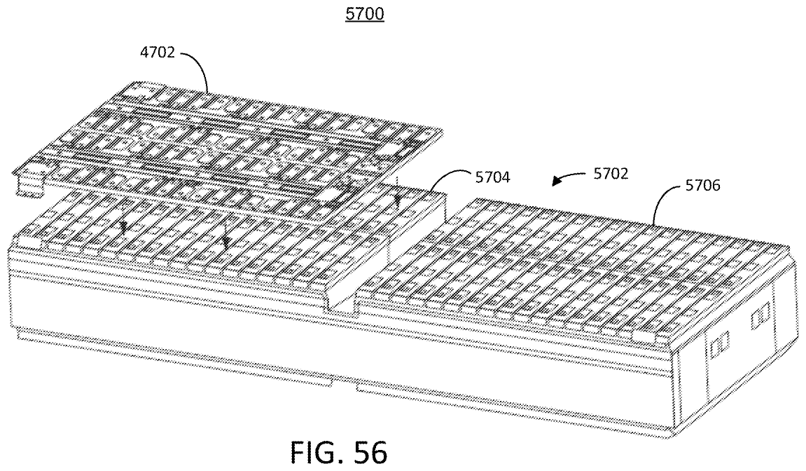

FIG. 56 depicts an operation 5700 of placing the current collector assembly 4702 on a battery module 5702. The battery module 5702 can be the same as or similar to the battery module 302, 304, 306, or 308. As illustrated, the battery module 5702 can include a first set of battery cells 5704 and a second set of battery cells 5706. The first and second sets (e.g., pluralities) of battery cells 5704 and 5706 can each include one or more prismatic battery cells similar to the battery cell 2202. The current collector assembly 4702 can be placed on the first set of battery cells 5704. The current collector assembly 4702 can be placed over the first set of battery cells 5704, thus connecting the first set of battery cells with each other in series or in parallel, depending on the configuration of the current collector assembly 4702. A current collector assembly similar to or the same as the current collector assembly 4702 can be similarly placed over the second set of battery cells 5706.

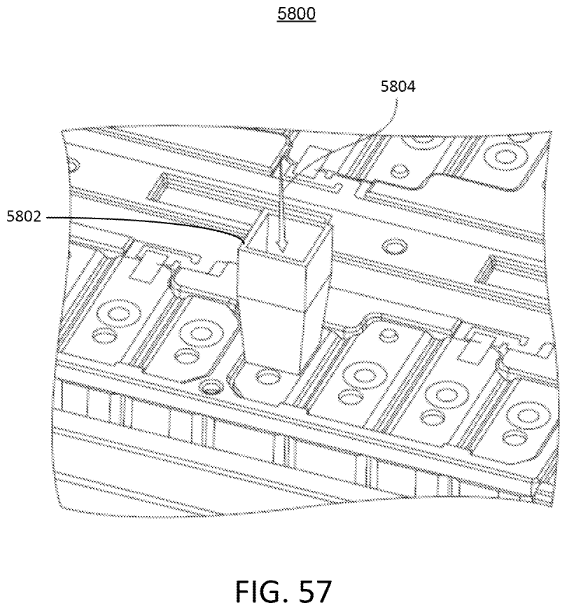

FIG. 57 depicts an operation 5800 of welding the current collector assembly 4702 onto the battery module 5702. In the operation 5800, a welding device 5802 can overlay a welding area on a busbar. The welding device 5802 can direct or point a laser in a downward direction 5804 towards the welding area. The welding device 5802 can activate (e.g., change from an “off” state to an “on” state) and weld the welding area onto a terminal of a battery cell. The welding device 5802 can then move or rotate to a different welding area of the busbar and similarly weld the welding area onto a terminal of a different battery cell. The welding device 5802 can repeat this process for each welding area of the current collector assembly 4702 until welding each welding area of the current collector assembly 4702 onto battery cells of the battery module 5702. The welding device 5802 can perform the operation 5800 after the current collector assembly 4702 overlays a set of battery cells (e.g., the first set of battery cells 5704 or the second set of battery cells 5706) or after an indenter of the welding device 5802 presses down on the busbar to force the busbar against the battery cell terminals.

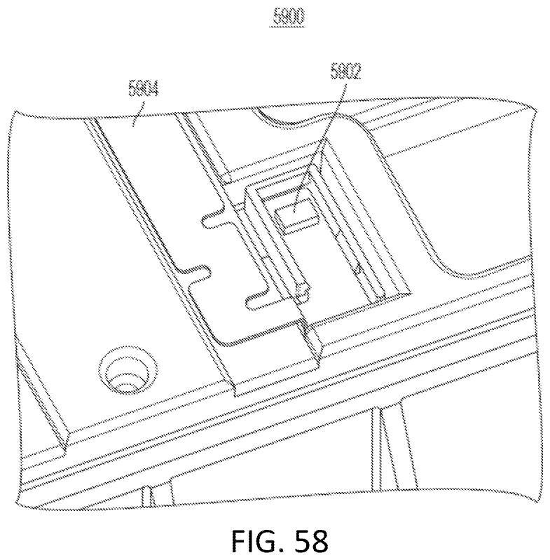

FIG. 58 depicts a perspective view 5900 of a thermistor 5902 coupled with an interconnection structure 5904, in accordance with implementations. The interconnection structure 5904 can be the same as or similar to the interconnection structure 4716. The thermistor 5902 can be or include platinum, nickel, cobalt, iron, or oxides of silicon. The thermistor 5902 can be or include a negative temperature coefficient thermistor. The thermistor 5902 can operate as a current-limiting resistor. The thermistor 5902 can limit the current traveling across the interconnection structure 4716 according to the temperature of the interconnection structure 4716 or battery cells providing power through the interconnection structure 4716. The thermistor 5902 can be welded onto the interconnection structure 4716 or attached to the interconnection structure 4716 via a thermally conductive adhesive. The thermistor 5902 can operate as a temperature meter. A BMS of the battery pack 202 can measure the temperature of the thermistor 5902 to determine the temperature of one or more battery cells within the battery pack to which the thermistor 5902 is coupled. The BMS can control the output of the battery pack 202 based on such readings to avoid overheating individual battery cells of the battery pack or the battery pack itself.

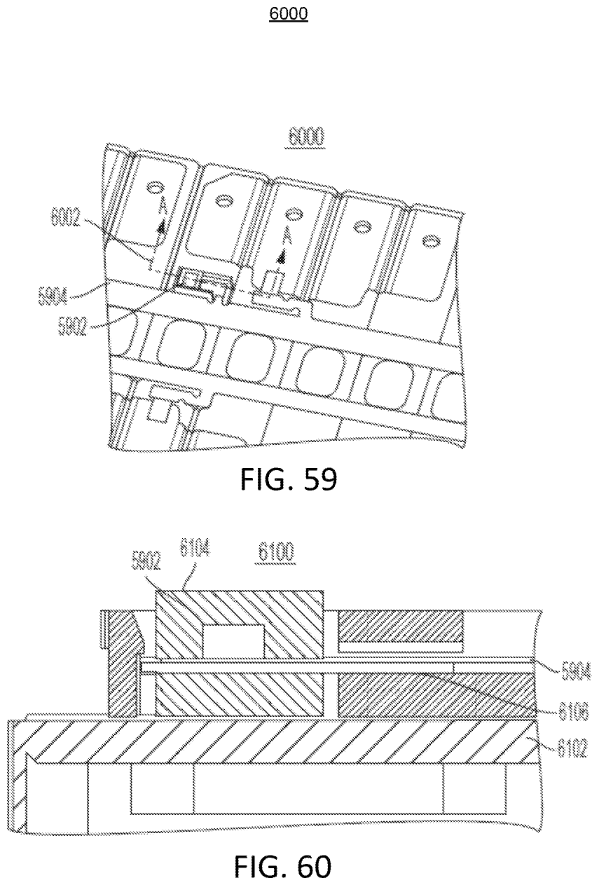

FIG. 59 depicts a perspective view 6000 of the thermistor 5902 measuring the temperature for different battery cells of the battery pack 202. The arrow 6002 can indicate the areas for which the temperature of the thermistor 5902 indicates the temperature of different battery cells. The thermistor 5902 can be coupled with the battery cells represented by the arrow 6002 through the interconnection structure 5904. For example, as battery cells (e.g., battery cells represented by the arrow 6002) provide power through the interconnection structure 5904 (e.g., provide power to an FPC coupled with the interconnection structure 5904), the interconnection structure 5904 can heat up. The thermistor 5902 can heat up with the interconnection structure 5904 according to the temperature increases according to the power provided by the battery cells underneath the arrow 6002. Multiple thermistors can be similarly coupled through the battery pack 202 and measure similar areas of battery cells in this manner. Accordingly, a BMS measuring the temperature of the thermistors can measure the temperature of specific battery cells (e.g., specific areas of battery cells) within the battery pack 202.

FIG. 60 depicts a cross-sectional view 6100 of the thermistor 5902 coupled with a battery cell 6102 through the interconnection structure 5904, in accordance with implementations. The battery cell 6102 can be or include a battery cell of the battery pack 202. The thermistor 5902 can be coupled with the battery cell 6102 through a thermally conductive adhesive 6104 and a metal sheet 6106. The thermally conductive adhesive 6104 can be a double-sided tape. The thermally conductive adhesive 6104 can be a thermally conductive adhesive tape. The thermally conductive adhesive 6104 can be electrically conductive and configured to transfer energy from the battery cell 6102 to the interconnection structure 5904. The metal sheet 6106 can be or include any metal, such as steel, iron, or aluminum. Current can travel from the battery cell 6102 through the thermistor 5902 and the interconnection structure 5904 to power an FPC or an external load. Using double-sided tape as the thermally conductive adhesive 6104 can be an improvement over glue adhesives because the double-sided tape can help avoid air bubbles, glue is often messy, difficult, and takes a long time to use, and applying glue can be process intensive. The thermistor 5902 can be welded or taped directly onto the battery cell 6102. The thermally conductive adhesives 6104 for multiple thermistors 5902 can have a uniform thickness to maintain uniformity and consistency in temperature readings across multiple thermistors 5902. Thickness of the thermally conductive adhesive includes a width of a portion of the thermally conductive adhesive between the thermistor 5902 and a portion (e.g., the terminal) of a battery cell 6102 to which the thermistor 5902 is coupled.

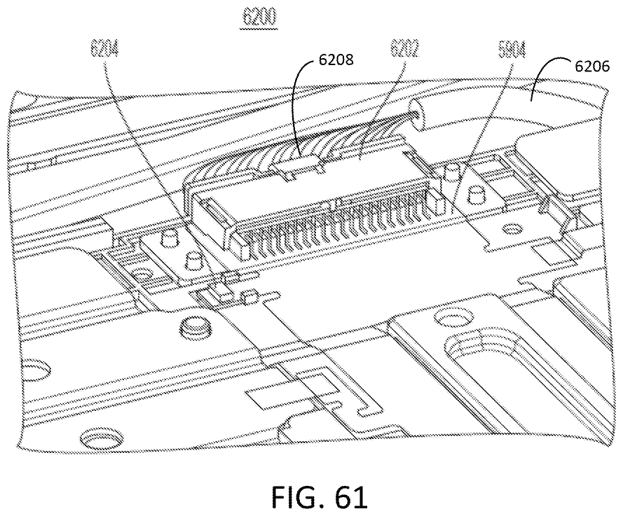

FIG. 61 depicts a perspective view of a circuit 6202 (e.g., an FPC) coupled with the interconnection structure 5904. The circuit 6202 can be the same as or similar to the circuit 4710 or the circuit 4722. The circuit 6202 can be welded to the interconnection structure 5904 or can be coupled with the interconnection structure 5904 via double-sided tape (e.g., a thermally conductive tape). A thermistor 6204 can be coupled with the interconnection structure 5904. The thermistor 6204 can be or include a negative temperature coefficient thermistor. The thermistor 6204 can be similar to the thermistor 5902. A BMS can measure the temperature of the thermistor 6204 to determine whether the temperature of the battery cells for which the thermistor 6204 measures the temperature is within an acceptable range. The BMS can stop drawing power from the battery cells based on the measurements to avoid overheating the circuit 6202.

The circuit 6202 can be connected or coupled with a harness 6206. The circuit 6202 can be connected with the harness 6206 via connectors 6208. The harness 6206 can be the harness 504. The circuit 6202 can reduce the voltage of current the circuit 6202 received through the interconnection structure 5904 (e.g., reduce the voltage through a step-down converter) and distributed current through the harness 6206. The harness 6206 can then distribute or conduct the current to the low voltage ports of the battery pack 202. Accordingly, the circuit 6202 can provide low voltage current to the low voltage ports of the battery pack 202.

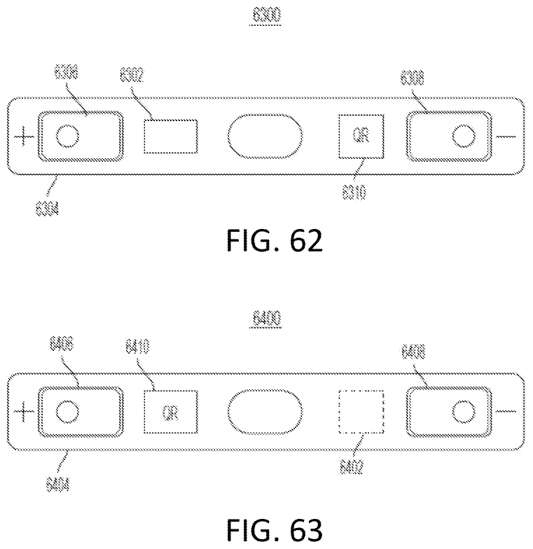

FIG. 62 depicts a top view 6300 of a thermistor 6302 coupled with a battery cell 6304. The thermistor 6302 can be the same as or similar to the thermistor 5902. The battery cell 6304 can be the same as or similar to the battery cell 6102. The thermistor 6302 can be welded onto the battery cell 6304 or coupled with the battery cell 6304 via a double-sided tape (e.g., a thermally conductive tape). As illustrated in the top view 6300, the thermistor 6302 can be located between a positive terminal 6306 and a negative terminal 6308 of the battery cell 6404. This positioning can facilitate better temperature measurements by the thermistor 6302 of the battery cell 6304. A QR code 6310 individually identifying the battery cell 6304 can be located between the thermistor 6302 and the negative terminal 6308.

FIG. 63 depicts a top view 6400 of a thermistor 6402 coupled with a battery cell 6404. The thermistor 6402 can be the same as or similar to the thermistor 5902. The battery cell 6404 can be the same as or similar to the battery cell 6102. The thermistor 6402 can be welded onto the battery cell 6404 or coupled with the battery cell 6404 via a double-sided tape (e.g., a thermally conductive tape). As illustrated in the top view 6400, the thermistor 6402 can be located between a positive terminal 6406 and a negative terminal 6408. This positioning can facilitate better temperature measurements by the thermistor 6402 of the battery cell 6404. A QR code 6410 individually identifying the battery cell 6304 can be located between the thermistor 6402 and the positive terminal 6406.

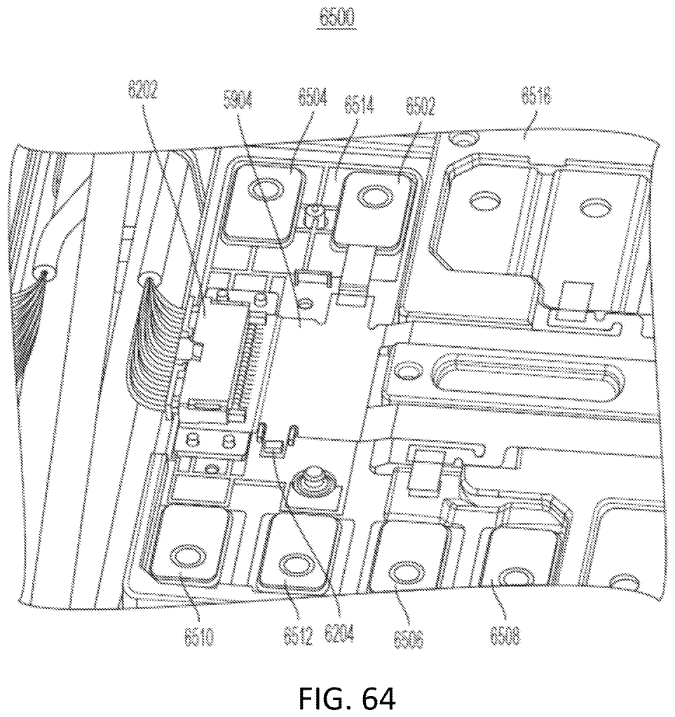

FIG. 64 depicts a perspective view 6500 of the circuit 6202 coupled with the interconnection structure 5904. As illustrated in the interconnection structure 5904, the circuit 6202 can be electrically connected with the positive terminals 6502, 6504, 6506, and 6508 and negative terminals 6510 and 6512 via the interconnection structure 5904 or an aluminum plate 6514. The aluminum plate 6514 can sit on a tray 6516. The aluminum can be the same or similar to the pedestal 5402. The aluminum plate 6514 can rest between the tray 6516 and the interconnection structure 5904. The aluminum plate 6514 can be aluminum because aluminum can be better for transferring heat (e.g., dissipating heat) than other metals or electrically conductive materials. The thermistor 6204 can measure the temperature of the battery cells of the positive terminals 6502, 6504, 6506, or 6508 and negative terminals 6510 or 6512.

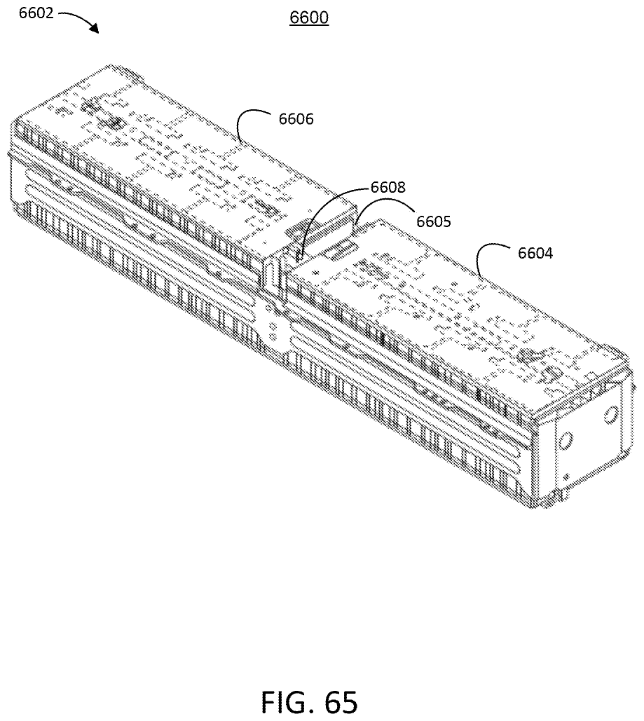

FIG. 65 depicts a perspective view 6600 of a battery module 6602 of a battery pack (e.g., the battery pack 202). The battery module 6602 can be the same as or similar to one or more of the battery modules 302, 304, 306, or 308. As illustrated in the perspective view 6600, the battery module 6602 can include a first side portion 6604, a second side portion 6606, and a disconnect 6608. The first side portion 6604 and the second side portion 6606 can each include battery cells (e.g., the battery cell 2202) and a current collector assembly (e.g., the current collector assembly 4702) connecting the terminals of the battery cells within the respective first side portion 6604 or second side portion 6606. The first side portion 6604 and the second side portion 6606 can each include busbars (e.g., the busbar 4704) at opposing ends of the respective first side portion 6604 or the second side portion 6606.

The disconnect 6608 can be coupled between the first side portion 6604 and the second side portion 6606 (e.g., at a middle portion 6605 of the battery module 6602). The disconnect 6608 can be coupled between the first side portion 6604 and the second side portion 6606 by fasteners (e.g., screws, nails, or bolts) that affix a bottom portion of the disconnect 6608 to a housing of the battery module 6602. As connected to the first side portion 6604 and the second side portion 6606, the disconnect 6608 can connect the busbars of each of the first side portion 6604 and the second side portion 6606 together. For example, the disconnect 6608 can be electrically conductive (e.g., made of a conductive material, such as a metal) and continuous from one end of the disconnect 6608 to the other end of the disconnect 6608. The disconnect 6608 can contact the busbars of each of the first side portion 6604 and the second side portion 6606, electrically connecting the busbars of each of the first side portion 6604 and the second side portion 6606 together. The disconnect 6608 can be removably coupled with the first side portion 6604 and the second side portion 6606 such that the disconnect 6608 can be removed from the battery module 6602, disconnecting the busbars of the first side portion 6604 and the second side portion 6606. In another example, a busbar can extend between two end portions of a battery pack including at least battery modules configured similar to or the same as the battery module 6602 (e.g., having a disconnect in the middle portion of the respective battery module). The busbar can be removably coupled with the disconnects of each battery module. Such can be advantageous, for example, to disconnect the connection between the busbars for servicing of the battery module 6602.

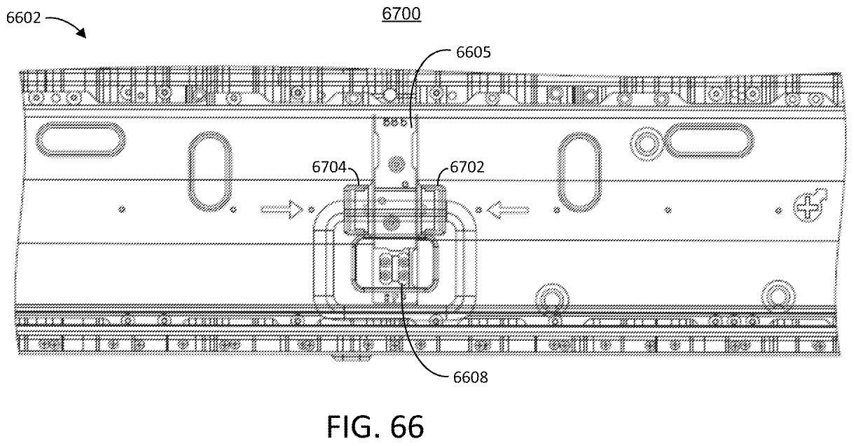

FIG. 66 depicts a partial top view 6700 of the battery module 6602. As illustrated in the partial top view 6700, the battery module 6602 can include circuits 6702 and 6704 (e.g., the circuits 4710 and 4722) and the disconnect 6608. The circuits 6702 and 6704 can be located at the middle portion 6605 of the battery module 6602. The circuits 6702 and 6704 can protrude from the battery module 6602 to avoid overheating inside of the housing of the battery module 6602.

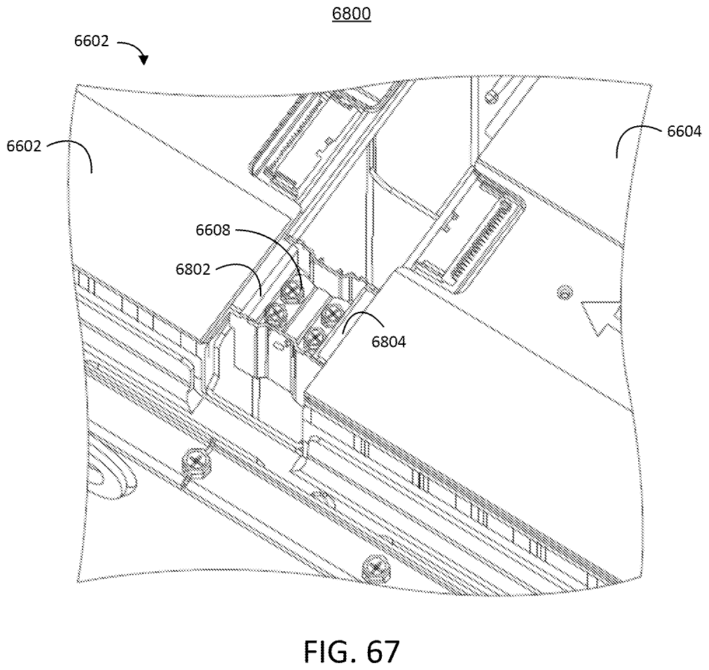

FIG. 67 depicts a partial perspective view 6800 of the battery module 6602. As illustrated in the partial perspective view 6800, the battery module 6602 can include busbars 6802 and 6804. The busbars 6802 and 6804 can be the busbars of the side portions 6604 and 6606. The disconnect 6608 can be electrically coupled with the busbars 6802 and 6804. Accordingly, the disconnect 6608 can electrically couple the busbars 6802 and 6804 together.

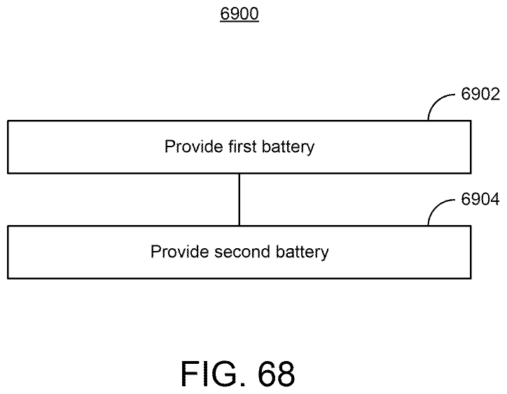

FIG. 68 depicts a method 6900 of providing a battery pack for an electric vehicle, in accordance with present implementations. The acts of the method 6900 can be interchangeable or removed. Additional acts can be added to the method 6900. The components described with respect to the method 6900 can be the same or similar components to the components of the battery pack 202. The method 6900 can include providing a first battery for a battery pack (ACT 6902). The method can include providing a second battery for the battery pack (ACT 6904).

At ACT 6902, the method 6900 can include providing a first battery (e.g., a first battery module) for a battery pack (e.g., a battery pack of an electric vehicle). The first battery can include a first plurality of battery cells (e.g., LFP prismatic battery cells) organized within a housing of the first battery. The battery pack can include a housing with a cover and a base with walls surrounding the edges of a plate (e.g., a floor of the plate) of the base. The base can additionally include members extending between opposite sides (e.g., side walls) of the base. The members can form bays between the adjacent members (e.g., members without any members between each other). The first battery can be disposed in a bay between two members or between a member (e.g., a lateral cross member) and a wall at an end of the housing.

At ACT 6904, the method can include providing a second battery (e.g., a second battery module) for the battery pack. The second battery can have more battery cells than the first battery. The second battery can be disposed (e.g., placed or fit into) at a bay between two members. The second battery can be disposed at a bay adjacent to (e.g., having a common member with) the bay of the first battery. A third and fourth battery (e.g., third and fourth battery modules) similar (e.g., having the same size or number of battery cells) to the second battery can be disposed at bays adjacent to the bay of the second battery.

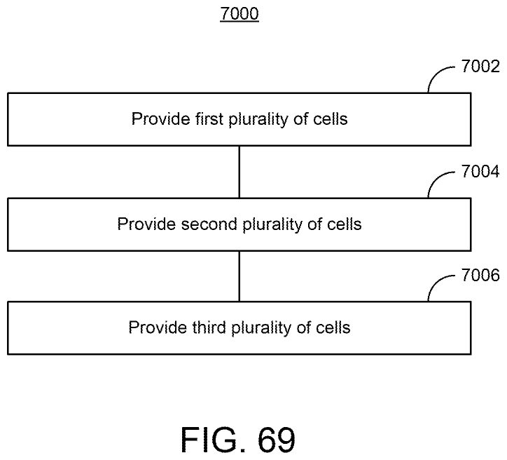

FIG. 69 depicts a method 7000 of providing a battery pack for an electric vehicle, in accordance with present implementations. The acts of the method 7000 can be interchangeable or removed. Additional acts can be added to the method 7000. The components described with respect to the method 7000 can be the same or similar components to the components of the battery pack 202. The method 7000 can include providing a first plurality of battery cells (ACT 7002). The method 7000 can include providing a second plurality of battery cells (ACT 7004). The method 7000 can include providing a third plurality of battery cells (ACT 7006).

At ACT 7002, the method 7000 can include providing a first plurality of battery cells. At ACT 7004, the method 7000 can include providing a second plurality of battery cells. At ACT 7006, the method 7000 can include providing a third plurality of battery cells. Each of the first plurality of battery cells or the second plurality of battery cells can include more battery cells than the third plurality of battery cells. Each of the first plurality of battery cells or the second plurality of battery cells can be provided in the second battery module. The third plurality of battery cells can be provided in the first battery module.

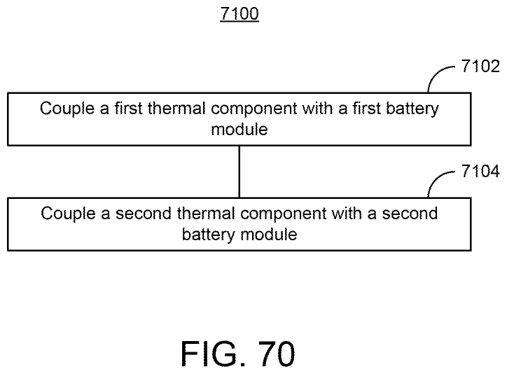

FIG. 70 depicts a method 7100 of coupling thermal components with a battery pack for an electric vehicle. The acts of the method 7100 can be interchangeable or removed. Additional acts can be added to the method 7100. The components described with respect to the method 7100 can be the same or similar components to the components of the battery pack 202. The method 7100 can include coupling a first thermal component with a first battery module and coupling a second thermal component with a second battery module (ACT 7102).

At ACT 7102, the method 7100 can include coupling a first thermal component with a first battery module and coupling a second thermal component with a second battery module. The first thermal component can be smaller than the second thermal component. The first thermal component can have the same width but a smaller length to the second thermal component. The first and second thermal components can each include a thermal component and a serpentine structure (e.g., a pipe, tube, crevice, or channel) that travels along a first surface of the thermal component. The serpentine structures can each have a serpentine portion that travels along the width of a first side of the first surface of the thermal component and a straight portion that travels along the width of a second side of the first surface of the thermal component. The thermal components can include faucets configured to receive liquid, such as water or glycol, to flow through the respective serpentine structures of the thermal components. The thermal components can be coupled (e.g., attached) to bottom plates or be the bottom plates of the first battery module and the second battery module, respectively. Cold liquid can flow through the thermal components to cool the battery cells within the battery modules.

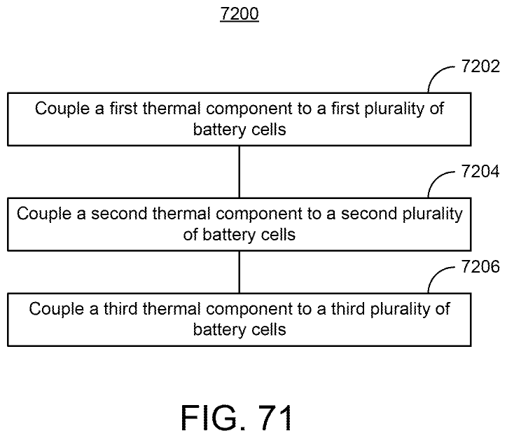

FIG. 71 depicts a method 7200 of coupling thermal components with a battery pack for an electric vehicle. The acts of the method 7200 can be interchangeable or removed. Additional acts can be added to the method 7200. The components described with respect to the method 7200 can be the same or similar components to the components of the battery pack 202. The method 7200 can include coupling a first thermal component to a first plurality of battery cells (ACT 7202). The method 7200 can include coupling a second thermal component to a second plurality of battery cells (ACT 7204). The method 7200 can include coupling a third thermal component to a third plurality of battery cells (ACT 7206).

At ACT 7202, the method 7200 can include coupling a first thermal component to a first plurality of battery cells. The first plurality of battery cells can be positioned in a first battery module. The first thermal component can be or include a serpentine structure or a cold plate. The first thermal component can be coupled to the first plurality of battery cells as the floor of the first battery module or by coupling or affixing (e.g., by welding, bolting, screwing, nailing, or otherwise fastening) the first thermal component to the floor (e.g., the floor of the housing) of the first battery module.

At ACT 7204, the method 7200 can include coupling a second thermal component to a second plurality of battery cells. The second plurality of battery cells can be positioned in a second battery module. The second thermal component can be or include a serpentine structure or a cold plate. The second thermal component can be coupled to the second plurality of battery cells as the floor of the second battery module or by coupling or affixing (e.g., by welding, bolting, screwing, nailing, or otherwise fastening) the second thermal component to the floor (e.g., the floor of the housing) of the second battery module.

At ACT 7206, the method 7200 can include coupling a third thermal component to a third plurality of battery cells. The third thermal component can be smaller (e.g., have a smaller width or length) than each of the first thermal component or the second thermal component. The third thermal component can be or include a serpentine structure or a cold plate. The third thermal component can be coupled to the third plurality of battery cells as the floor of the third battery module or by coupling or affixing (e.g., by welding, bolting, screwing, nailing, or otherwise fastening) the third thermal component to the floor (e.g., the floor of the housing) of the second battery module.

A pipe can be coupled with each of the first, second, and third thermal components. The pipe can be coupled with each thermal component at two locations. The two locations can be ends (e.g., edges) of the serpentine structures of the thermal component. When coupled with the thermal components, the pipe can extend up between battery modules (e.g., between battery cells of the battery modules at the middle of the battery modules) storing the first, second, and third plurality of battery cells. A hose can be connected to the pipe to transfer to transport water or glycol (e.g., cold water or glycol) through the pipe and to the serpentine structures of the thermal components. Because the serpentine structures can be coupled or touching the battery cells, the cold water or glycol can lower the temperature of the battery cells.

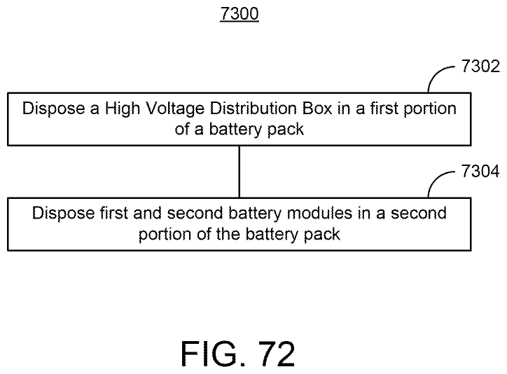

FIG. 72 depicts a method 7300 of configuring a battery pack for an electric vehicle. The acts of the method 7300 can be interchangeable or removed. Additional acts can be added to the method 7300. The components described with respect to the method 7300 can be the same or similar components to the components of the battery pack 202. The method 7300 can include disposing a voltage distribution box (VDB) (e.g., a high voltage distribution box (HVDB)) in a first portion of a battery pack (ACT 7302). The method 7300 can include disposing a first battery module and a second battery module in a second portion of the battery pack (ACT 7304).

At ACT 7302, the method 7300 can include disposing a VDB in a first portion of a battery pack. The first portion of the battery pack can be a bay (e.g., a circuitry bay) at a front of a battery pack. The first portion of the battery pack can be between a wall at the end of a housing of the battery pack and a member traveling the width of the housing between two walls at the edges of the housing. The VDB can include a VDB housing, positive and negative terminals, a fuse, a contactor, one or more busbars, a harness (e.g., a low voltage harness), and an FDU interface). The VDB can be configured to connect external high voltage loads (e.g., loads that operate at high voltages) with the busbars of the battery pack. The VDB can do so through the contactors. For example, the contactors can be exposed through a housing of the battery pack. An operator can connect one or more high voltage loads to the contactors through the housing.

At ACT 7304, the method 7300 can include disposing a first battery module and a second battery module in a second portion of the battery pack. The second portion of the battery pack can be the portion of the battery pack outside of the bay at the front of the battery pack. The second portion of the battery pack can be or include two separate bays adjacent to the bay at the front of the battery pack. The first battery module can be disposed or placed in one bay of the battery pack. The second battery module can be disposed or placed in another bay of the battery pack.

The VDB can be electrically coupled with the first battery module and with the second battery module. The VDB can be electrically coupled with the first battery module and the second battery module via a busbar (e.g., a high voltage busbar) of the VDB that contacts a busbar (e.g., a high voltage busbar) of the first battery module or the second battery module.

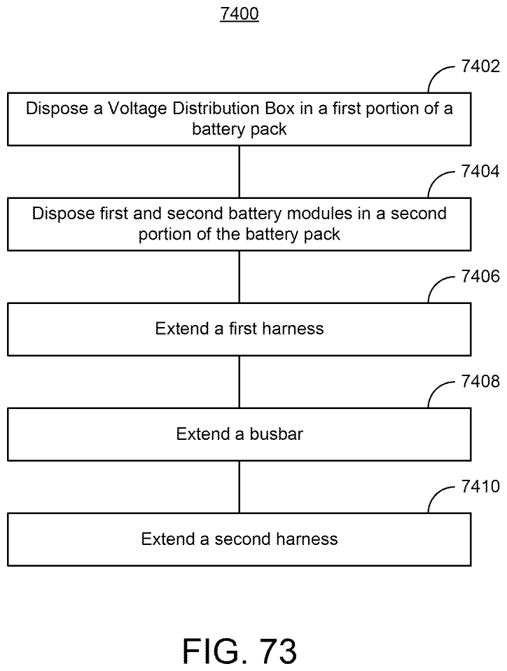

FIG. 73 depicts a method 7400 of configuring a battery pack for an electric vehicle. The acts of the method 7400 can be interchangeable or removed. Additional acts can be added to the method 7400. The components described with respect to the method 7400 can be the same or similar components to the components of the battery pack 202. The method 7400 can include disposing a voltage distribution box (VDB) (e.g., a high voltage distribution box (HVDB)) in a first portion of a battery pack (ACT 7402). The method 7400 can include disposing a first plurality of cells and a second plurality of cells in a second portion of the battery pack (ACT 7404). The method 7400 can include extending a first harness (ACT 7406). The method 7400 can include extending a busbar (ACT 7408). The method 7400 can include extending a second harness (ACT 7410).

At ACT 7402, the method 7400 can include disposing a VDB in a first portion of a battery pack. The first portion of the battery pack can be a bay (e.g., a circuitry bay) at a front of a battery pack. The first portion of the battery pack can be between a wall at the end of a housing of the battery pack and a member traveling the width of the housing between two walls at the edges of the housing. The VDB can include a VDB housing, positive and negative terminals, a fuse, a contactor, one or more busbars, a harness (e.g., a low voltage harness), and an FDU interface). The VDB can be configured to connect external high voltage loads (e.g., loads that operate at high voltages) with the busbars (e.g., high voltage busbars) of the battery pack. The VDB can do so through the contactors. For example, the contactors can be exposed through a housing of the battery pack. An operator can connect one or more high voltage loads to the contactors through the housing.

At ACT 7404, the method 7400 can include disposing a first battery module and a second battery module in a second portion of the battery pack. The first battery module can at least partially enclose a first plurality of battery cells. The second battery module can at least partially enclose a second plurality of battery cells. The second plurality of battery cells can include a higher number of battery cells than the first plurality of battery cells. The second portion of the battery pack can be the portion of the battery pack outside of the bay at the front of the battery pack. The second portion of the battery pack can be or include two separate bays adjacent to the bay at the front of the battery pack. The first plurality of cells can be disposed or placed in one bay of the battery pack. The second plurality of cells can be disposed or placed in another bay of the battery pack.

The VDB can be electrically coupled with the first battery module and the second battery module (e.g., the first plurality of battery cells and the second plurality of battery cells). The VDB can be electrically coupled with the first battery module and the second battery module via a busbar (e.g., a high voltage busbar) of the VDB that contacts a busbar (e.g., a high voltage busbar) connected (e.g., via a current collector assembly) of the first battery module or the second battery module.

At ACT 7406, the method can include extending a first harness. The first harness can be a low voltage harness. The first harness can be extended in a direction from the first portion of the battery pack (e.g., the front portion of the battery pack) to the second portion of the battery pack (e.g., a back portion of the battery pack). The first harness can be extended across a middle portion of a first battery module at least partially enclosing the first plurality of battery cells and a middle portion of a second battery module at least partially enclosing the second plurality of battery cells. The first harness can receive current from circuits (e.g., FCPs) of CCAs of the first battery module and the second battery module.

AT ACT 7408, the method can include extending a busbar (e.g., the busbar electrically coupling the VDB with the first battery module and the second battery module described above with respect to ACT 7404). The busbar can be or include a high voltage busbar. A first portion of the busbar can be extended across the second portion of the battery pack. A second portion of the busbar across first end portions of a first battery module and a second battery module in the battery pack. A third portion of the busbar across second end portions of the first battery module and the second battery module in the battery pack.

At ACT 7410, the method can include extending a second harness. The second harness can be a low voltage harness. The second harness can extend across the first portion of the battery pack. The second harness and the first harness can conduct current with a lower voltage and current conducted by the busbar.

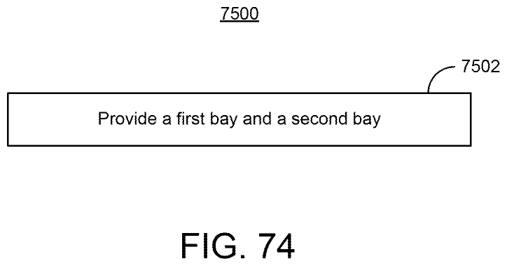

FIG. 74 depicts a method 7500 of providing a battery pack for an electric vehicle. The acts of the method 7500 can be interchangeable or removed. Additional acts can be added to the method 7500. The components described with respect to the method 7500 can be the same or similar components to the components of the battery pack 202. The method 7500 can include providing a first bay and a second bay (ACT 7502).

At ACT 7502, the method 7500 can include providing a first bay and a second bay. The first and second bays can be bays of a battery pack housing. The first bay can house a first plurality of battery cells. The first bay can house a first battery module containing the first plurality of battery cells. The second bay can house a second plurality of battery cells. The second bay can house a second battery module containing the second plurality of battery cells. The second plurality of battery cells can include more battery cells than the first plurality of battery cells.

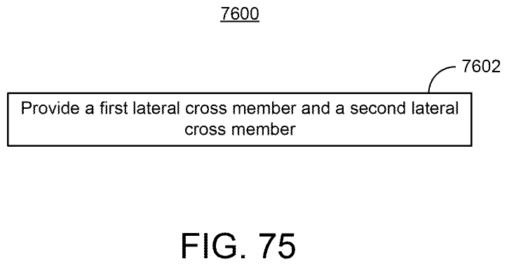

FIG. 75 depicts a method 7600 of providing a battery pack for an electric vehicle. The acts of the method 7600 can be interchangeable or removed. Additional acts can be added to the method 7600. The components described with respect to the method 7600 can be the same or similar components to the components of the battery pack 202. The method 7600 can include providing a first member and a second member (ACT 7602).

At ACT 7602, the method 7600 can include providing a first member (e.g., first lateral cross member) and a second member (e.g., second lateral cross member). The first member and the second member can extend across the width of a battery pack housing. The battery pack housing can include any number of members similarly extended across the width of the battery pack housing. A distance between a wall of a battery pack (e.g., a wall at an end of a battery pack) and the first member can be less than a distance between the first member and the second member. In one example, the four later cross members can extend the width of the battery pack. The first member can be a first distance from a wall at a first end of the battery pack. A second member can be a second distance from the first member. A third member can be a third distance from the second member opposite the first member. A fourth member can be a fourth distance form the third member opposite the second member. The first distance can be less than the second distance. The second distance can be equal to the third distance or the fourth distance. Accordingly, the members can be spaced apart such that battery modules or plurality of cells of different sizes can be placed in the bays between the members.

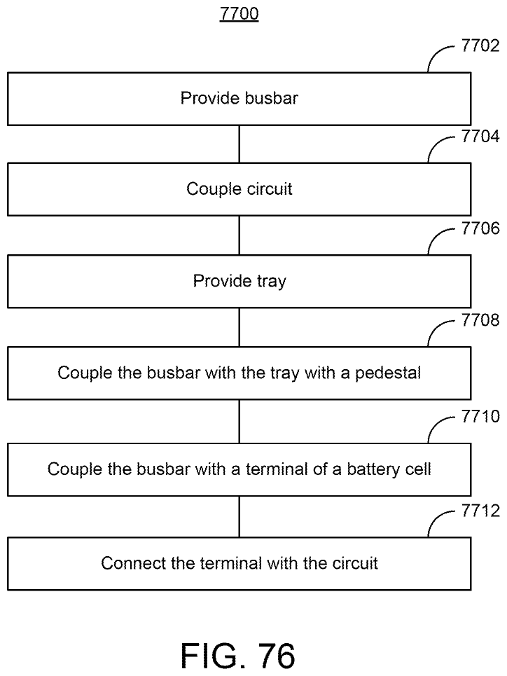

FIG. 76 depicts a method 7700 of coupling a current collector assembly with a battery module for an electric vehicle. The acts of the method 7700 can be interchangeable or removed. Additional acts can be added to the method 7700. The components described with respect to the method 7700 can be the same or similar components to the components of the battery pack 202. The method 7700 can include providing a busbar (ACT 7702). The method 7700 can include coupling a circuit (ACT 7704). The method 7700 can include providing a tray (ACT 7706). The method 7700 can include coupling the busbar with the tray with a first pedestal (ACT 7708). The method 7700 can include coupling the busbar with a terminal of a battery cell (ACT 7710). The method 7700 can include connecting the terminal with the circuit (ACT 7712).

At ACT 7702, the method 7700 can include providing a busbar. The busbar can include multiple portions. Each portion can include multiple welding areas.

At ACT 7704, the method 7700 can include coupling a circuit. The circuit can be coupled with the busbar (e.g., a front end of the busbar). A circuit (e.g., an FCP) can be coupled (e.g., affixed) to a top surface of an interconnection structure. The circuit can be coupled (e.g., electrically coupled) with an end of the busbar (e.g., a front end portion of the busbar) via a pedestal that contacts the interconnection structure, the circuit, and the busbar. A second circuit can be coupled at an opposite side of the same surface of the interconnection structure. The two circuits can be disposed to the same end portions of the interconnection structure.

At ACT 7706, the method can include providing a tray. The interconnection structure or the busbar can rest or be supported by the tray. The tray can include one or more cavities. Each portion of the busbar can be held in place within a cavity of the tray by a buckle that extends from the tray through a hole in the portion.

At ACT 7708, the method 7700 can include coupling the busbar (e.g., a portion of the busbar) with the tray with a first pedestal. The busbar can be coupled with the tray through the first pedestal through a buckle of the tray. The buckle can extend through the first pedestal and the busbar. The busbar can be with the tray through a buckle at a first end (e.g., first end portion) of the tray. The busbar (e.g., another busbar) can be coupled at a second end (e.g., second end portion) opposite the first end. The portions of the busbar can be coupled (e.g., electrically coupled) with each other through the interconnection structure.

As a current collector assembly, the tray, the first pedestal, and the busbar can be enclosed over one or more battery cells of a battery module. A battery module housing can enclose the collector assembly, the tray, the first pedestal, the busbar, and one or more battery cells. The battery module housing can be between thermal insulation material and a battery pack cover of a battery pack housing.

At ACT 7710, the method 7700 can include coupling the busbar with a terminal of a battery cell. A welding area (e.g., a current collector element) of the busbar can be welded to the terminal of the battery cell. The welding area can be exposed through a gap in the tray. A laser can weld (e.g., micro-weld) the current collector element to the terminal of the battery cell through the gap. The laser can be rotated, moved, or otherwise operated to similarly weld any number of current collector elements to terminals of battery cells of the battery module.

At ACT 7712, the method 7700 can include connecting the terminal (e.g., the terminal of the battery cell) with the circuit. The terminal can be connected with the circuit through the welded portion of the busbar. The busbar can contact the interconnection structure. The interconnection structure can contact or support the circuit. Accordingly, the terminal of the battery cell can be coupled (e.g., electrically coupled) with the circuit through the busbar and the interconnection structure.

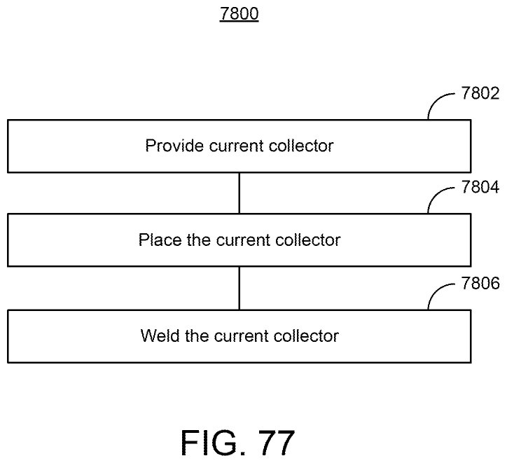

FIG. 77 depicts a method 7800 of coupling a current collector assembly with a battery module for an electric vehicle. The acts of the method 7800 can be interchangeable or removed. Additional acts can be added to the method 7800. The components described with respect to the method 7800 can be the same or similar components to the components of the battery pack 202. The method 7800 can include providing a current collector assembly comprising a tray and a busbar (ACT 7802). The method 7800 can include placing the current collector assembly over a battery pack comprising a battery cell (ACT 7804). The method 7800 can include welding the current collector element to a terminal of the battery cell through a surface of the current collector element exposed by the cavity (ACT 7806).

At ACT 7802, the method 7800 can include providing a current collector assembly comprising a tray and a busbar. The busbar can have a current collector element exposed by a cavity in the tray. The current collector element can be a welding area (e.g., a designated welding area). The busbar can include multiple portions, each portion can rest in a different cavity within the tray. Each portion can be held in place within the cavity by a buckle that extends from the tray through a hole in the portion. Each portion can include multiple welding areas. The welding areas can be horizontally adjacent to each other (e.g., be positioned along a line (e.g., a straight line) next to each other (e.g., unobstructed from each other or within 10 centimeters, 20 centimeters, 50 centimeters, or a meter of each other) along a first axis). Each welding area can be vertically adjacent to a hole (e.g., be positioned along a line (e.g., a straight line) next to each other (e.g., unobstructed from each other or within 10 centimeters, 20 centimeters, 50 centimeters, or a meter of each other) along a second axis transverse to the first axis). The welding areas can have a donut pattern. The welding areas can be or include a different material from the rest of the portion of the busbar. The welding areas can have a lower melting point such that during welding the welding areas melt while the surrounding area of the portion of the busbar does not change shape. The different portions of the busbar can be connected with an interconnection structure that at least partially overlays each portion of the busbar. The interconnection structure can contact two similarly configured busbars or an FCP.

At ACT 7804, the method 7800 can include placing the current collector assembly over a battery pack comprising a battery cell. The current collector assembly can be placed over the battery cell such that a welding area overlays or otherwise contacts a welding area of the current collector. In doing so, the current collector assembly can be placed over a plurality of battery cells (e.g., battery cells of a battery module) such that each welding area of the current collector assembly overlays or contacts a different battery cell terminal. The welding areas can be placed on top of or otherwise contact the battery cell terminals through gaps or cavities in the tray of the current collector assembly.

At ACT 7806, the method 7800 can include welding the current collector element (e.g., the welding area) to a terminal of the battery cell. The current collector element can be welded (e.g., micro-welded) to the terminal of the battery cell through a surface of the current collector element exposed by the cavity.

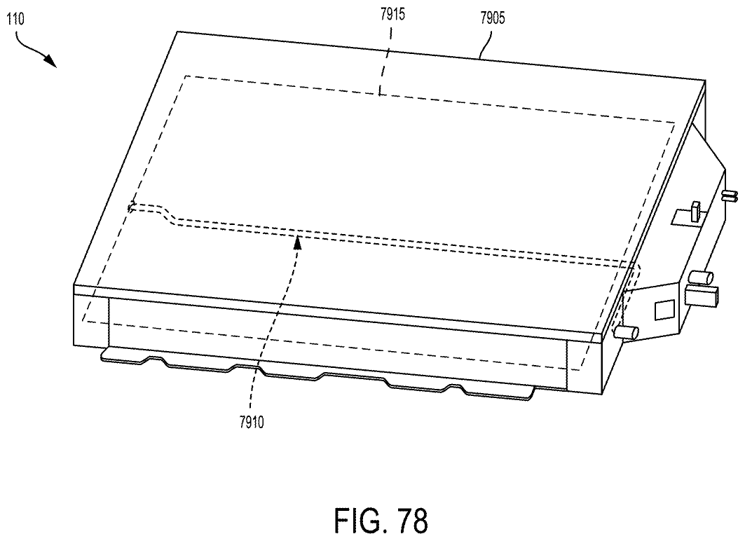

FIG. 78 depicts an example battery pack 110. Referring to FIG. 78, among others, the battery pack 110 can provide power to vehicle 105. Battery packs 110 can include any arrangement or network of electrical, electronic, mechanical or electromechanical devices to power a vehicle of any type, such as the vehicle 105. The battery pack 110 can include at least one housing 7905. The housing 7905 can include at least one battery module 115 or at least one battery cell 120, as well as other battery pack components. The battery module 115 can be or can include one or more groups of prismatic cells, cylindrical cells, pouch cells, or other form factors of battery cells 120. The housing 7905 can include a shield on the bottom or underneath the battery module 115 to protect the battery module 115 and/or cells 120 from external conditions, for example if the vehicle 105 is driven over rough terrains (e.g., off-road, trenches, rocks, etc.) The battery pack 110 can include at least one cooling line 7910 that can distribute fluid through the battery pack 110 as part of a thermal/temperature control or heat exchange system that can also include at least one thermal component (e.g., cold plate) 7915. The thermal component 7915 can be positioned in relation to a top submodule and a bottom submodule, such as in between the top and bottom submodules, among other possibilities. The battery pack 110 can include any number of thermal components 7915. For example, there can be one or more thermal components 7915 per battery pack 110, or per battery module 115. At least one cooling line 7910 can be coupled with, part of, or independent from the thermal component 7915.

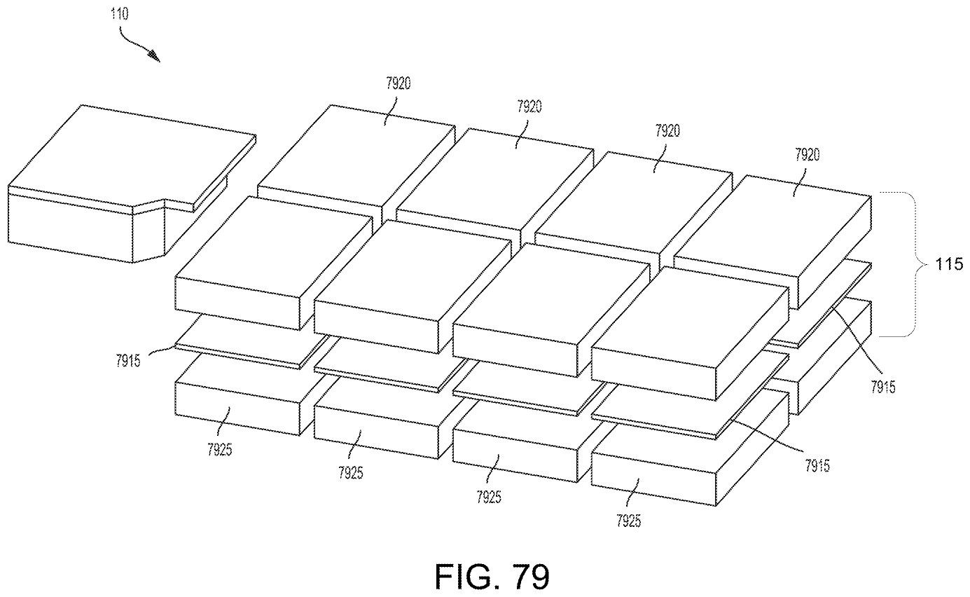

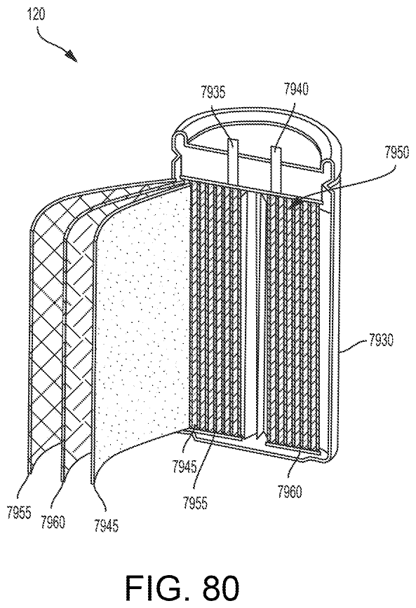

FIG. 79 depicts example battery modules 115, and FIGS. 80, 81, and 82 depict an example cross sectional view of a battery cell 120. The battery modules 115 can include at least one submodule. For example, the battery modules 115 can include at least one first (e.g., top) submodule 7920 or at least one second (e.g., bottom) submodule 7925. At least one thermal component 7915 can be disposed between the top submodule 7920 and the bottom submodule 7925. For example, one thermal component 7915 can be configured for heat exchange with one battery module 115. The thermal component 7915 can be disposed or thermally coupled between the top submodule 7920 and the bottom submodule 7925. One thermal component 7915 can also be thermally coupled with more than one battery module 115 (or more than two submodules 7920, 7925). The thermal components 7915 shown adjacent to each other can be combined into a single thermal component 7915 that spans the size of one or more submodules 7920 or 7925. The thermal component 7915 can be positioned underneath submodule 7920 and over submodule 7925, in between submodules 7920 and 7925, on one or more sides of submodules 7920, 7925, among other possibilities. The thermal component 7915 can be disposed in sidewalls, cross members, structural beams, among various other components of the battery pack, such as battery pack 110 described above. The battery submodules 7920, 7925 can collectively form one battery module 115. In some examples each submodule 7920, 7925 can be considered as a complete battery module 115, rather than a submodule.

The battery modules 115 can each include a plurality of battery cells 120. The battery modules 115 can be disposed within the housing 7905 of the battery pack 110. The battery modules 115 can include battery cells 120 that are cylindrical cells or prismatic cells, for example. The battery module 115 can operate as a modular unit of battery cells 120. For example, a battery module 115 can collect current or electrical power from the battery cells 120 that are included in the battery module 115 and can provide the current or electrical power as output from the battery pack 110. The battery pack 110 can include any number of battery modules 115. For example, the battery pack can have one, two, three, four, five, six, seven, eight, nine, ten, eleven, twelve or other number of battery modules 115 disposed in the housing 7905. It should also be noted that each battery module 115 can include a top submodule 7920 and a bottom submodule 7925, possibly with a thermal component 7915 in between the top submodule 7920 and the bottom submodule 7925. The battery pack 110 can include or define a plurality of areas for positioning of the battery module 115 and/or cells 120. The battery modules 115 can be square, rectangular, circular, triangular, symmetrical, or asymmetrical. In some examples, battery modules 115 can be different shapes, such that some battery modules 115 are rectangular but other battery modules 115 are square shaped, among other possibilities. The battery module 115 can include or define a plurality of slots, holders, or containers for a plurality of battery cells 120. It should be noted the illustrations and descriptions herein are provided for example purposes and should not be interpreted as limiting. For example, the battery cells 120 can be inserted in the battery pack 110 without battery modules 7920 and 7925. The battery cells 120 can be disposed in the battery pack 110 in a cell-to-pack configuration without modules 7920 and 7925, among other possibilities.

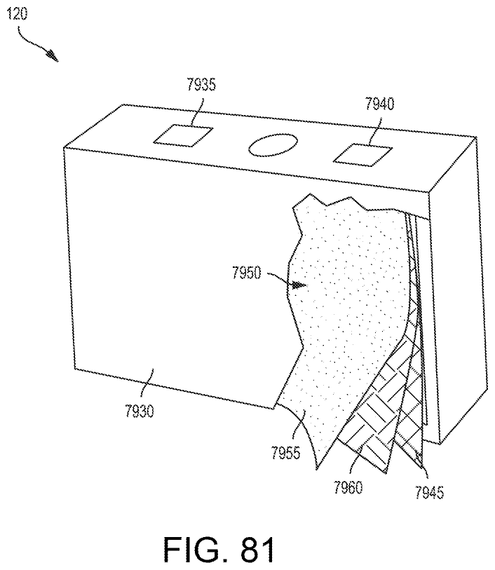

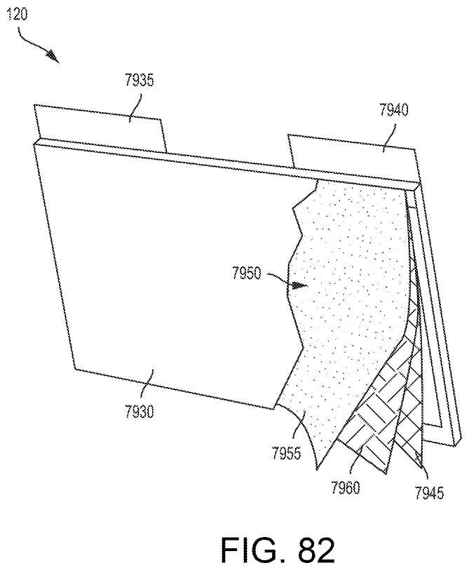

Battery cells 120 have a variety of form factors, shapes, or sizes. For example, battery cells 120 can have a cylindrical, rectangular, square, cubic, flat, pouch, elongated or prismatic form factor. As depicted in FIG. 80, for example, the battery cell 120 can be cylindrical. As depicted in FIG. 81, for example, the battery cell 120 can be prismatic. As depicted in FIG. 82, for example, the battery cell 120 can include a pouch form factor. Battery cells 120 can be assembled, for example, by inserting a winded or stacked electrode roll (e.g., a jelly roll) including electrolyte material into at least one battery cell housing 7930. The electrolyte material, e.g., an ionically conductive fluid or other material, can support electrochemical reactions at the electrodes to generate, store, or provide electric power for the battery cell by allowing for the conduction of ions between a positive electrode and a negative electrode. The battery cell 120 can include an electrolyte layer where the electrolyte layer can be or include solid electrolyte material that can conduct ions. For example, the solid electrolyte layer can conduct ions without receiving a separate liquid electrolyte material. The electrolyte material, e.g., an ionically conductive fluid or other material, can support conduction of ions between electrodes to generate or provide electric power for the battery cell 120. The housing 7930 can be of various shapes, including cylindrical or rectangular, for example. Electrical connections can be made between the electrolyte material and components of the battery cell 120. For example, electrical connections to the electrodes with at least some of the electrolyte material can be formed at two points or areas of the battery cell 120, for example to form a first polarity terminal 7935 (e.g., a positive or anode terminal) and a second polarity terminal 7940 (e.g., a negative or cathode terminal). The polarity terminals can be made from electrically conductive materials to carry electrical current from the battery cell 120 to an electrical load, such as a component or system of the vehicle 105.

For example, the battery cell 120 can include at least one lithium-ion battery cell. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 120 to separate the anode and cathode from each other and to facilitate transfer of lithium ions between the anode and cathode. It should be noted that battery cell 120 can also take the form of a solid state battery cell developed using solid electrodes and solid electrolytes. Solid electrodes or electrolytes can be or include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B═Al, Ti), garnet-type with formula A₃B₂(XO₄)₃ (A=Ca, Sr, Ba and X═Nb. Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₇P₃S₁₁, Li₇S—P₂S₅, Li₇S—B₂S₃, SnS—P₂S₅, Li₇S—SiS₂, Li₇S—P₂S₅, Li₇S—GeS₂, Li₁₀GeP₂S₁₂) and/or sulfide-based lithium argyrodites with formula Li₆PS₅X (X═Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

The battery cell 120 can be included in battery modules 115 or battery packs 110 to power components of the vehicle 105. The battery cell housing 7930 can be disposed in the battery module 115, the battery pack 110, or a battery array installed in the vehicle 105. The housing 7930 can be of any shape, such as cylindrical with a circular (e.g., as depicted in FIG. 80, among others), elliptical, or ovular base, among others. The shape of the housing 7930 can also be prismatic with a polygonal base, as shown in FIG. 81, among others. As shown in FIG. 82, among others, the housing 7930 can include a pouch form factor. The housing 7930 can include other form factors, such as a triangle, a square, a rectangle, a pentagon, and a hexagon, among others. In some embodiments, the battery pack can not include modules (e.g., module-free). For example, the battery pack can have a module-free or cell-to-pack configuration where the battery cells are arranged directly into a battery pack without assembly into a module.

The housing 7930 of the battery cell 120 can include one or more materials with various electrical conductivity or thermal conductivity, or a combination thereof. The electrically conductive and thermally conductive material for the housing 7930 of the battery cell 120 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 7930 of the battery cell 120 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others. In examples where the housing 7930 of the battery cell 120 is prismatic (e.g., as depicted in FIG. 81, among others) or cylindrical (e.g., as depicted in FIG. 80, among others), the housing 7930 can include a rigid or semi-rigid material such that the housing 7930 is rigid or semi-rigid (e.g., not easily deformed or manipulated into another shape or form factor). In examples where the housing 7930 includes a pouch form factor (e.g., as depicted in FIG. 82, among others), the housing 7930 can include a flexible, malleable, or non-rigid material such that the housing 7930 can be bent, deformed, manipulated into another form factor or shape.

The battery cell 120 can include at least one anode layer 7945, which can be disposed within the cavity 7950 defined by the housing 7930. The anode layer 7945 can include a first redox potential. The anode layer 7945 can receive electrical current into the battery cell 120 and output electrons during the operation of the battery cell 120 (e.g., charging or discharging of the battery cell 120). The anode layer 7945 can include an active substance. The active substance can include, for example, an activated carbon or a material infused with conductive materials (e.g., artificial or natural graphite, or blended), lithium titanate (Li₄Ti₅O₁₂), or a silicon-based material (e.g., silicon metal, oxide, carbide, pre-lithiated), or other lithium alloy anodes (Li—Mg, Li—Al, Li—Ag alloy etc.) or composite anodes consisting of lithium and carbon, silicon and carbon or other compounds. The active substance can include graphitic carbon (e.g., ordered or disordered carbon with sp² hybridization), Li metal anode, or a silicon-based carbon composite anode, or other lithium alloy anodes (Li—Mg. Li—Al, Li—Ag alloy etc.) or composite anodes consisting of lithium and carbon, silicon and carbon or other compounds. In some examples, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state.

The battery cell 120 can include at least one cathode layer 7955 (e.g., a composite cathode layer compound cathode layer, a compound cathode, a composite cathode, or a cathode). The cathode layer 7955 can include a second redox potential that can be different than the first redox potential of the anode layer 7945. The cathode layer 7955 can be disposed within the cavity 7950. The cathode layer 7955 can output electrical current out from the battery cell 120 and can receive electrons during the discharging of the battery cell 120. The cathode layer 7955 can also receive lithium ions during the discharging of the battery cell 120. Conversely, the cathode layer 7955 can receive electrical current into the battery cell 120 and can output electrons during the charging of the battery cell 120. The cathode layer 7955 can release lithium ions during the charging of the battery cell 120.

The battery cell 120 can include a layer 7960 disposed within the cavity 7950. The layer 7960 can include a solid electrolyte layer. The layer 7960 can include a separator wetted by a liquid electrolyte. The layer 7960 can include a polymeric material. The layer 7960 can include a polymer separator. The layer 7960 can be arranged between the anode layer 7945 and the cathode layer 7955 to separate the anode layer 7945 and the cathode layer 7955. The polymer separator can physically separate the anode and cathode from a cell short circuit. A separator can be wetted with a liquid electrolyte. The liquid electrolyte can be diffused into the anode layer 7945. The liquid electrolyte can be diffused into the cathode layer 7955. The layer 7960 can help transfer ions (e.g., Li+ ions) between the anode layer 7945 and the cathode layer 7955. The layer 7960 can transfer Lit cations from the anode layer 7945 to the cathode layer 7955 during the discharge operation of the battery cell 120. The layer 7960 can transfer lithium ions from the cathode layer 7955 to the anode layer 7945 during the charge operation of the battery cell 120.

The redox potential of layers (e.g., the first redox potential of the anode layer 7945 or the second redox potential of the cathode layer 7955) can vary based on a chemistry of the respective layer or a chemistry of the battery cell 120. For example, lithium-ion batteries can include an LFP (lithium iron phosphate) chemistry, an LMFP (lithium manganese iron phosphate) chemistry, an NMC (Nickel Manganese Cobalt) chemistry, an NCA (Nickel Cobalt Aluminum) chemistry, an OLO (Over Lithiated Oxide) chemistry, or an LCO (lithium cobalt oxide) chemistry for a cathode layer (e.g., the cathode layer 7955). Lithium-ion batteries can include a graphite chemistry, a silicon-graphite chemistry, or a lithium metal chemistry for the anode layer (e.g., the anode layer 7945).

For example, lithium-ion batteries can include an olivine phosphate (LiMPO₄, M=Fe and/or Co and/or Mn and/or Ni)) chemistry, LISICON or NASICON Phosphates (Li₃M₂(PO₄)₃ and LiMPO₄Oₓ, M=Ti, V, Mn, Cr, and Zr), for example lithium iron phosphate (LFP), lithium iron manganese phosphate (LMFP), layered oxides (LiMO₂, M=Ni and/or Co and/or Mn and/or Fe and/or Al and/or Mg) examples, NMC (Nickel Manganese Cobalt) chemistry, an NCA (Nickel Cobalt Aluminum) chemistry, or an LCO (lithium cobalt oxide) chemistry for a cathode layer, lithium rich layer oxides (Li₁₊ₓM₁₋ₓO₂) (Ni, and/or Mn, and/or Co), (OLO or LMR), spinel (LiMn₂O₄) and high voltage spinels (LiMn_{1.5}Ni_{0.5}O₄), disordered rock salt, Fluorophosphates Li₂FePO₄F (M=Fe, Co, Ni) and Fluorosulfates LiMSO₄F (M=Co, Ni, Mn) (e.g., the cathode layer 7955). Lithium-ion batteries can include a graphite chemistry, a silicon-graphite chemistry, or a lithium metal chemistry for the anode layer (e.g., the anode layer 7945). For example, a cathode layer having an LFP chemistry can have a redox potential of 3.4 V vs. Li/Lit, while an anode layer having a graphite chemistry can have a 0.2 V vs. Li/Li⁺ redox potential.

Electrode layers can include anode active material or cathode active material, commonly in addition to a conductive carbon material, a binder, or other additives as a coating on a current collector (metal foil). The chemical composition of the electrode layers can affect the redox potential of the electrode layers. For example, cathode layers (e.g., the cathode layer 7955) can include medium to high-nickel content (50 to 80%, or equal to 80% Ni) lithium transition metal oxide, such as a particulate lithium nickel manganese cobalt oxide (“LiNMC”), a lithium nickel cobalt aluminum oxide (“LiNCA”), a lithium nickel manganese cobalt aluminum oxide (“LiNMCA”), or lithium metal phosphates like lithium iron phosphate (“LFP”) and lithium iron manganese phosphate (“LMFP”). Anode layers (e.g., the anode layer 7945) can include conductive carbon materials such as graphite, carbon black, carbon nanotubes, and the like. Anode layers can include Super P carbon black material, Ketjen Black, Acetylene Black, SWCNT, MWCNT, graphite, carbon nanofiber, or graphene, for example.

Electrode layers can also include chemical binding materials (e.g., binders). Binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Binder materials can include agar-agar, alginate, amylose, Arabic gum, carrageenan, cascine, chitosan, cyclodextrines (carbonyl-beta), ethylene propylenc diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

Current collector materials (e.g., a current collector foil to which an electrode active material is laminated to form a cathode layer or an anode layer) can include a metal material. For example, current collector materials can include aluminum, copper, nickel, titanium, stainless steel, or carbonaceous materials. The current collector material can be formed as a metal foil. For example, the current collector material can be an aluminum (Al) or copper (Cu) foil. The current collector material can be a metal alloy, made of Al, Cu, Ni, Fe, Ti, or combination thereof. The current collector material can be a metal foil coated with a carbon material, such as carbon-coated aluminum foil, carbon-coated copper foil, or other carbon-coated foil material.

The layer 7960 can include or be made of a liquid electrolyte material. For example, the layer 7960 can be or include at least one layer of polymeric material (e.g., polypropylene, polyethylene, or other material) including pores that are wetted (e.g., saturated with, soaked with, receive, are filled with) a liquid electrolyte substance to enable ions to move between electrodes. The liquid electrolyte material can include a lithium salt dissolved in a solvent. The lithium salt for the liquid electrolyte material for the layer 7960 can include, for example, lithium tetrafluoroborate (LiBF₄), lithium hexafluorophosphate (LiPF₆), and lithium perchlorate (LiClO₄), among others. The solvent can include, for example, dimethyl carbonate (DMC), ethylene carbonate (EC), and diethyl carbonate (DEC), among others. Liquid electrolyte is not necessarily disposed near the layer 7960, but the liquid electrolyte can fill the battery cells 120 in many different ways. The layer 7960 can include or be made of a solid electrolyte material, such as a ceramic electrolyte material, polymer electrolyte material, or a glassy electrolyte material, or among others, or any combination thereof.

In some embodiments, the solid electrolyte film can include at least one layer of a solid electrolyte. Solid electrolyte materials of the solid electrolyte layer can include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B═Al, Ti), garnet-type with formula A₃B₂(XO₄)₃ (A=Ca, Sr. Ba and X═Nb, Ta), lithium phosphorous oxy-nitride (LiₓPO_{y}N₂). In some embodiments, the solid electrolyte layer can include a glassy, ceramic and/or crystalline sulfide-based electrolyte (e.g., Li₃PS₄, Li₇P₃S₁₁, Li₇S—P₂S₅, Li₇S—B₂S₃, SnS—P₂S₅, Li₇S—SiS₂, Li₇S—P₂S₅, Li₇S—GeS₂, Li₁₀GeP₂S₁₂) and/or sulfide-based lithium argyrodites with formula Li₆PS₅X (X═Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

In examples where the layer 7960 includes a liquid electrolyte material, the layer 7960 can include a non-aqueous polar solvent. The non-aqueous polar solvent can include a carbonate such as ethylene carbonate, propylene carbonate, diethyl carbonate, ethyl methyl carbonate, dimethyl carbonate, or a mixture of any two or more thereof. The layer 7960 can include at least one additive. The additives can be or include vinylidene carbonate, fluoroethylene carbonate, ethyl propionate, methyl propionate, methyl acetate, ethyl acetate, or a mixture of any two or more thereof. The layer 7960 can include a lithium salt material. For example, the lithium salt can be lithium perchlorate, lithium hexafluorophosphate, lithium bis(fluorosulfonyl)imide, lithium bis(trifluorosulfonyl)imide, or a mixture of any two or more thereof. The lithium salt can be present in the layer 7960 from greater than 0 M to about 1.5 M. Once disposed to the battery cell 120, liquid electrolyte can be present and touching battery subcomponents present within the battery cell 120. The battery subcomponents can include the cathode, the anode, the separator, the current collector, etc.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C #, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein. Each component or any combination of components described herein can be a component of the same implementation, regardless of the reference number for the component.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

1.-60.

61. A battery pack housing, comprising:
a first bay and a second bay, the first bay to at least partially enclose a first plurality of battery cells, the second bay to house a second plurality of battery cells, the second plurality of battery cells comprising more battery cells than the first plurality of battery cells.

62. The battery pack housing of claim 61, comprising:
a first wall at a first end portion;
a second wall at a second end portion;
a first member, the first member and the first wall defining the first bay to house the first plurality of battery cells; and
a second member, the first member and the second member defining the second bay to house the second plurality of battery cells.

63. The battery pack housing of claim 61, comprising:
the first bay comprising a first enclosure and the second bay comprising a second enclosure, wherein the second enclosure is larger than the first enclosure.

64. The battery pack housing of claim 61, comprising:
a first wall at a first end portion;
a second wall at a second end portion;
a first member, the first member and the first wall defining the first bay to house the first plurality of battery cells;
a second member, the first member and the second member defining the second bay to house the second plurality of battery cells;
a third member, the third member and the second member defining a third bay to house a third plurality of battery cells; and
a fourth member adjacent to the second wall, the fourth member and the third member defining a fourth bay to house a fourth plurality of battery cells.

65. The battery pack housing of claim 61, comprising:
a third bay and a fourth bay, the third bay and the fourth bay being substantially similar in size to the second bay.

66. The battery pack housing of claim 61, comprising:
a first battery housing enclosing at least a portion of the first plurality of battery cells, the first battery housing conforms to a shape of the first bay, the first battery housing having a first length; and
a second battery housing enclosing at least a portion of the second plurality of battery cells, the second battery housing conforms to a shape of the second bay, a length of the second battery housing is greater than the length of the first battery housing.

67. The battery pack housing of claim 61, comprising:
a third bay to house at least one of a battery voltage temperature (BVT) monitor and a voltage distribution box (VDB), the at least one of the BVT monitor and the VDB communicably coupled to the first plurality of battery cells and the second plurality of battery cells.

68. The battery pack housing of claim 61, comprising:
a cover adjacent to the first bay and the second bay to enclose an opening of the first bay and an opening of the second bay;
a first thermal component to couple with the first plurality of battery cells, the first plurality of battery cells is between the cover and the first thermal component; and
a second thermal component to couple with the second plurality of battery cells, the second plurality of battery cells is between the cover and the second thermal component.

69. The battery pack housing of claim 61, comprising:
a cover adjacent to the first bay and the second bay to enclose an opening of the first bay and an opening of the second bay; and
a service window on the cover, the service window to dispose closer to the second plurality of battery cells than the first plurality of battery cells.

70. The battery pack housing of claim 61, comprising:
a cover adjacent to the first bay and the second bay to enclose an opening of the first bay and an opening of the second bay; and
a thermal insulation material between the cover and the first plurality of battery cells and between the cover and the second plurality of battery cells.

71. The battery pack housing of claim 61, comprising:
a first wall at a first end portion;
a second wall at a second end portion;
a base plate comprising a convex portion and a concave portion;
a first member, the first member, the base plate, and the first wall defining the first bay to house the first plurality of battery cells; and
a second member, the first member, the base plate, and the second member defining the second bay to house the second plurality of battery cells.

72. A system, comprising:
a first member;
a second member; and
a distance between a wall of a battery pack and the first member is less than a distance between the first member and the second member.

73. The system of claim 72, comprising:
the first member and the wall defining a first bay to house a first plurality of battery cells; and
the first member and the second member defining a second bay to house a second plurality of battery cells comprising more battery cells than the first plurality of battery cells.

74. The system of claim 72, comprising:
a first wall at a first end portion;
a second wall at a second end portion;
the first member and the first wall defining a first bay to house a first plurality of battery cells;
the first member and the second member defining a second bay to house a second plurality of battery cells comprising more battery cells than the first plurality of battery cells;
a third member, the third member and the second member defining a third bay to house a third plurality of battery cells; and
a fourth member adjacent to the second wall, the fourth member and the third member defining a fourth bay to house a fourth plurality of battery cells.

75. The system of claim 72, comprising:
a first wall at a first end portion;
the first member and the first wall defining a first bay to house a first plurality of battery cells;
the first member and the second member defining a second bay to house a second plurality of battery cells comprising more battery cells than the first plurality of battery cells;
a first battery housing enclosing at least a portion of the first plurality of battery cells, the first battery housing conforms to a shape of the first bay, the first battery housing having a length; and
a second battery housing enclosing at least a portion of the second plurality of battery cells, the second battery housing conforms to a shape of the second bay, the second battery housing having a length greater than the length of the first battery housing.

76. The system of claim 72, wherein the wall is a first wall, comprising:
the first member and the first wall defining a first bay to house a first plurality of battery cells;
the first member and the second member defining a second bay to house a second plurality of battery cells comprising more battery cells than the first plurality of battery cells; and
a third bay to house at least one of a battery voltage temperature (BVT) monitor and a voltage distribution box (VDB), the at least one of the BVT monitor and the VDB communicably coupled to the first plurality of battery cells and the second plurality of battery cells.

77. The system of claim 72, wherein the wall is a first wall, comprising:
the first member and the first wall defining a first bay to house a first plurality of battery cells;
the first member and the second member defining a second bay to house a second plurality of battery cells comprising more battery cells than the first plurality of battery cells;
a cover adjacent to the first bay and the second bay to enclose an opening of the first bay and an opening of the second bay;
a first thermal component to couple with the first plurality of battery cells, the first plurality of battery cells is between the cover and the first thermal component; and
a second thermal component to couple with the second plurality of battery cells, the second plurality of battery cells is between the cover and the second thermal component.

78. The system of claim 72, wherein the wall is a first wall, comprising:
the first member and the first wall defining a first bay to house a first plurality of battery cells;
the first member and the second member defining a second bay to house a second plurality of battery cells comprising more battery cells than the first plurality of battery cells;
a cover adjacent to the first bay and the second bay to enclose an opening of the first bay and an opening of the second bay; and
a service window on the cover, the service window to dispose closer to the second plurality of battery cells than the first plurality of battery cells.

79. A method, comprising:
providing a first bay and a second bay, the first bay to house a first plurality of battery cells, the second bay to house a second plurality of battery cells, the second plurality of battery cells including more battery cells than the first plurality of battery cells.

80. The method of claim 79, comprising:
providing a first wall at a first end portion of a battery pack;
providing a second wall at a second end portion of the battery pack;
providing a first member, the first member and the first wall defining the first bay; and
providing a second member, the first member and the second member defining the second bay.

81.-100. (canceled)
